(19) United States
(12) Patent Application Publication
(10) Pub. No.: US 2013/0275413 A1
(43) Pub. Date: Oct. 17, 2013

(54) KNOWLEDGE VISUALIZATION AND INFORMATION BASED SOCIAL NETWORK

(71) Applicant: MindsPlace Inc., Fair Lawn, NJ (US)

(72) Inventors: Yoram SNIR, Rockville, MD (US); Mirit Snir, Rockville, MD (US)

(21) Appl. No.: 13/799,140

(22) Filed: Mar. 13, 2013

Related U.S. Application Data
(60) Provisional application No. 61/610,235, filed on Mar. 13, 2012.

(51) Int. Cl. G06F 17/30

(52) U.S. Cl. CPC G06F 17/30554
USPC 707/722

(57) ABSTRACT

The present invention, in some of its embodiments, relates to managing and interactively displaying content, associating content to virtual networks, and associating social networks to content and to virtual networks.

### RELATED APPLICATION

This application claims the benefit of priority under 35 USC §119(e) of U.S. Provisional Patent Application No. 61/610,235 filed Mar. 13, 2012, the contents of which are incorporated herein by reference in their entirety.

### FIELD OF THE INVENTION

The present invention, in some of its embodiments, relates to the field of managing and interactively displaying content, associating content to virtual networks, and associating social networks to content and to virtual networks.

### BACKGROUND OF THE INVENTION

Professional users, that read professional content, are using paper journals and electronic Web based journals. Presently, using a search engine allows the users to find content according to simple terms, and requires the user to read the content in one scope and search for related content in separate scope. In many cases, the search process provides a large amount of search results, most of which are totally irrelevant to the user, and the user needs to browse through these, and read part of them before identifying relevant content.

The commonly used visualization comprises several approaches such as Printed paper, PDF and HTML (web interface). Printed papers are articles that were pre-shaped and edited. They include Figures and text that are positioned relative to each other in a pre-fixed structure (fonts, location, integration into the journal, ads). Using printed papers, the user (the reader) faces some obstacles. For instance, the user does not control it other than flipping pages. In addition, the user does not perform search queries to look for specific text. Another approach is PDF, which is similar to paper, with a viewer allows zooming in and out as a whole, keeping the proportion and location of text and figures (as in the printed version). User is still required to fit the pdf into the screen size, with the limitation that if full page fits the screen the figures and fonts become too small to read conveniently, and if zoomed in, then the user must shift the page back and forth for reading and in particular to view images that are related to the text, which are often located elsewhere in the page or in other pages. There are advantages and disadvantage for keeping the original “print” structure and page breaks in the documents. The primary advantage would be maintaining the overall look across platforms. However, it practically does not fit the screen size, aspect ratio and resolution of electronic display environment (for example A4 in print version vs. half the size in tablets, much smaller size in mobile phones, and various size and aspect ratios on personal computer screens). Other limitations exist with regard to search and highlight, including, for example, challenges in marking and copying in multi-columns format, equations, and various complex structures that may exist in the content.

A different approach includes HTML, and similar web-interfaces. In this approach, the software has the textual content and presents it in accordance to the HTML capabilities. This includes control over font size. It embeds the figures in fixed locations relative to the text, either as a link that needs to be followed, or explicit in the display area without smart formatting nor handling of size and resolution, thus the embedding of the figures never gets to a professional magazine look, and often suffers from further delays in obtaining the displayed figures when desired. Normally web pages are highly busy with additional indirectly relevant content and links from the page provider, and sometime with web/mobile ads and other pop-up content. In some cases, the excessive presence of links leads to unintentional click on them, which is annoying to the user. Often, the displayed content requires following some links to get some other parts of the content (e.g. high resolution figures, tables, other parts of the document, etc), which require the user to click back and forth, and wait each time for content arrival and display. The user spends a lot of time on clicking around to find the needed content, and the process is slow, tedious, and thus annoys the user.

HTML documents allow the user to view, annotate, search and highlight of the plain text only documents, but are impractical to search, highlight and copy parts that are more complex than just plain text, or that are stored as images. Additional approach could be Electronic Reader platforms, PDF viewers. Such approach includes text viewers with quality of display similar to HTML, but usually less capable than a full HTML browser. While journal viewers have professional look that created by reformatting simple text content into automatically edited journal-like format, they lack of suitable and clearly not customized for handling scientific content.

In addition, scientists and researchers seeking articles and data have only limited search options available to them, which are primarily based on basic keyword search. They also have no convenient platform for secure and dedicated networking that would allow them to practical exchange research and ideas within and among organizations and within ad-hoc communities. In fact, email remains their main communication tool for such purpose, which is clearly a very limited tool. As the searching, accessing and sharing of data and research results among specific groups of collaborators is one of the principal drivers of scientific discoveries, there is a clear need to provide suitable platform for such purposes.

At present, scientists, researchers and physicians who are seeking research materials typically use textual search engines, one of the main ones is called PubMed (produced by the National Library of Medicine (NLM), the National Center for Biotechnology Information (NCBI), and the National Institutes of Health (NIH)). PubMed is a system that searches Medline database, which indexes articles in the biomedical research and clinical research fields. PubMed is a large repository and amalgamator of scientific publications, including references and abstracts on life sciences and biomedical topics, and other related information and data. The PubMed search engine is driven by a keyword search, which typically returns article titles in chronological order, based on the date of article publication. In order to access the article abstract it is necessary to click-through to the relevant link, and for further progressing towards full text, it is necessary to perform one or more clicks-through towards the article or to a third party provider's site, sometimes with additional requirements pertaining to purchasing or otherwise obtaining rights to read the article, and/or to the type of content format to be used. All these steps are often repeated over and over again and require many back-and-forth browsing, downloading of information and wasted waiting time. These occur while in most cases the process progresses through articles that are not interesting to the user, due to the poor ability to express the concept of real interest by a few keywords and by the poor presentation of the search results in an intuitive way. This invention improves over existing search for relevant information and data by allowing better efficiency, a more enjoying and faster process to get to the information of interest.

As with searching for relevant content in PubMed, similar search process, and similar problems exist is other search engines and tools, including, for example, in Google's search and similar, and in various dedicated articles and citation aggregators. These are based on keyword search, and as such the resulting process is very inefficient and inconvenient from the user's perspective. As with the scientific and medical fields, the above is similar in a variety of professional fields, in which the search process and the content access and display are very inefficient and inconvenient. It is one of the purposes of some of the exemplary embodiments of the present invention to provide novel efficient and convenient solution to the above.

In addition, the typical search for abstracts and articles of interest is sometimes based on the keywords, authors and general categories. This conventional approach is missing one of the key aspects of online collaboration and of up-to-date community activity, namely, finding the information that grabs the attention by researchers of the same community. The approach, in some embodiments of the present invention, of search assisted by professional social network is important to assist the researcher in finding what's really important at present time, and not just the large amount of less relevant information out there on a certain topic.

In addition, collaboration is critical to address today's global markets and industry challenges. Professionals often work in distributed development teams, exchanging data, creating discussion about ideas, forming collaborative research that involves professionals working across the hall, or within an institution, or in different institutions, or on the other side of the globe. Each of these interactions requires a variety of modes of communication to ensure that the collaboration is successful. Social interaction tools that are currently available to collaboration between professionals include face-to-face meetings, online conversations, phone conversations, emails exchange, calendaring, and electronic information exchange such as e-mail to collaborate, exchange information, and for decision support. E-mail exchange, list servers, Skype and other Voice over IP systems teleconferencing, and videoconferencing are common tools that are used for collaboration. Another form of community structure is the web-based forums. Similarly, webinars and web-conferences allow groups whose participants are distributed to communicate at the same time. The expanding collaboration and social networking participation creates potential for business in the networked global community, however, professional do not usually use some of such tools, such as online social networks, blogs, chats, instant messaging, for team collaboration, as these are not designed to fit the professional needs, including with regard to data management, privacy, professionalism, and the like, and do not support the connectivity with the topics and content. These tools usually remain for use in the domain of personal social activity, and less in the professional domain.

However, the existing collaborative user interfaces have limitations. For example, the number of participants and the types of their interactions. The participation may support existing relationships, and to a limited extent help users establish new ones, but often these relationships persist in the virtual world only and for limited time. Sometimes, but not always, users benefit from the interaction, but most times users do not contribute to it. Online communities such as healthcare discussion groups create a less-professional environment with many unidentified users. Another example is Wikipedia, which has low number of contributors, and on top of that only a small portion of them have interaction with others.

Professionals, for example, but not limited to, researchers and physicians, seek professional collaboration as part of their routine work. Such collaboration would include learning from experience of colleagues, and building professional relationship and progressing within their professional community (e.g. the research community and medical community).

The professionals constantly would like to publish and share knowledge about their scientific and medical achievements, expertise, and fields of interest. The professionals seek colleagues with similar fields of interest at that same time. Such professional groups, like researchers and scientists or other types of professionals, work together across time and space. These groups share interests, share research centers, shared instruments, community data systems, and community infrastructure projects.

However, there is no appropriate integration between the way they can use social, professional networking, content search, content consumption, and content viewing. There is also lack in ability to assist the user in selectively and efficiently expanding the professional collaboration network in the context of topics that are currently of interest, and to easily identify what is important, who is relevant to be contacted and to enable communication about these.

One of the objects of some exemplary embodiments of the present invention is to provide an application platform that allows the users the ability to approach authors and researchers that were identified having the same interest, either by the field of interest they declared or based on their implicit field of interest as is apparent over time, and/or in real time, as they actually search and consume content, and/or communicate about it.

As some of the basic needs of researchers is to express their achievements within their scientific community and to follow the progress of their colleagues and leaders in the field (which is a root behavior of a social network), one of the objects of some exemplary embodiments of the present invention is to provide an application platform that solves these needs, in a manner that is suitable for professional community.

The following is a list of art, U.S. patent applications and patents that relate to analysis and citation analysis, the contents of which are incorporated herein by reference: US2009/0292673, US2008/0282187, US2007/0239704, US2005/0010559, US2002/0156760, U.S. Pat. No. 6,738,780, U.S. Pat. No. 6,457,028, U.S. Pat. No. 6,289,342.

### SUMMARY OF THE INVENTION

The present invention, in some of its embodiments, relates to the field of managing and interactively displaying content, associating content to virtual networks, and associating social networks to content and to virtual networks.

There is provided in accordance with an exemplary embodiment of the invention, a system for accessing electronic content and providing social network comprising:

a computerized user interface;

a computerized sub system for accessing one or more databases and for searching information in said one or more databases;

a computerized sub-system for maintaining user data for a plurality of users and connectivity data among said users; and

a sub-system that is suitable for generating information search results which takes into account the user's connectivity with other users.

Optionally, said subsystem (d) uses information pertaining to the user's field of interest.

There is provided in accordance with an exemplary embodiment of the invention, a system for accessing electronic content and providing social network comprising:

a computerized user interface;

a computerized sub system for accessing one or more databases and for at least one of searching, obtaining, reading and viewing of information in said one or more databases;

a computerized subsystem for analyzing said access to said information and/or at least one database and to characterize fields of interest of the user;

a computerized sub-system for maintaining user data for a plurality of users and connectivity data among said users; and

a sub-system that is suitable for identifying other users sharing similar field of interest based on said analyzing.

Optionally, the system further makes connection between said users having similar fields of interest.

There is provided in accordance with an exemplary embodiment of the invention, a system for accessing electronic content and providing social network comprising:

a computerized user interface;

a computerized sub system for accessing one or more remote databases and for searching information in said one or more remote databases;

a computerized sub-system for maintaining user data for a plurality of users and connectivity data among said users; and

wherein said system include at least one client and at least one server, and wherein at least one client performs said access to said one or more remote databases.

Optionally, at least one server also performs said access to said one or more remote databases.

There is provided in accordance with an exemplary embodiment of the invention, a method of interactively display in a client application results of searches in databases, the method comprising the steps of:

providing criteria of information to be searched;

accessing a database to obtain characteristic information for multiple search results that meet the criteria;

accessing a database to pre-fetch available initial textual information and figures for each of a certain amount of multiple results;

display multiple search results in combination with figures for said multiple pre-fetched results; and

enable one-click to access the figures and initial textual information.

Optionally, information is articles and initial textual information includes at least abstract information. Optionally or alternatively, multiple figures are displayed in a manner that they continuously replacing one another.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 shows an example of a Multi Entity Types Network;

FIGS. 2A-2D show examples of client, server and network resources communication model and co-function;

FIG. 3 shows an example of Channels Display;

FIG. 4 shows an example of Entities Screen;

FIGS. 5A-5L show examples of Entity Display, for example, a display of an article, including for example abstract, full-text and images, as well as other exemplary user interface formats, functionalities and actions;

FIGS. 6A-6D show examples of processes the user performs as part of the user's experience when searching for content such as articles;

FIG. 7 shows an example of a system breakdown;

FIGS. 8A-8J show examples for relationships, interactions and flow between some components of the present invention, including, for example, entities (including, for example, entities representing users, articles, discussions, etc), channels, collections of channels, searches, and views;

FIGS. 9A-9M show example of database structure and relationships among data items and tables as being used by some exemplary embodiments of the present invention; and

FIGS. 10A-10W show examples of screenshots of some exemplary implementations of some aspects of the present invention.

### DETAILED DESCRIPTION OF THE INVENTION

An aspect of some embodiments of the invention relates to a system which interrelates knowledge, professional identities and/or messages/comments and/or discussions (e.g., organized such as linear discussions) on one or both or neither. In an exemplary embodiment of the invention, knowledge items have authors and an underlying assumption utilized by some embodiments of the invention is that the authors collaborate on a plurality of articles and conduct research (e.g., knowledge discovery) in various fields. In an exemplary embodiment of the invention, items of knowledge are part of the system and are linked to the origin. In some cases, such items are viewable only via a paywall, and only a reference/citation is managed by the system. In an exemplary embodiment of the invention, people that are managed by the system (e.g., authors) are not users, though they may join. In an exemplary embodiment of the invention, users of the system are not authors of any items of knowledge. In an exemplary embodiment of the invention, when items are displayed, they are displayed in a manner which facilitates easy browsing, optionally by presenting highlights and graphic elements, and linked to other parts of the system. In an exemplary embodiment of the invention, the system facilitates cooperation between users on knowledge discovery. In an exemplary embodiment of the invention, once users start discussion on a knowledge item, messages/discussions are formed, which are themselves treated as objects in the system which have, for example, authors and/or can be searched and/or displayed as results.

In an exemplary embodiment of the invention, the managed knowledge comprises citations of articles. Optionally, a single discussion may relate to many such articles/citations. In some cases, managed data comprises full data (e.g., articles and/or parts thereof, such as an image or a text section, optionally managed as links.

In an exemplary embodiment of the invention, a user can use the created relationships between knowledge, people and/or discussion content to provide useful guidance, for example, in research. In an exemplary embodiment of the invention, such relationships are managed and are increased and/or decrease din strength according to their usage and/or inherent strength (e.g., relationships between items). Optionally, this allows the network to be treated as a neural network or a database of relations.

In an exemplary embodiment of the invention, the system is (logically) constructed as a set of linked networks. Such networks include, for example, a social network made of users, linked with virtual network made of articles (which are typically written by people outside of the network, some of which may join the social network), and a network formed of a messaging service made of discussions (typically generated by the users of the social network, and some generated, optionally automatically, based on the virtual network).

One or more of the following relationships (and/or as described below), may be provided in some embodiments of the invention:
(a) three (or more) way relationships, rather than just pairings between items in two networks
(b) multiple types of relationships exist simultaneously, for example, the relation between two objects is unidirectional, or bidirectional, or one-many, or many-many (e.g. group). In another example various direction relationships are provided, for example, person->person->articles->other persons or to other articles->discussion->persons/articles->.

In an exemplary embodiment of the invention, there is provided the ability to query for related objects, for example objects that are related in a way meaningful for research. In one example, a query finds articles related to a discussion, for example, based on Relation Formula. In one example, some or all types of inner-link (e.g., between objects of the same type) and/or cross-link (e.g., between objects of different types) have one or more of weight (e.g., how important this type of link), minimal limit (e.g., how many of this type is the minimum to establish relation), maximal limit (e.g., a threshold number of links that make it a non-interesting relation), distance (e.g., how many different links in between the related objects), and/or direction (e.g., are the two objects related because they point to same object in the middle, or because one is pointing to the other, or both are pointed by a common object). Optionally, some or all links include time stamps (e.g., creation and/or modification).

In an exemplary embodiment of the invention, the process of querying comprises relaxing a relationship formula and allowing weaker and weaker relations, until enough objects are collected for a query result. Optionally, such a formula includes giving score to relations (e.g., similarities among content, keywords and/or fields of interest). Optionally or alternatively, the formula includes relationships between pairs, triplets of objects and/or lists (e.g., channels) of objects. Optionally or alternatively, the process includes creating associative queries within the platform. In one example, traversal along an associative network (e.g., possibly, with fuzzy logic relations) to collect enough data/results having a total score, which is high enough.

An aspect of some embodiments of the invention relates to on-going search, for example, a self-progressing-iterative search by the platform. In an exemplary embodiment of the invention, the search provides a first set of results based on locally availability and/or pre-fetched data and then is continued to be updated for, for example, a few (e.g., 2-60) seconds or minutes (e.g., 1-5), as more data arrives. In addition, further update as more data is created and/or indexed and becomes available is optionally also provided.

In an exemplary embodiment of the invention, when a user initiates an interest in something (e.g. query), the system search for results, and by pre-fetching content, analyzes and extracts information that causes the system to re-generate additional (implicit, hidden) queries, which may additionally or alternatively be generated manually, by the user browsed through multiple steps among pages.

In one example, the process includes: User query/interest->search->pre-fetch results->analyze->additional implicit search->pre-fetch results->analyze->additional implicit search.

In an exemplary embodiment of the invention, the process includes iterative search to improve the keywords or any other key that allows related content to be identified.

In an exemplary embodiment of the invention, the pre-fetch allows the server and/or client to make progress in finding relevant content in a multi-iterative search, before the user actively redefines the search and/or goes to a non-visible results display.

In a particular example, a user is characterized by explicit and implicit relations (interested in X, recently read Y, wrote Z). Now the user types a keyword search W1. This results in, for example, 1000 results. The system may not only display the results (or some of them) and/or pre-fetch results, but also analyze the pre-fetched content, and concludes that specific N items are relevant to X/Y/Z. Optionally, the system also prioritizes such items and/or analyses them using, for example, background processing to extract new links/keywords W2. Optionally, such links and/or keywords are used to initiate another (e.g., separately presented) search on K2. This process is optionally repeated, for example, to associatively access relevant content.

An aspect of some embodiments of the invention relates to maintaining privacy of users, while allowing users to use the system. For example, the users can, for example, discuss on article, collate material and/or generate links to other users.

In an exemplary embodiment of the invention, the privacy of a user using the platform is kept by defining threshold formulas for each query process. In an exemplary embodiment of the invention, these threshold formulas define minimum and/or maximum parameters for each value in query formula. For example, the distance is very small when one user reads another user's article. If the reader is not in the author's groups of people, the threshold prevents disclosing the reader in a suggested list of users for collaboration. However, the user may approach the author and/or allow his activities to be public. In this as in other embodiments, thresholds can be replaced by other decision means, such as fuzzy logic and rule based logic. In a particular example, when one or more users read an article or a discussion, reporting (to followers) that users read that article or discussion will only appear after multiple users read it, in order not to identify a user who may have published stern comments.

An aspect of some embodiments of the invention relates to continual updating of channels which are created by queries or other means. In an exemplary embodiment of the invention, such updating is provided by re-applying the query and applying thresholds on the time stamps of links and objects. For example, if many users are discussing common topic and sharing the same article, new links are created and the article is now suitable for the query results, even if it was written many years ago.

In an exemplary embodiment of the invention, relations are formed and stored, but their relevancy for a user could be time-dependent. For example, an author of an article from 20 years ago, may not necessarily be interested in the field anymore (even if he wrote many very important articles, cited by others), and maybe others that are more recent can be much more relevant for the user. Optionally, a determination is made re a time window and/or publication density of articles by an author and/or group in a field.

In an exemplary embodiment of the invention, user actions can affect search results. For example, a user can create alerts/notifications/or any other process at the user side (though possibly executed on a server) which is triggered by and/or otherwise affected by change in relations in the network (as opposed to creation or modification of items). Example: identifying articles within a certain field of interest of a user (e.g. one of the user's channel) were recently read by users related to the user, or discussed by users related to the user. This is without any change that happened to the article. Optionally or alternatively, the act of creating alerts, processes, etc. may itself be the basis for creating a relationship which is then discovered by the system and/or used in search weighting.

An aspect of some embodiments of the invention relates to client-centric design. In an exemplary embodiment of the invention, the client obtains and/or instructs what to obtain and the server is used primarily for assisting and/or augmenting. In an exemplary embodiment of the invention, the client makes the primary access to network resources, and does not necessarily depend on server data. In an exemplary embodiment of the invention, the server acts as a secondary source of data. Optionally, the server approaches network resources based on its processing. Optionally or alternatively, the server receives from the client information about data the client obtained (and/or generated). A particular example is paywall protected articles which may accessed by the client and not via a server.

An aspect of some embodiments of the invention relates to a system with a loosely coupled client server model. In an exemplary embodiment of the invention, the server acts, at least in part, in an advisory, voluntarily, capacity, optionally asynchronously with client operation and/or queries. In an exemplary embodiment of the invention, server inputs is optionally considered by the client and used to augment (e.g. reorder, add and/or annotate) data being displayed, and to provide meta-action on the data. In an exemplary embodiment of the invention, the server provides such advisory support to a plurality of clients, for example, 3, 5, 10, 100 or more or intermediate numbers, possibly substantially simultaneously (e.g., within a 5 second time window). Optionally, a plurality of servers are provided, at least some of which provide services other than provided by other servers. For example, one server can search for data in one location and another in another location, or one server provides author data and another provides scientific data. Data from multiple servers can be collated by the client.

In an exemplary embodiment of the invention, the server can decide if to ignore, offer some data, or all available data to the client. Optionally, the schedule of the server is not linked to the client schedule, so such input may arrive late and/or after a user at the client started browsing results.

In an exemplary embodiment of the invention, the server adjusts response timing, order and/or quantity according to one or more of server resources, bottlenecks availability, network condition, data link cost and/or user service quality agreement.

In an exemplary embodiment of the invention, the client receives information from the server that is useful to modulate/augment the client behavior and the content being provided to the user. For example, the client can reorder, add functions/actions that the server suggests as related to the text, provide complimentary data about the text, provided by the server. At this point, the client may use the data or not, for example, based on user setting, current user action and/or available resources at the user. In an exemplary embodiment of the invention, the user collects such server input for background processing.

An aspect of some embodiments of the invention relates to pre-fetching within articles, which may result in improved user experience. For example, the pre-fetching may follow the path of from list of id->to citation->to obtain abstract->full-text (if available)->multimedia (e.g., figures). In another example, after abstracts, thumbnails are obtained.

In an exemplary embodiment of the invention, if full-text or figures are not available from typical network resources, in some cases the server augments the results and provides text/figures/thumbnails, not previously accessible to the client. In an exemplary embodiment of the invention, what is displayed may be in a different order form pre-fetching. For example, show the citation with figures (optionally changing the figures as in a slide show).

In an exemplary embodiment of the invention, what is provided to the user is fast response and/or data that is ready for next step (abstracts/full text/actions). Optionally or alternatively, what is provided is an informative display of search results that includes data of much more advanced step in the browsing process. (e.g. no need for multiple clicks to see a preview of figures, much before getting the abstract of full text). This may also be useful for displaying metadata and/or possible actions about the citation (e.g., the server/client finds out and displays what else can be provided to the user before the user gets to ask for it).

In an exemplary embodiment of the invention, optimization may be provided, for example, one or more of optimizing according to resources, bottlenecks availability, network condition and/or data link cost. Optionally or alternatively, optimizing is adjusted according to the priorities of articles (optionally predicted as relevant to the user). Optionally or alternatively, optimizing is adjusted to fit the typical read time, and/or flip/scroll/“next item” time by the specific user.

An aspect of some embodiments of the invention relates to visually displaying text with auto association with multimedia. In one example, text progress is aligned with figures, and/or vice versa, progress figures as the text reading progresses. So as text is scrolled, matching images or shown, or selecting of an images causes automatic selection of text which references the image (e.g., as determined by text processing to identify figure designation in the text and/or in the image caption).

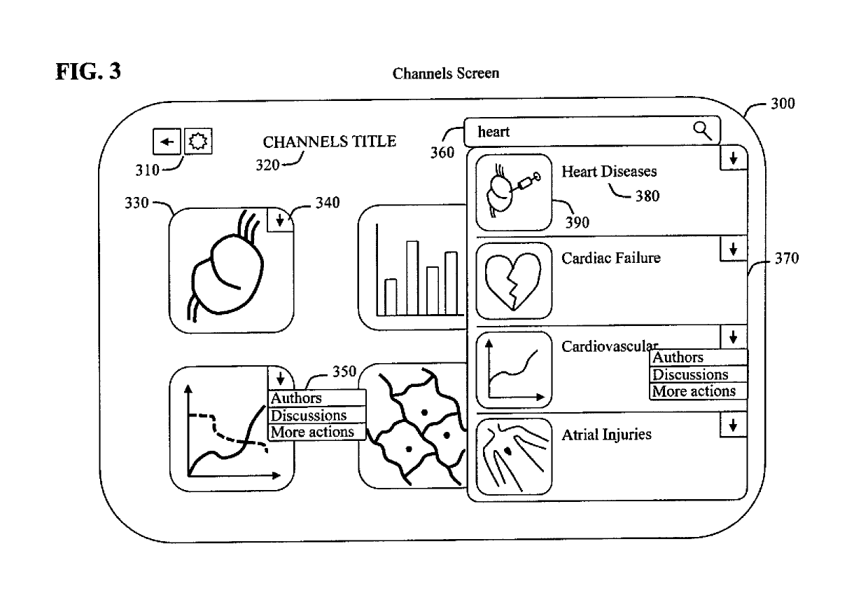

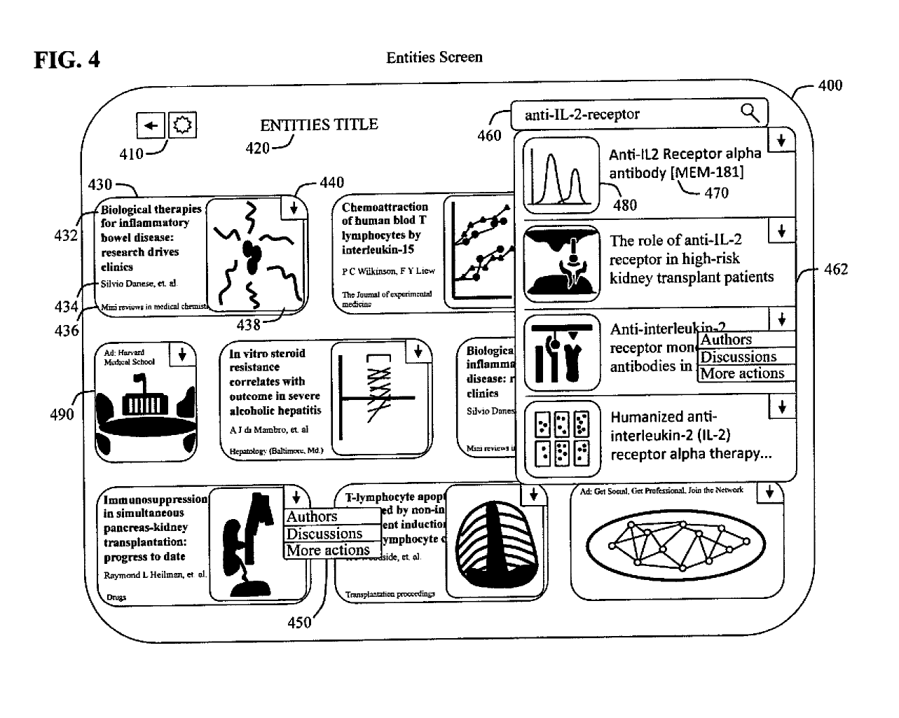

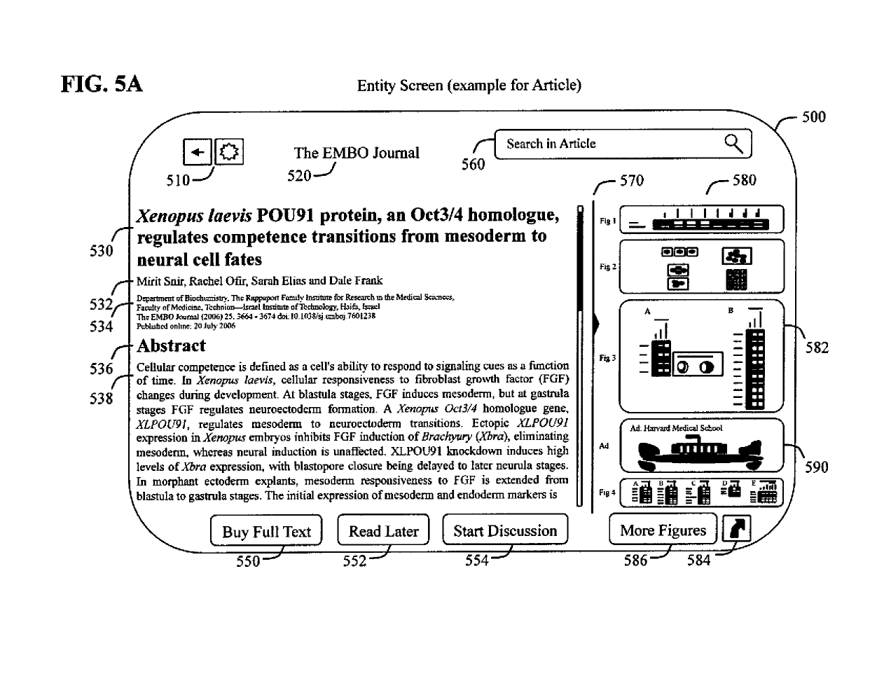

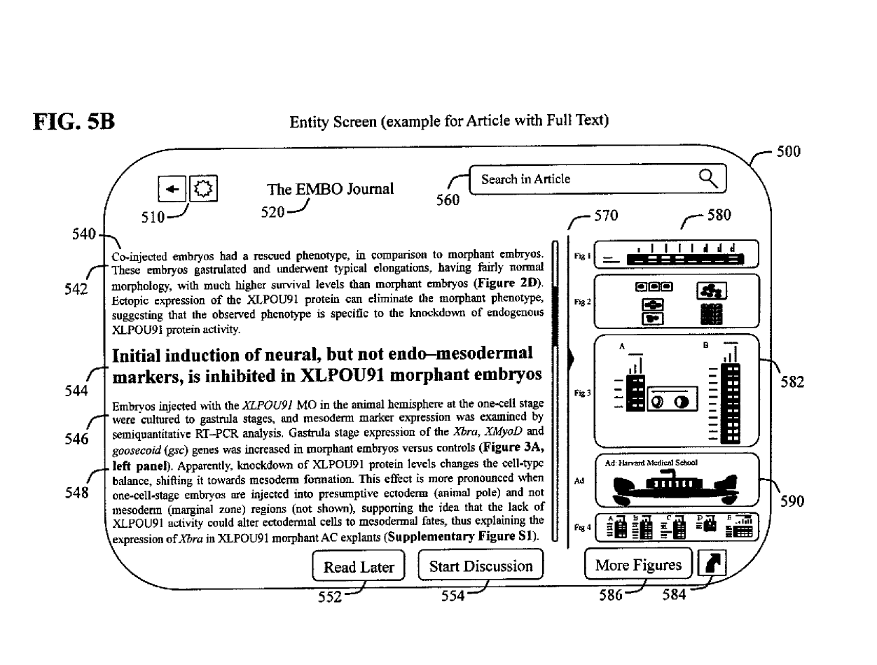

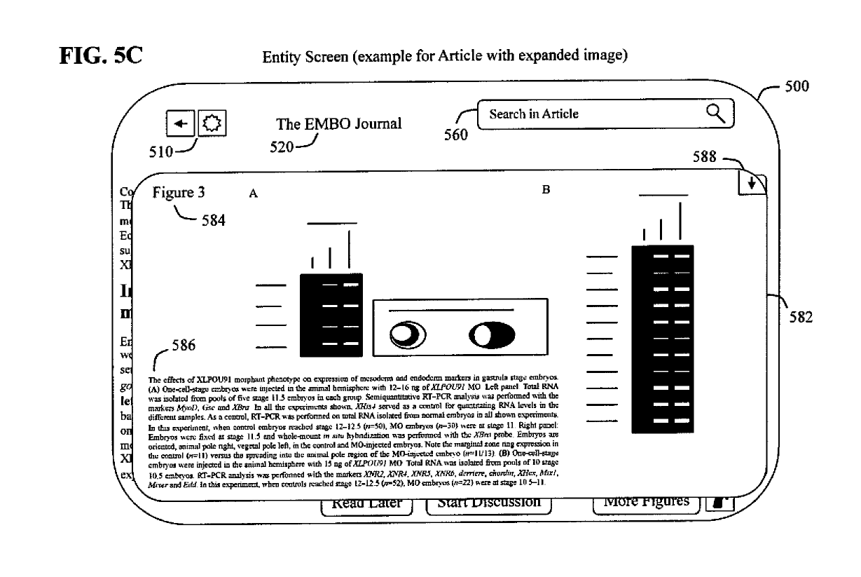

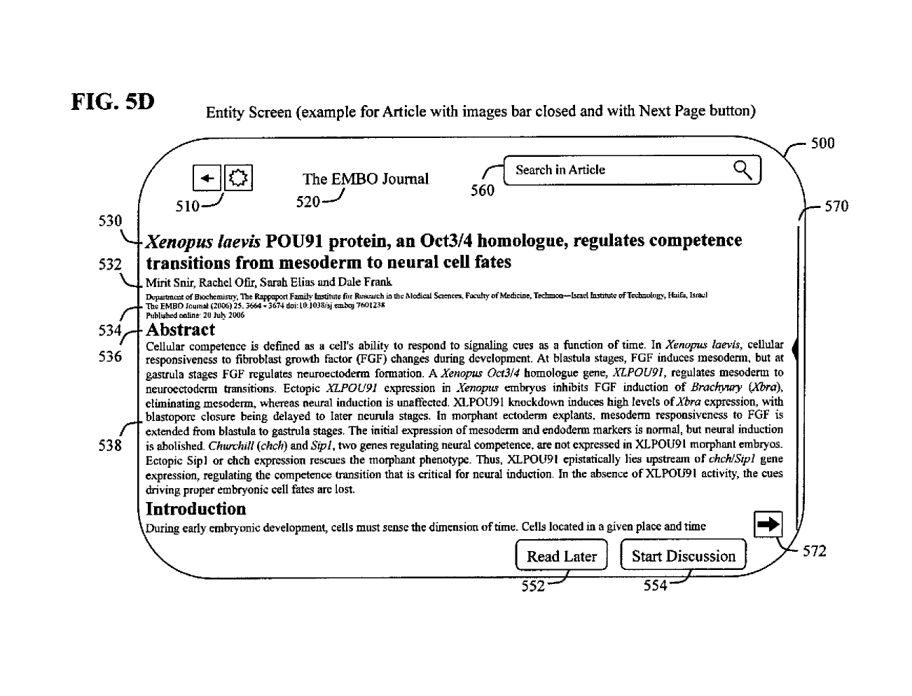

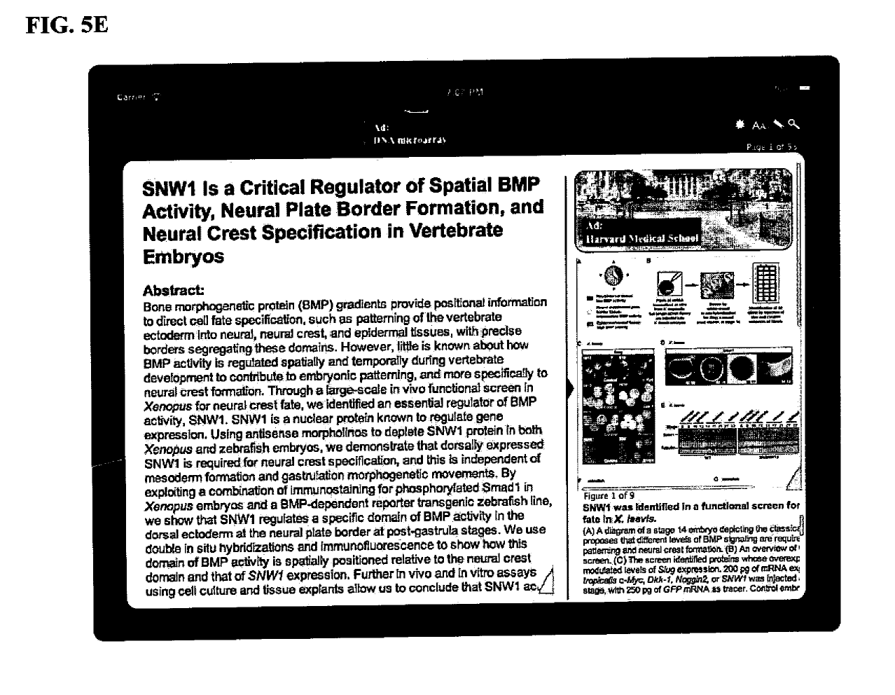

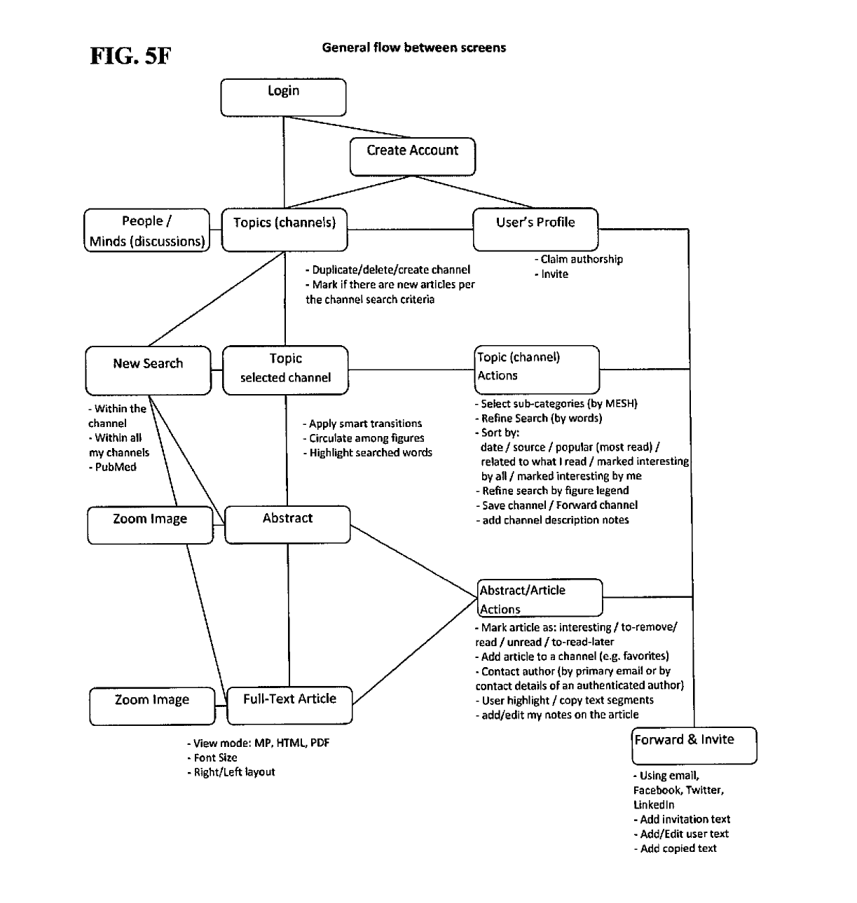

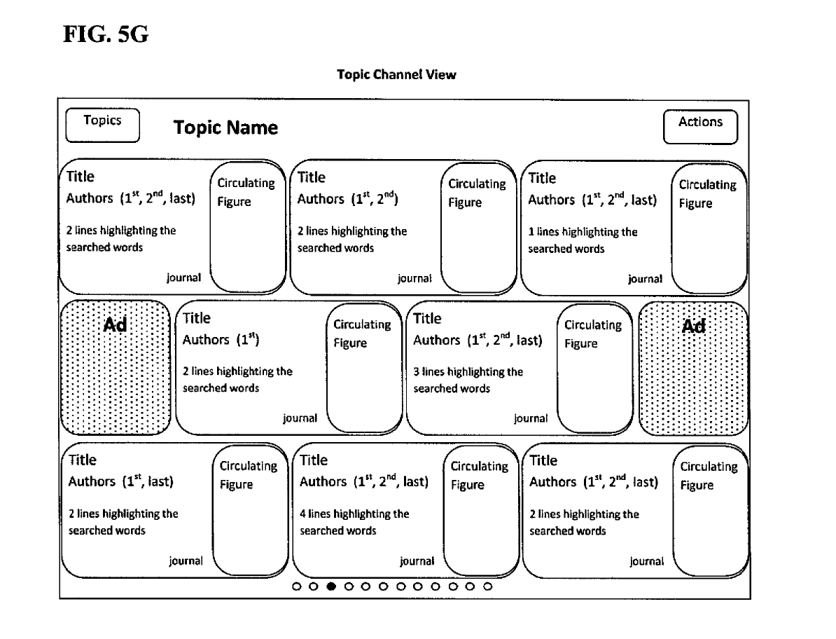

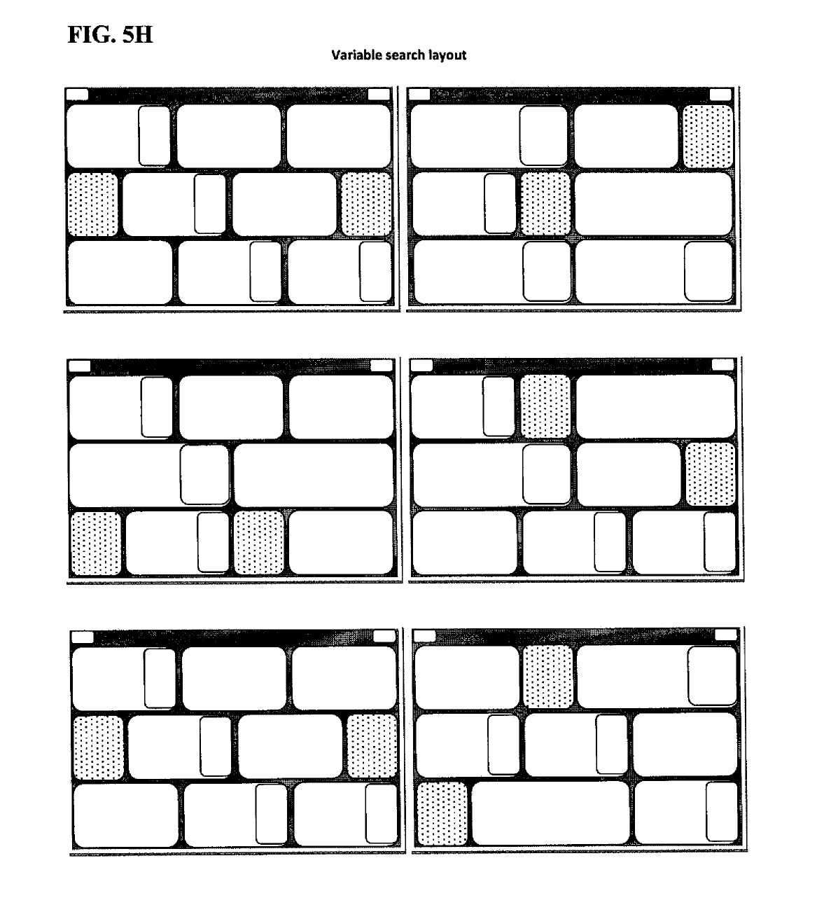

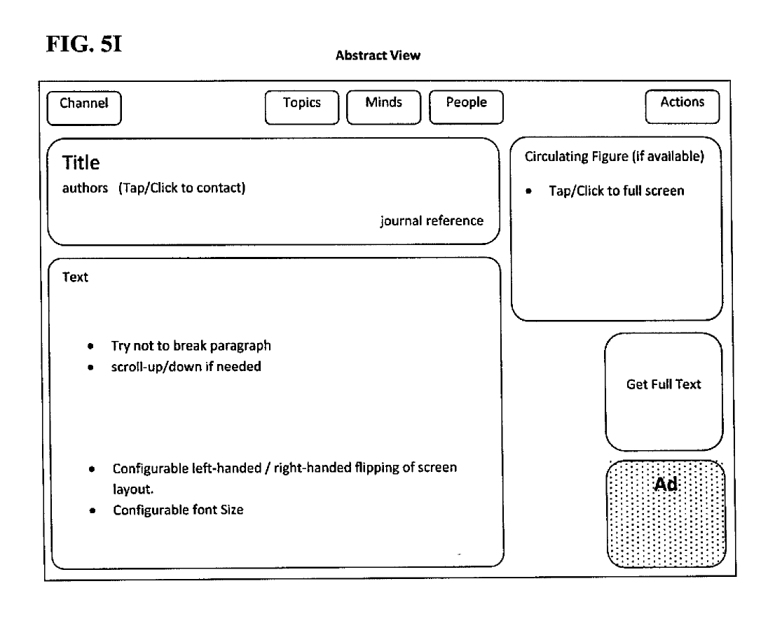

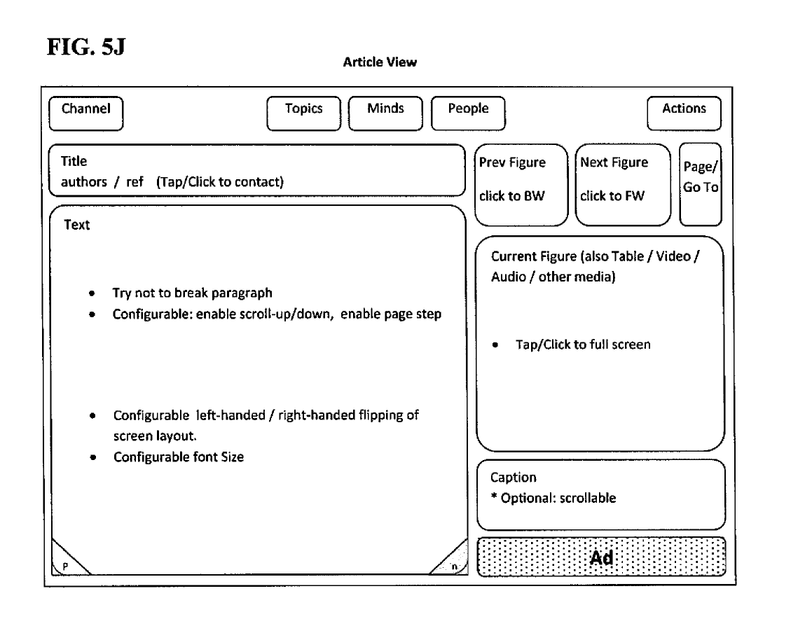

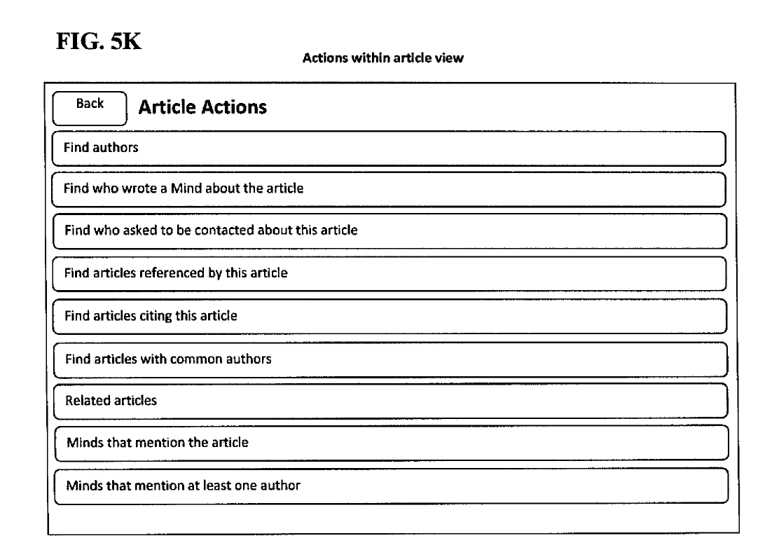

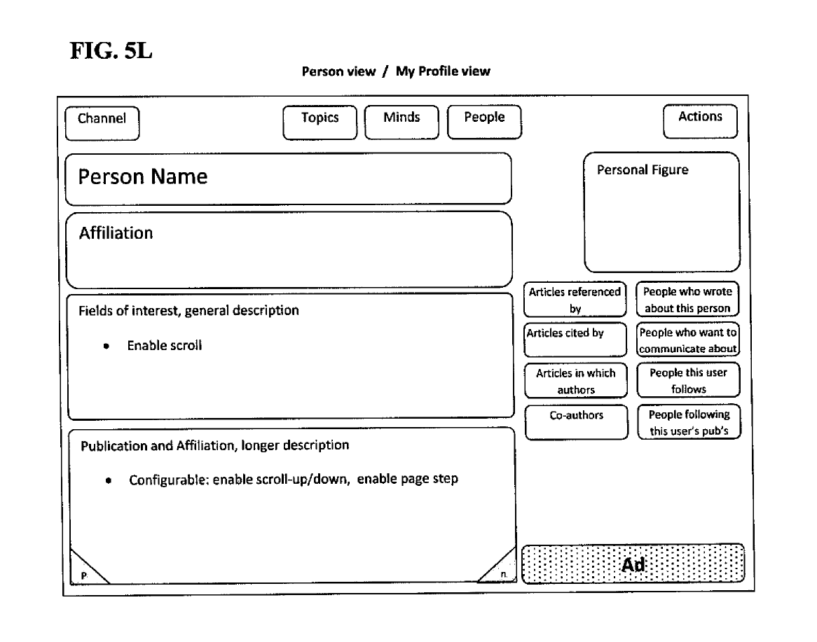

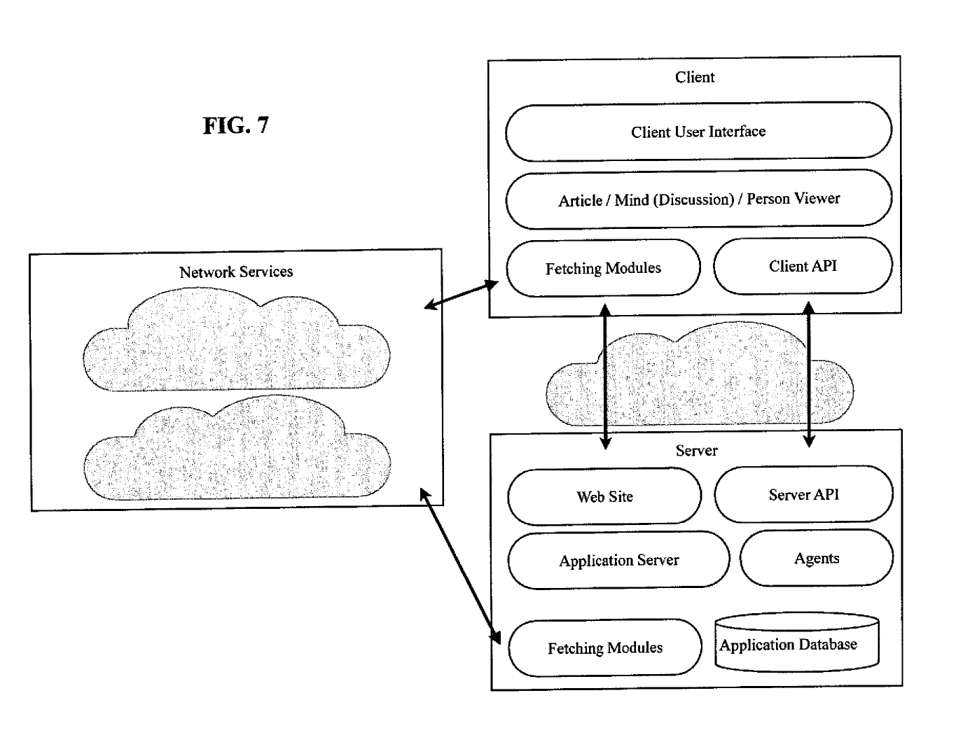

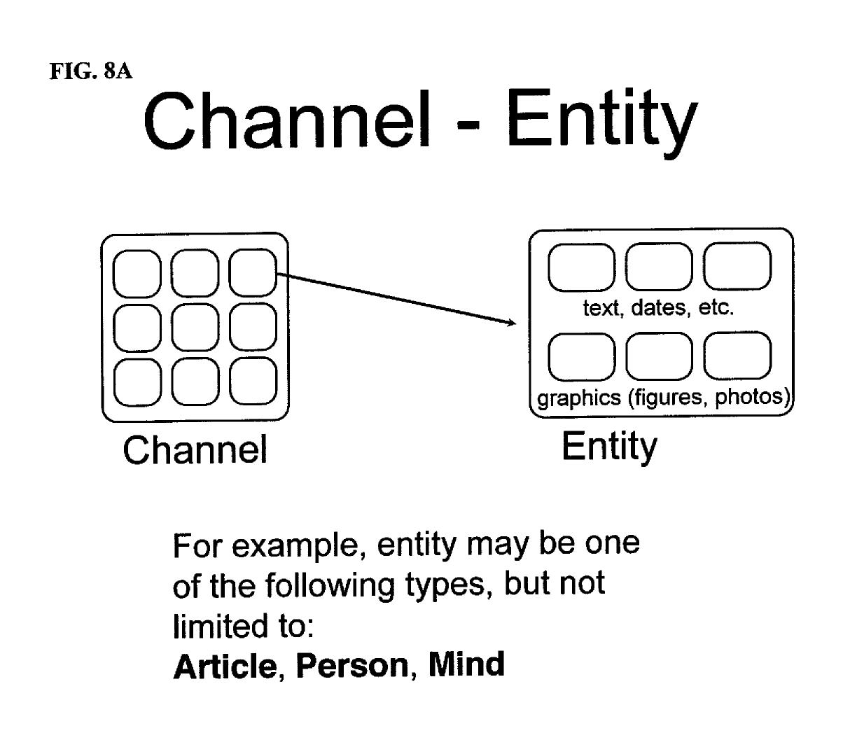

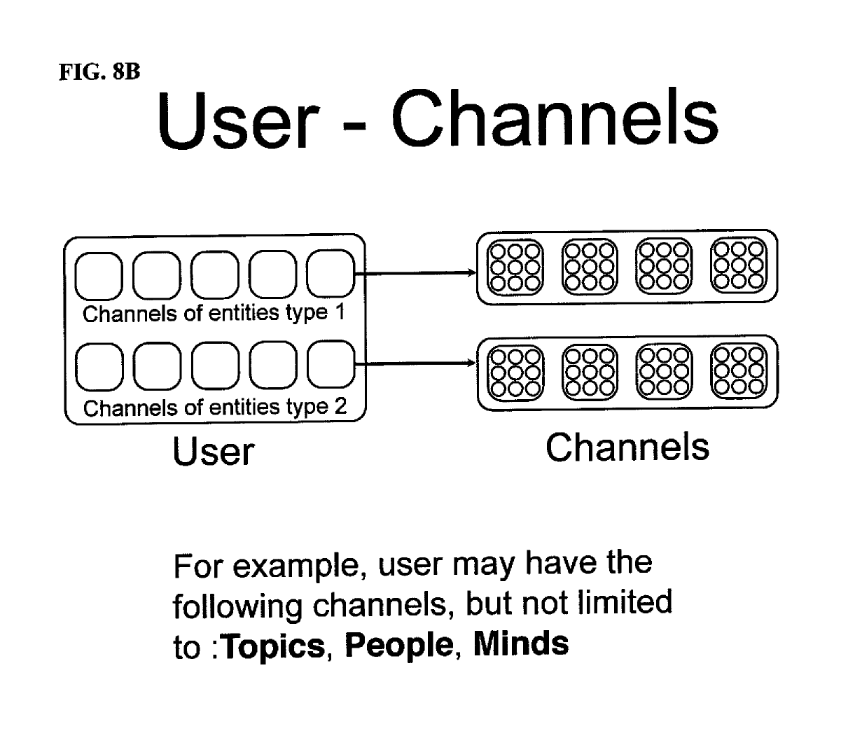

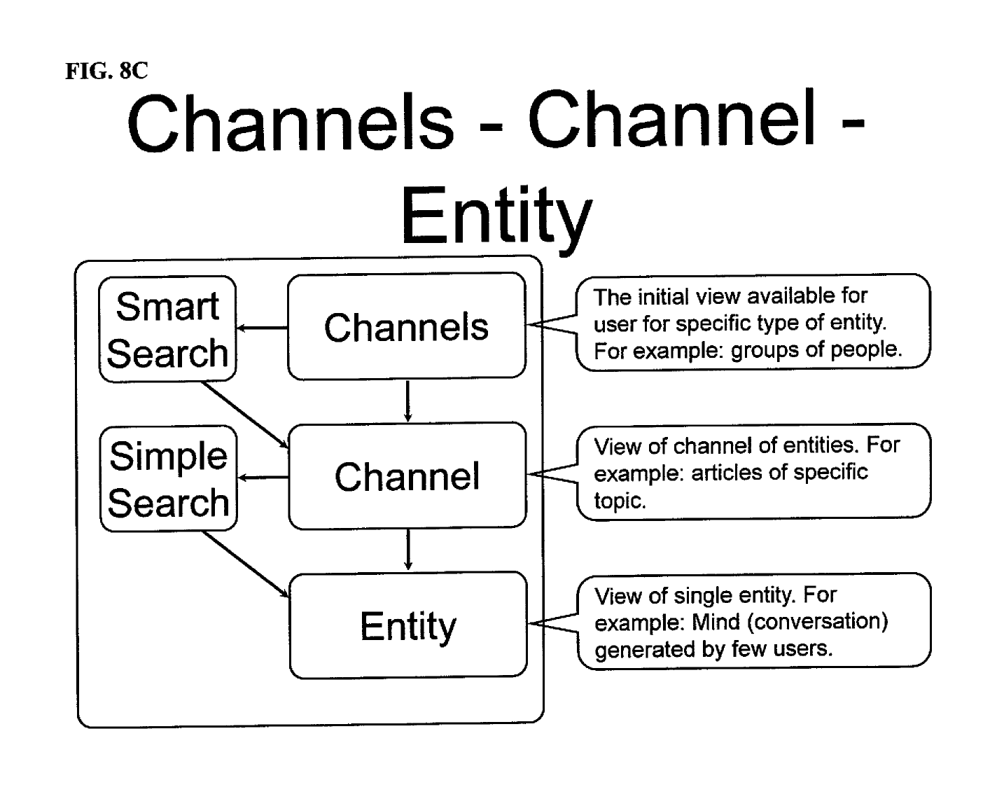

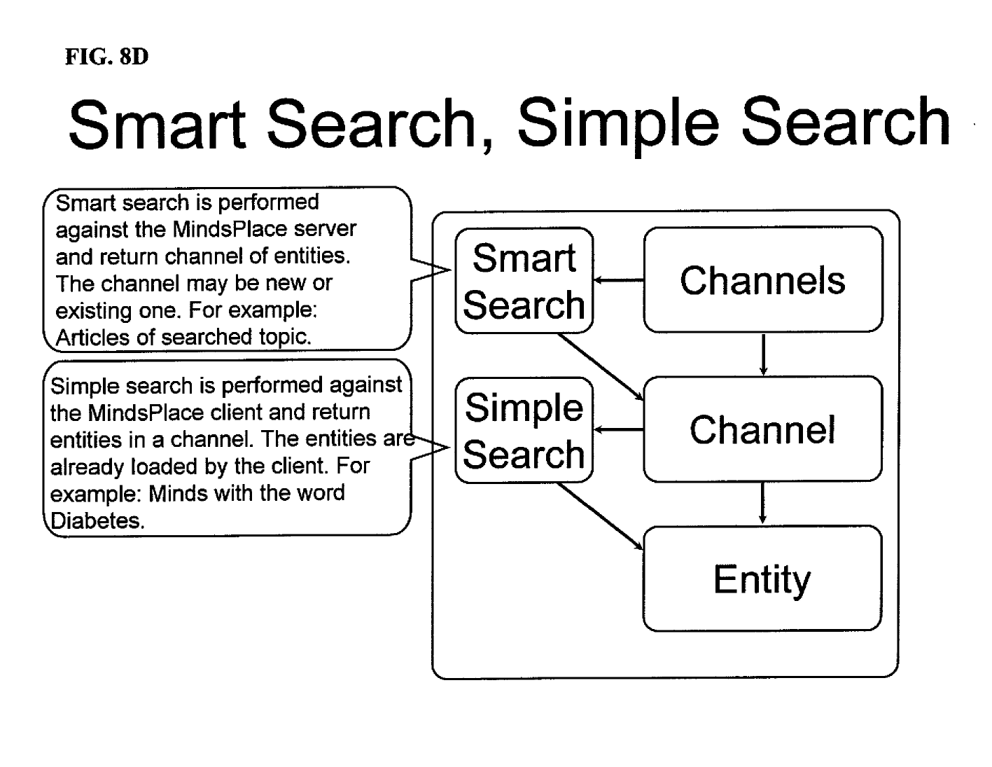

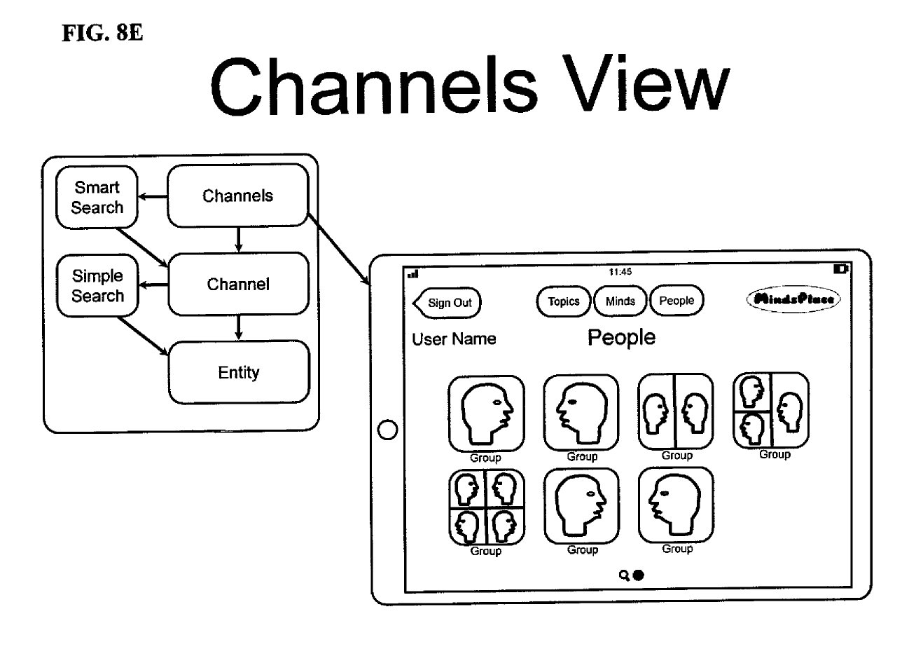

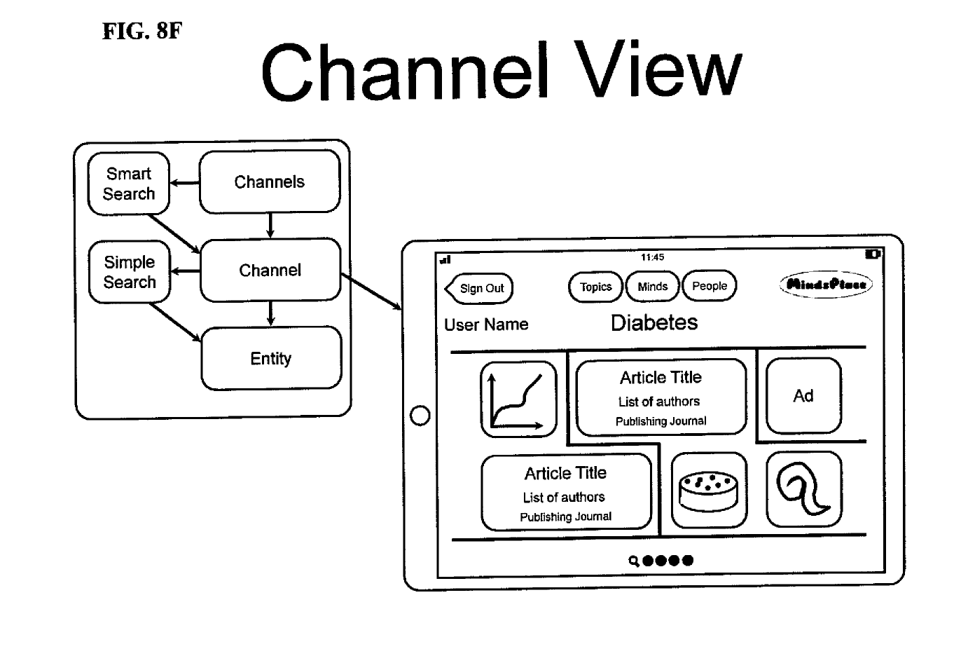

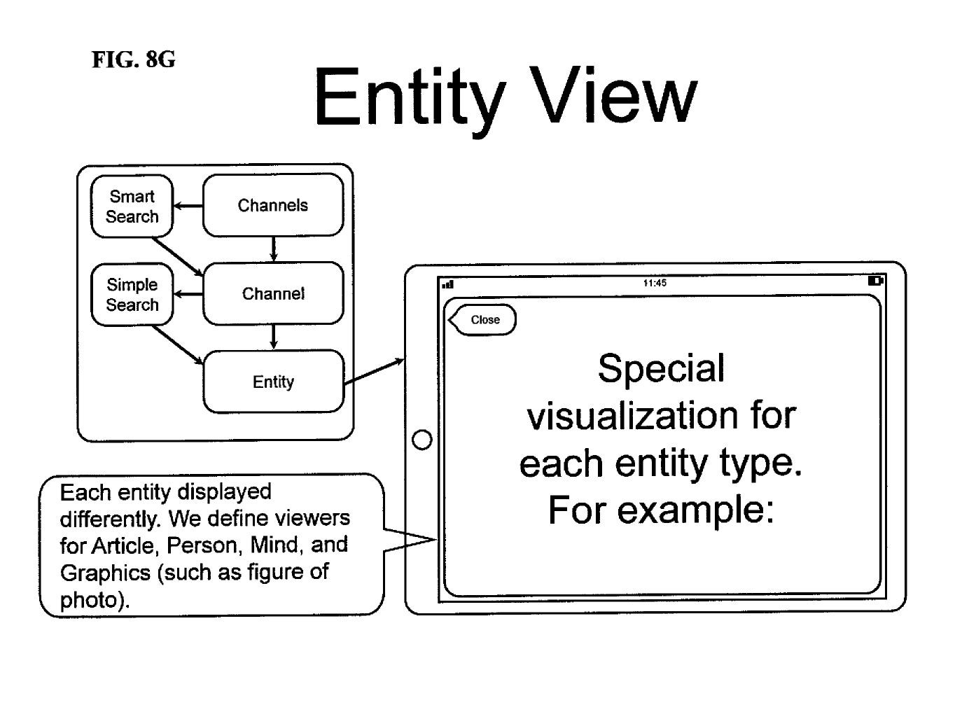

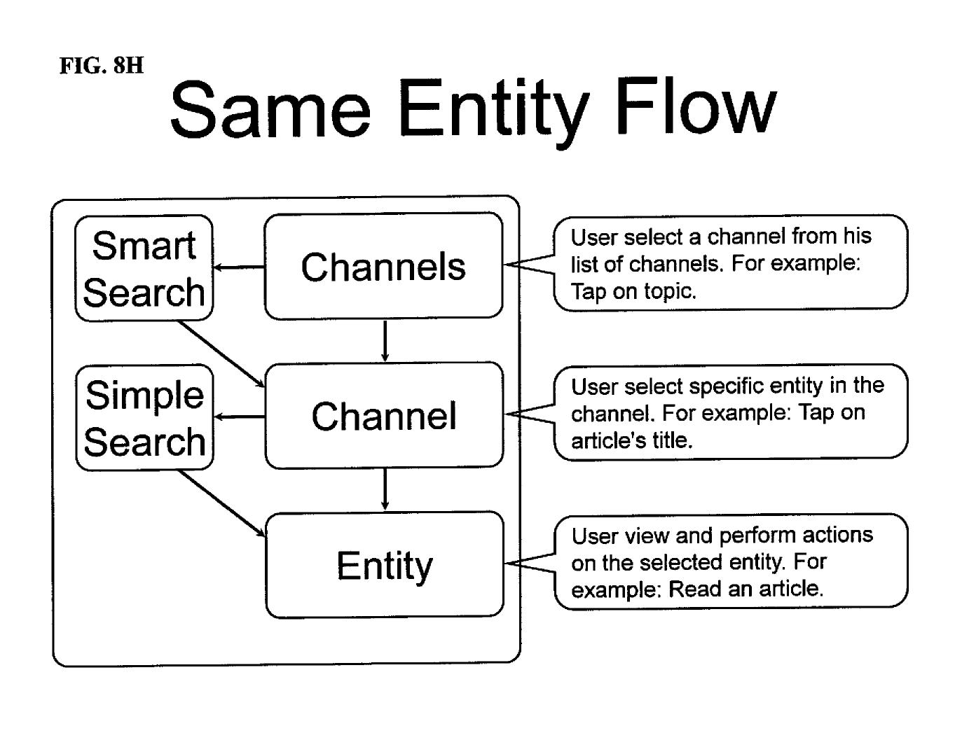

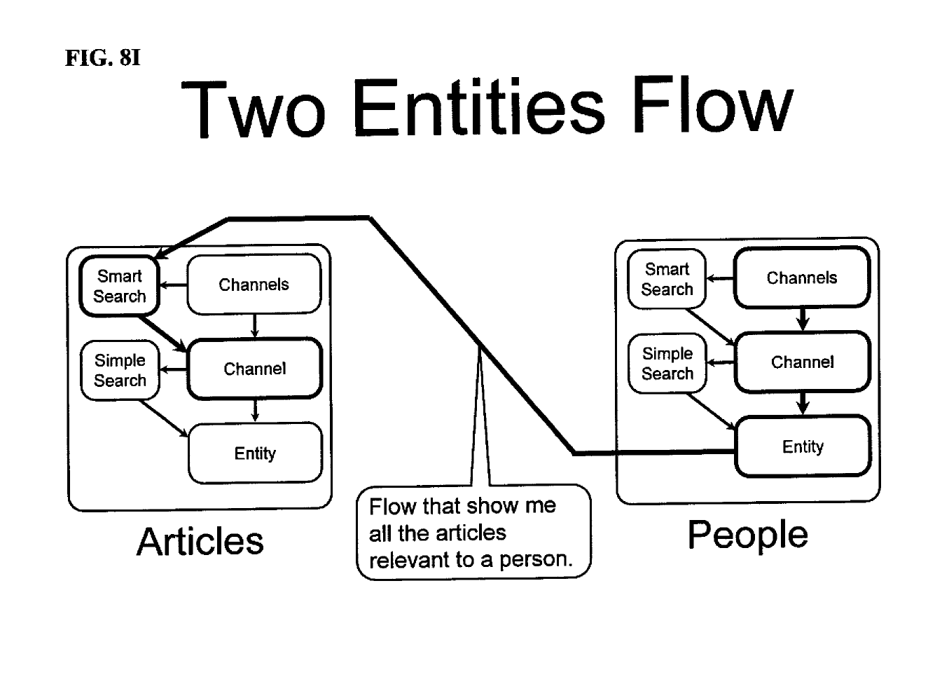

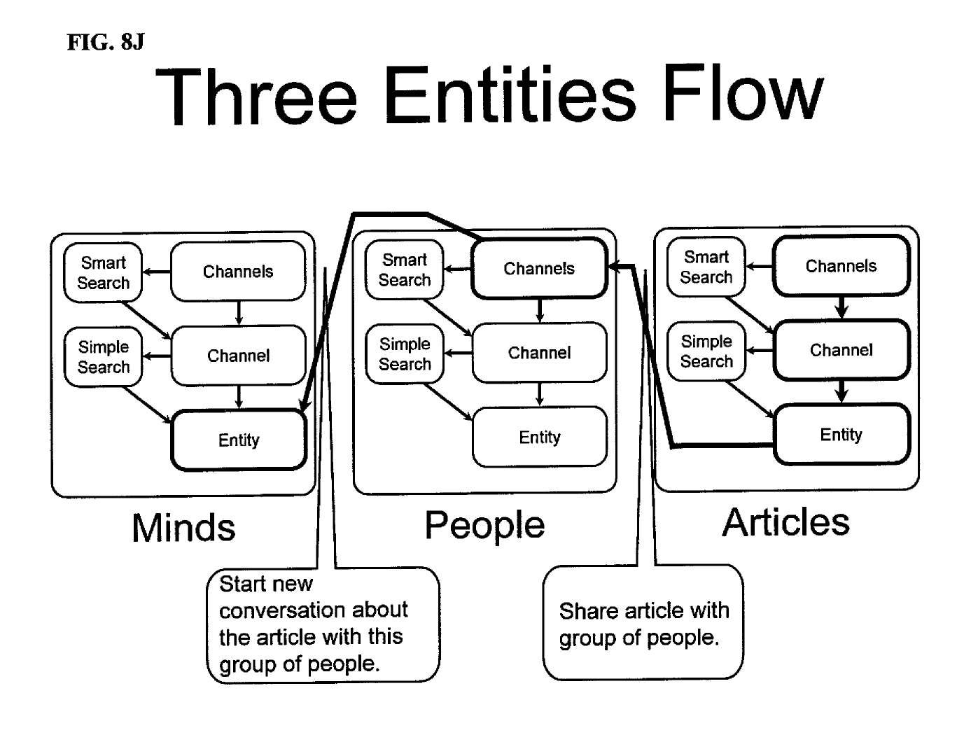

In an exemplary embodiment of the invention, figures may be ordered in the display in the order that the text refers to them (e.g. a page that refers to Figures in the order of FIG. 7, FIG. 3, and then FIG. 5 will be displayed side by side with the figures in that order).

An aspect of some embodiments of the invention relates to usage of gestures. In an exemplary embodiment of the invention, an up-down gesture (e.g. one finger swipe) is used to continuously scroll up-down through content, and/or, optionally, in combination, right-left gestures (e.g. one finger swipe) are used for a “previous/next page” function. Optionally, this includes adaptive pagination of text to specific continuous location in the overall text (e.g., due to the scroll and/or display size and/or arrangement). In one example, a Next/Prey page transition is presented as right-left page shift, or as page flip.

An aspect of some embodiments of the invention relates to determining similarity between contents. In an exemplary embodiment of the invention, similarity among content is determined by analyzing incidence (occurrence frequency) of textual-terms being used in a certain text document relative to similar other documents, optionally identifying exceptional terms as being representative of the text, and further optionally identifying similarities among documents based on the identified terms, and then defining a matching score by the correlation of incidence of the identified key terms.

In an exemplary embodiment of the invention, such a method is applied on search results that are obtained as a list. Optionally, key terms are identified per article, and the articles are grouped by those key terms, and thus generate potential categories. Optionally, when user reads a certain data item (e.g., article), the system can identify those previously identified key terms as actually terms of interest by the user (even though the user never specified them explicitly). Optionally, the User's profile is extended to include implicit characteristics as identified above. One or more groups of users of shared interest are formed this way.

An aspect of some embodiments of the invention relates to client-based advertisement management and/or optimization.

In an exemplary embodiment of the invention, a sever and/or other provider or commercial and/or promotional material, provides to the client (e.g., a tablet client) a collection of potential ads to be displayed. The client displays them at the right time, not necessarily driven by the sever, for example, when off-line, or when the user is interested in a certain field, or when display area permits, and according to the display area properties (size, timing, etc), and the like. The client reports to the server (or to ads provider) at a later time what has been displayed and when (this is used for billing). In an exemplary embodiment of the invention, the advertisements are preselected according to the client previous indicated fields of interest. In an exemplary embodiment of the invention, the client notes and reports a change in focus by the user, so that new ads can be provided thereto. Optionally or alternatively, the server tracks user behavior.

In an exemplary embodiment of the invention, the server estimates possible areas of interest to the user, based on research directions followed by the user, even if the user has not reach their end. For example, advertisements for travel to a location may be provided to a user who is showing interest in a researcher located in that location, or if a major conference on the subject is known to be in that location. In another example, advertisements for research tools may be provided according to the type of research being viewed.

An aspect of some embodiments of the invention relates to using a client to display search results, when viewing topics, collections and/or channels, categorized by object type, means articles, discussions, and/or people. In an exemplary embodiment of the invention, a server provides results based on different Query Formulas. For example, one formula can result with articles with similar searched term, while another result with articles linked to discussions with the searched term. In an exemplary embodiment of the invention, the client is configured to display the results according to other keys and/or selectively according to one of multiple keys and/or logics provided by the server.

An aspect of some embodiments of the invention relates to data sharing. In an exemplary embodiment of the invention, non-sharable content is provided within the system at a reduced cost. Optionally, exporting such material is at additional charge. Optionally, data from multiple sources and paywalls is provided in a same manner to a user, with lower cost within the system and higher if exported (e.g., e-mail, printing, saving and/or delayed reading)

An aspect of some embodiments of the invention relates to providing article (or discussion) translation, for example, within a viewed window. In an exemplary embodiment of the invention, the translation is limited to an overview of an article and/or to a section being viewed and/or to a section matching an image being viewed.

An aspect of some embodiments of the invention relates to automatically identifying research groups based on publications, shared authorship and/or shared subject matter. Optionally, ranking of such groups based on publications is provided. Optionally or alternatively, links between authors are thus provided. Optionally, user supplied information, such as discussions is used to further enhance such data. Optionally, a time window method is used to identify a window of time in which such a research group is extant and/or to allow a user to track changes over time in the composition, relative weight (between authors and/or compared to other groups) and/or interests of such an identified research group.

The terms “Minds” or “Mind”, discussion or discussions are interchangeable when used within the described platform and/or this application, and define various communications among users or groups using the described platform. In some exemplary embodiments of the present invention these communications are by posting messages, publishing blogs. In some exemplary embodiments, these include co-editing of content, direct peer-to-peer communication (including online discussions, audio communication, video communication, and the like), responding or commenting on content, and/or contacting and communicating with users outside the system.

The terms user platform in the present invention defines the user's devices and/or systems for consuming content, and in some exemplary embodiment it may include, but not limited to the user's computer, cellular phone, mobile computing, tablet, car computer, web-TV and the like. In some exemplary embodiments of the present invention some of these may have human interface that does include touching-sensor capabilities (touch screen), gestures identification, 3D motion and position detection, and the like.

The terms content and articles used in some exemplary embodiments of the present application refer to content such as articles, or other textual information which is typically being published to be read and/or consumed by others. In some exemplary embodiments of the present invention it includes rich media, for example figures, animation, video, sound, and the like. In some exemplary embodiments of the present invention the embodiments may be used with other types of content, including, without limitation to databases, software, vouchers, games, chats, forums, blogs, and other web-based content and web-based services.

In some exemplary embodiments of the present invention the terms data, content and/or information may also be used for, but not limited to various kinds of information types and sources, for example, one or more or combination of various types, for example articles, abstracts, general text, numbers, equations, geometric objects, data tables, pictures, figures, graphs, sound, video, animation, 3D data, 3D video data, web-links (URLs), web-content, records, lists, documents, presentations, display formatting objects, run-time objects and/or scripts, and/or many other types, and/or any combinations and/or integration and/or structural incorporation, and/or hierarchical nesting thereof. In some examples of the present invention, information and/or data relate to meta-data that relates to other information. In some examples of the present invention, data relates to results of processing other data or content, including for example any analysis, segments, translation, statistics, pre-fetching, extension, completion or other manipulation of one or more data items. In some examples of the present invention, data and/or information relates to functions and/or operators that can be applied to a certain content and/or information, for example scripts, and/or controls, and/or function calls, and/or remote function calls that are able to operate on, or in the context of, or result from, or generate, a certain data or content. In some examples of the present invention, data relates to information of visualization and/or users' preferences and/or visual order of elements and/or visualization guidance. All above examples may be applicable to all occurrences of data, content and/or information in the present invention, mutatis mutandis.

In some exemplary embodiments of the present invention the term server may be used for one or more servers. In some examples, the one or more server can process information, obtain information, store information and provide information, whether interacting as a single server, a local group of servers, a distributed collection of servers, and/or as dynamically or statically collaborating array of processing units, computers or servers that dynamically or statically allocate various tasks and/or fulfill various task, in part or in complete. In some examples, the one or more servers collaborate in order to obtain information, balance or compensate for overload among the group or groups of servers, compensate for malfunction, compensate for different ability or rights or capacity in obtaining access to information and/or processing it, complement each other in ability or capacity to process and/or obtain and/or store and/or communicate about and/or transmit information. In some examples, the one or more servers provide ability to add information by one or more servers to related information obtained by other one or more servers.

In some exemplary embodiments of the present invention the term client may be used for one or more clients. In some exemplary embodiments of the present invention the term client platform may be used for one or more client platforms. For example, it may be used to relate to one or more client units. In some examples of the present invention, a client performs tasks and operations, and/or communicates with other one or more network resources and/or one or more servers. In some examples, multiple clients perform various such activities independently, either concurrently, and/or at different times, and/or at partially overlapping times and/or at alternating times. In some examples, multiple clients perform various actions in synchrony and/or in communication with each other, as a peer-to-peer communication, and/or as group communication. In some examples, the one or more clients collaborate about and/or processing and/or communicating about and/or obtaining and/or sharing information. The present application relates to all the above cases as client.

In exemplary embodiments of the present invention the application platform is interactive magazine style application allows efficient and convenient searching and reading relevant content, and navigating quickly and seamlessly from content of one source or feed to related sources or feeds. In exemplary embodiments of the present invention the platform allows searching for related content based on relations among content and based on relations in the social network. This approach fetches articles related by interest and by other properties, not just specific terms or specific properties of the articles.

In exemplary embodiments of the present invention, the Platform is designed to give a solution for the above need. In an example, the platform provides an integration of at least one or more of three major services: (A) Knowledge Virtual Network, (B) Professional Social Network, and (C) Threaded Messaging Service.

(A) Knowledge Virtual Network is relating Knowledge Entities into Virtual Network. In an example, the relations are based on Schematic Properties of the entities, on keywords that are identified using Natural Language Processing, and/or on Social Activity and Messaging Activity.
(B) Professional Social Network is relating Human Entities into Actual Network. In an example, the relations are based on (B.1) User Preferences and/or on (B.2) suggestions based on Virtual Relations, and on mentioning in the Messaging Service. In an example, User Preferences include relations to the Virtual Network in the format of Virtual Channels, which are, in some examples, smart collections of Knowledge Entities adjusted according to relations in the Actual Network and/or the Threaded Messaging Service.
(B.1) User Preferences Relations in the Actual Network. In an example, User's account includes at least one or more of 4 types of relations: (I) Actual channels (Groups of people); (II) Virtual channels (Smart collections of articles—such channel is, for example, a search result modified for the user's actual network); (III) Actual entities (Relation to single person—such relation is, for example, used when the user doesn't want to see other users and block messages from them. In some examples, it is also used for pointing to other accounts of the same person, and/or it is used for any person-to-person relation); and/or (IV) Virtual entities (Relation to single knowledge entity—such relation is, for example, used for My Articles, Read Later, Favorites, etc. In some examples it is used for any person-to-article relation).
(B.2) Suggested Relations based on Virtual Network in the Actual Network—The user is offered to collaborate with other users based on relations in the virtual network, for example, when both users favorite different articles with strong article-to-article relation.
(C) Threaded Messaging Service is, in some examples, allowing professional discussions using extended micro-blogging service. In some examples, Mentions of Entities from the Virtual Network and/or from the Actual Network are generating complex relations, which are crossing between networks. In an example, there are Suggested Relations based on Threaded Messaging Service in the Actual Network, in which the user is offered to collaborate with other users based on posts, for example, when both users post a link to different articles, but with strong relations in the virtual network, and another example, when user mentions others in his posts.

In exemplary embodiments of the present invention, messages of some or all participants in a social network reveal the current trends in topics of interest (“hot topics”).

In examples of the present invention, content search, which return feed of results, is an advanced multi-stage search. For example, when the search term is new, the system (either on the client side, and/or on the one or more server side, and/or both) is bringing content from external sources. In an example, the new content is indexed into complex virtual network. In an example, the feed is made of the new content modified according to the user's actual network. In an example, the relations between both networks are maintained by the system to create natural grouping of users.

In some examples of the present invention, feeds are fetched without search in external content. In some examples, the system provides new feeds according to relations to currently browsed content. In some examples, related feeds are relaying on the user's actual network, the content's virtual network and the cross networks relations.

In examples of the present invention, the social network is allowing users to share messages and links. When looking on the content that was linked by the people that the user follows, the user is viewing Community Curated Content. The people that are followed by a user are a trusted source of information for that user. The platform is indexing traditional search for professional content, into the virtual network, and adjusting the results using social search. The platform maintains complex relations between the networks and within each network.

In conjunction with the detailed description of various aspects of some embodiments of the invention, it is to be understood that the invention is not necessarily limited in its application to the details of construction and the arrangement and/or order and/or format of the components and/or methods set forth in the following description and as illustrated in the drawings and elaborated by the examples. The invention is capable of other embodiments or of being practiced or carried out in various ways.

The present invention embodies many exemplary aspects and embodiments, each having many sub embodiments and alternatives, the aspects and embodiments include, but not limited to, communications among client and server platforms, server advisory role in loosely coupled client server interaction, content management, content storage, content processing, content sharing, content modification, modulating, reformatting, enhancing, reordering and augmenting, content accessing, content searching, content analysis, semantic similarity analysis, statistical analysis for fields of interest, content visualization, interactive display of content, content access rights, content sharing and payment management, social networks, virtual networks among content items, interaction between users and content, interactions between virtual networks of content and social networks, communications in the context of content, and the like. The present invention also relates to methods, systems, user interfaces, user interaction, user experience, formatting, display, visualization and designs related to the implementation and/or control of each one or more of these aspects and embodiments and their sub embodiments and alternatives. Each of the aspects and embodiments of the present invention and/or each of their sub embodiments and alternatives may be practiced in itself or in combination with other aspects and embodiments of the present invention and/or each of their sub embodiments and alternatives. Each of the aspects and embodiments of the present invention and/or each of their sub embodiments and alternatives may be practiced in the order described and/or in any alternative different order, including for example different order of presentation and/or different order of data access and/or different order of communications. Hence, the present invention encompasses as novel and inventive concepts all combinations and sub combinations of each of these embodiments and aspects of the invention as well as combinations and sub combinations of each of the sub embodiments and alternatives of any of these embodiments and aspects of the invention and this application should be read as if each such combination and/or sub combination of each of the embodiments and aspects of the invention and/or their sub embodiments and alternatives is described in particular.

Thus, it is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination. Although the invention is been described in conjunction with specific embodiments and examples thereof, it is evident that many alternatives, modifications and variations will be apparent to those skilled in the art. Accordingly, it is intended to embrace all such alternatives, modifications and variations that fall within the spirit and broad scope of the appended claims.

### Technological Features of Exemplary Embodiments of the Present Invention

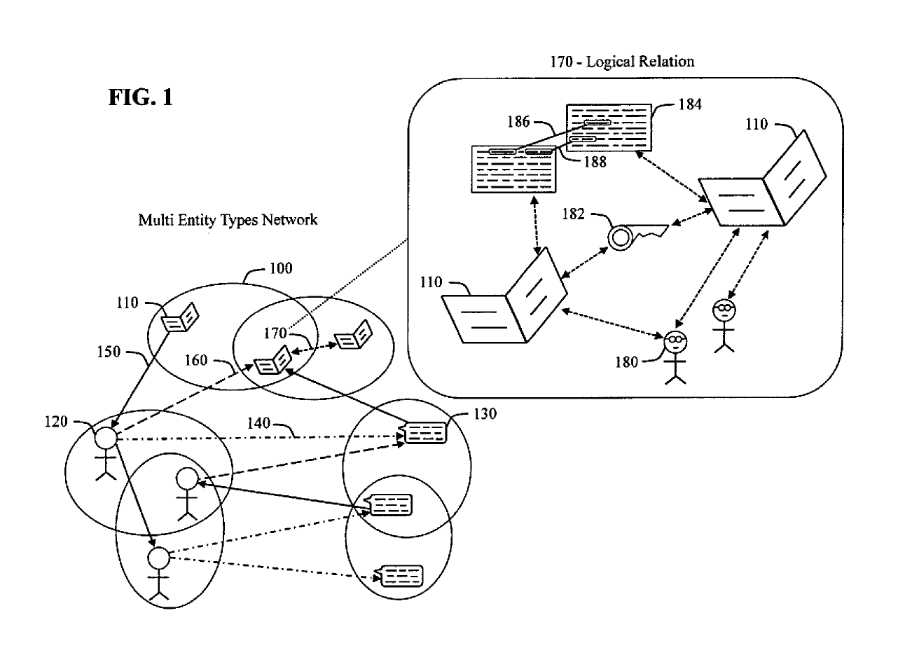

### FIG. 1—Multi Entity Types Network

In exemplary embodiments of the present invention, the professional, social, and virtual network is made of multiple entity types and Collections of Entities 100. For example, an entity is, but not limited to, an Article 110, a User 120, a Discussion 130, etc. In an example, when one entity is creating another entity, etc., the platform maintains a Creating Relation 140. In an example, when an entity is referencing another entity, as the author, or as a reference, or simply mentions the other entity, etc., the platform maintains a Referencing Relation 150. In an example, when an entity expresses an interest in another entity, such as user reads an article, user reads a discussion, user hides another user or article for himself, etc., the platform maintains a Signal Relation 160. In an example, the platform maintains a Logical Relation 170 when two entities are related by Shared Authors 180, and/or Shared Properties 182, which are similar attributes of both entities, like the year of creation, the publisher, etc., and/or statistics relations and/or textual analysis based relations and/or data similarity and/or Natural Language Processing (NLP) relations between the Full Text 184 and/or the abstracts and/or the meta-data of both entities. In an example, when a synonym word, and/or uncommon word, etc., appears in both entities, the platform maintains an NLP relation of a type Dictionary Relation 186. In an example, when one or more multi-words expressions, and/or one or more phrases, etc., appear in both entities, the platform maintains an NLP relation of type Phrase Relation 188.

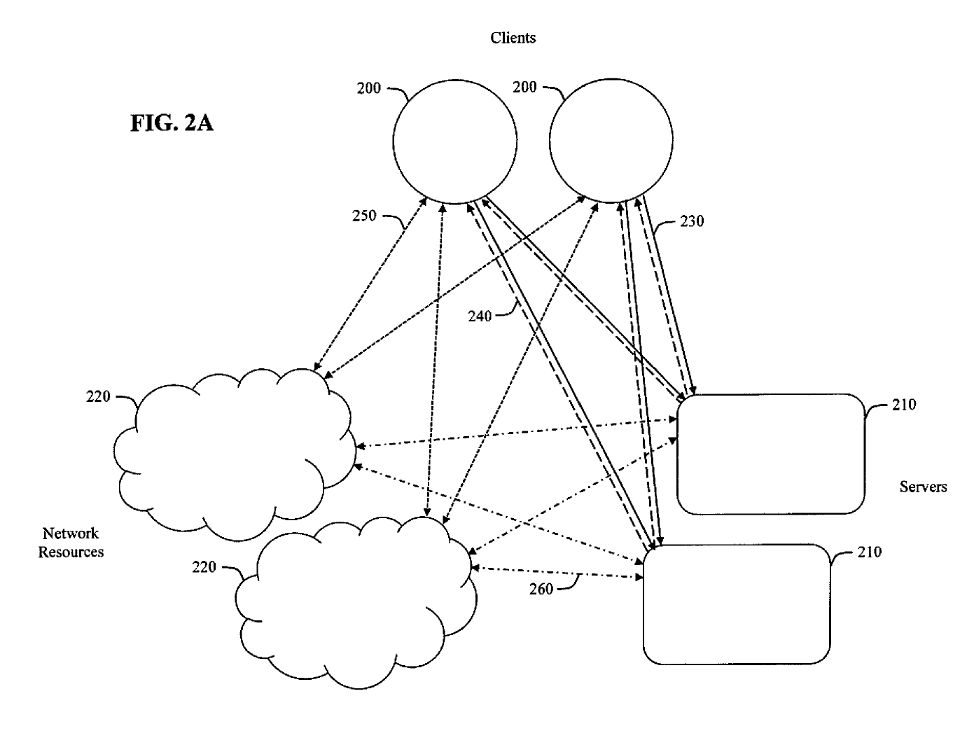

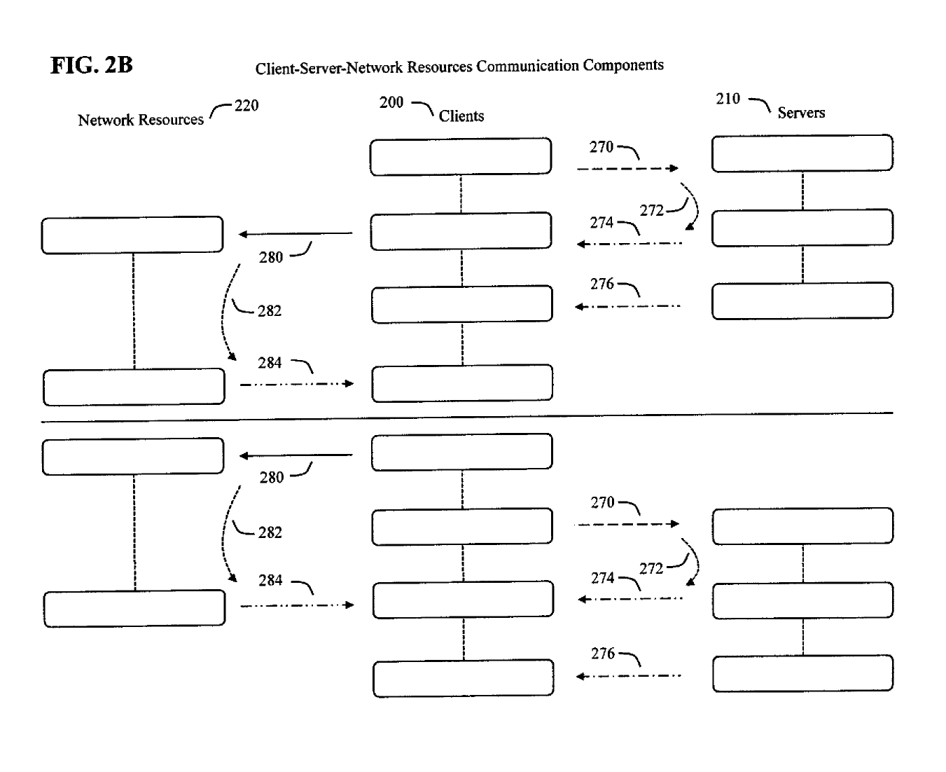

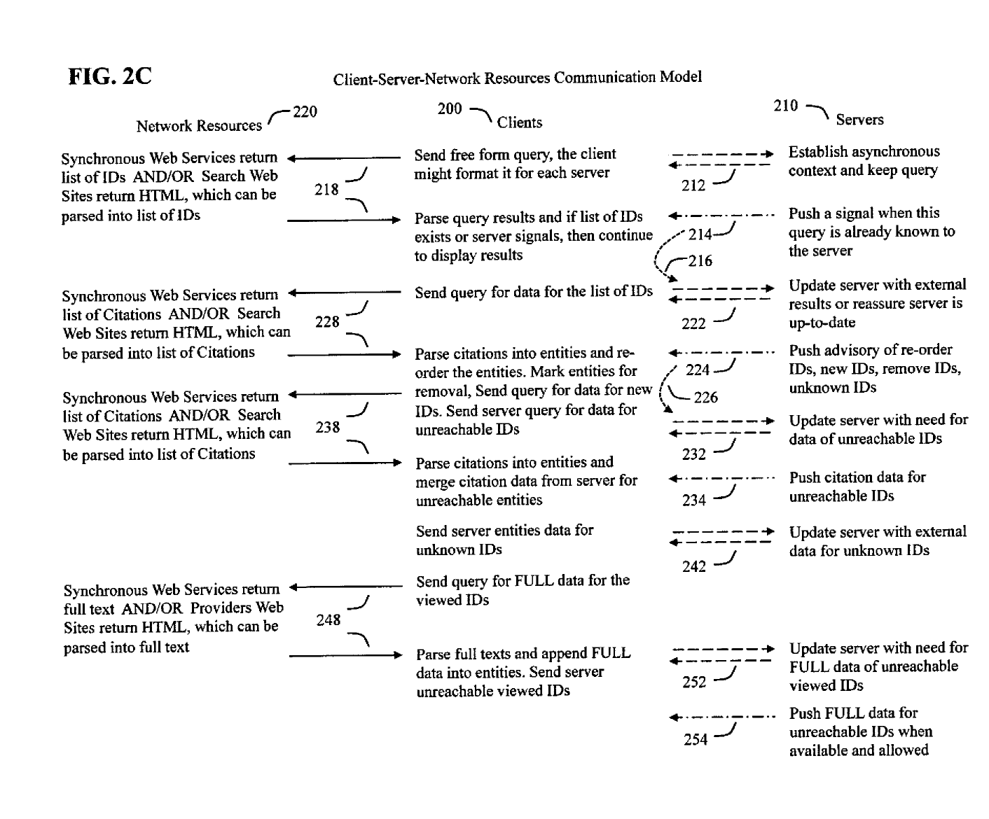

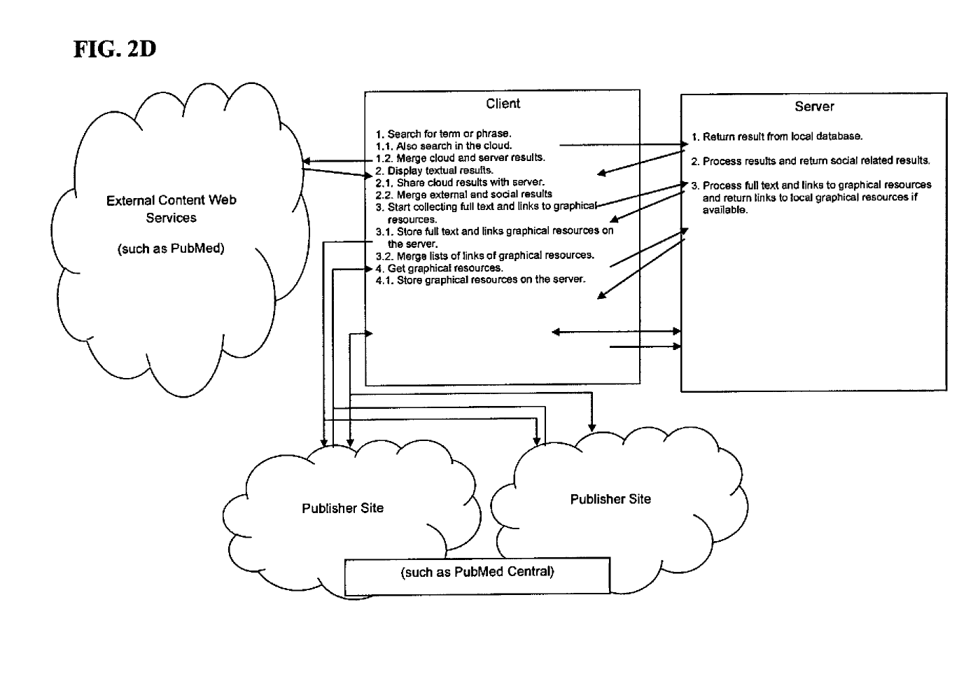

### FIGS. 2A, 2B, 2C, 2D—Client, Server and Network Resources Communication

### FIG. 2A

In exemplary embodiments of the present invention, the professional, social, and virtual network and user experience are built by a set of communications between the Clients 200, the Servers 210, and the Network Resources 220, which are providers of search services, publishers, aggregators of data (like PubMed, IEEE), public databases, user contributed publication services, web-based information sources, local data storages, experimental results data centers, etc., and/or any other resource on the network with content relevant for the network.

In an example, the user works on the client platform without the need to access the server or the network resources for obtaining information, for example, when offline and/or soon after becoming online, and/or when looking into data that already resides on the client platform, and/or when generating new information, and/or when generating communication before actually sending it to others, etc.

In an example, the client platform approaches one or more network resources in order to obtain information, for example to search, or with a query to obtain one or more streams of on-going information or on-the-fly updating information.

In an example, the client sends to the server a message with data of one or more data types (see FIG. 1), such as user profile and fields of interest, user status, current and/or past user queries, current and/or past user communications, information currently and/or previously generated and/or contributed by the user (e.g. user's publication, research documents, experimental results, databases, etc), and/or information related to Channel, and/or Entity, and/or any Part of Entity, and/or processed information based on one or more entities, and/or statistics related to one or more entities and/or channels, and/or with Relations (see FIG. 1) associated with the data, and/or with preferred Advisory Types. This message is called Notify Communication 230, as it is notifying the server of a user general interest and/or current intent, and or current activity, and/or new data obtained by and/or generated by and/or processed by the client and the request to update the server and potentially seeking additional data. In an example, such message includes parts of data, and/or full copies of data, and/or processed data, and/or analysis related to the data and/or statistics related to data, and/or attributes related to data that resides on the client side and/or obtained by the client. In an example, such message includes information related to the user's status, and/or the user's current and/or past interest, and/or the user's current and/or past explicit queries, and/or analysis of implicit topics of interest of the user, and/or user's profile. In an example, such message includes information related to the user's connection with other people, including for example details related to general contacts, and/or lists of professional connections, and/or people or groups of people or entities or institutions with whom the user has communications and/or other contacts and/or partnership and/or affiliation and/or association, current and/or past contacts, and/or users related to content that the user has interest in (e.g. authors, active users within a certain field of interest), and/or people that user follows their publications, communications, and/or discussions related thereof. In an example, such message includes information related to visualization, statistics of visualization and usage, preferences of visualization, etc.

In an example, the server process the client's message and asynchronously sends related data to the client, based on the preferred advisory types. Such asynchronous response is called Advisory Communication 240. In exemplary embodiments of the present invention, the server's response can come at any time, or not at all, in one or more messages, in one or more fragments, in various types, in one part or few parts or stream of information, and/or with partial info. In some examples, server message or response is triggered when some other events happens at the server side and/or on the social network, and/or by other users, and/or by other information sources accessed by the server, and/or by processes that occur at the server from time to time, and/or when the server has the resources (e.g. processing and/or communication) to handle and process information relevant for the client.

In exemplary embodiments of the present invention the one or more Network Resources communications with the Client are based on responding to the client's requests, and thus start synchronously, though client can continue and receive further information synchronously and/or asynchronously. In some exemplary embodiments of the present invention the one or more Server communications with the Client are based on responding to the client's requests, and thus start synchronously, though client can continue and receive further information synchronously and/or asynchronously. In some exemplary embodiments of the present invention the one or more Server communications with the Client are completely asynchronous, and after the Client connects to the server, and/or provides to the Server updates about events and/or requests and/or field of interest and/or similar notifications, the Server sends from time to time asynchronous to the client. In some examples of the present invention, such asynchronous information is advisory information that allows the client to integrate it with the information that the client already has and/or to process and/or augment or modify or reorder the information that the client has, and/or to presented it to the user and/or to use for offering functionality to the user, and the like. In some examples, some or all of such information exchange between client and the one or more servers forms a loosely coupled relationship and/or voluntary information exchange, in which the client can operate, at least in part, without the servers' input, and/or can rely on all of, or part of, or none of the server input, and/or can process the server's information in various ways as the client is configured, and the server can reply and/or provide detailed information, and/or provide some part of information that the server has, and/or provide some information at a certain time and some information at other time. In some examples, this loose coupling allows some of the client and server communications to be without commitment and each can operate independent of the other to some extent. In some examples, each side updates the other side on some or more of the information that it has and events that occur, at various time selected by the sending side, and the other side can process part or all of the received information at time selected by the receiving side, and can choose to use the information in part or in full, and can update and/or process and/or augment its information in part or in full, and can provide or not provide response of various types and completeness levels at any selected time.

In an example, when a client queries a Network Resource, and/or fetch assets, such as images, figures, multimedia, etc., the platform maintains a Fetch Communication 250. In an example, when a server query a Network Resource, and/or fetch bulk of data, and/or fetch assets, etc., the platform maintains a Bulk Communication 260.

In an exemplary embodiment of the present invention, the client follows available information to pre-fetch and obtain information from either the one or more network resources and/or from the one or more servers. In some examples, the client and/or the server use pre-fetch of information, in order to access and download information from network resources before the user requests it. In some examples, the pre-fetch is used to improve significantly the user experience and reduces the overall wait time. In some cases, the pre-fetch is used by the client and/or the server for interim statistical analysis of pre-fetched content, and/or for further identifying relevant fields or relevant content or relevant communications for the user, and possibly to analyze that pre-fetched content for determining similarity with the field of interest of the user, and/or for generating priorities and/or prediction for identifying information that may be of interest to the user even though the user may have not yet seen and/or requested it. In some examples, such pre-fetch is performed sequentially along possible information sources, and in some examples such pre-fetch is performed randomly, or based on statistical analysis and/or heuristics that is used to predict what is likely to be desired by the user, based on user consumption habits, based on textual analysis, based on current user field of interest and/or the like. In some exemplary embodiments, a pre-fetch is done not only to advance the download of content, but also to automatically generate further searches for information from network resources, and to analyze and follow the provided search results and information. In some examples, the pre fetch process follows through links and information, proceeds from one or more lists to citations, and/or proceeds further to obtain abstracts and/or proceeds further to obtain full-text of available content and/or to images or multimedia icons and/or to various quality or full-resolution multimedia, and/or to metadata, and/or to tables and/or to other data associated with the content and/or article. In some cases, pre-fetch is performed in the context of articles, search, discussions, and other information type that can lead to links and further associated information.

In some examples, the pre-fetch, and/or statistical or textual or properties analysis of pre-fetched content occurs before and/or in parallel to the user requests, and in some examples a statistical analysis of user behavior and/or interest is considered in order predict and determine which information to pre-fetch first. In an example, any one or more of network overall bandwidth, network latency, network utilization, network availability, network connection type (i.e. cellular, WiFi, LAN, other), network communication cost and other network properties are used to determine any one or more of which information to pre-fetch, at what level of details, at what priority, when, in which order, and how to balance and prioritize such pre-fetch communications relative to other communications between the client and the one or more servers and/or between the client and the one or more network resources. In an example, this consideration is performed by the client and/or the server and/or both.

In some examples of the present invention, pre-fetch continues by the client and or the one or more servers to seek further related information again and again in order to further expand the information sources and to predict what else could be of interest to the user. For example, fetch of content such as one abstract and/or article, analyze key content characteristics, follow links and/or search for additional content with these keywords or characteristics, analyze the search results, pre-fetch some of those results and then again analyze, follow links and/or initiate further search, analyze, pre-fetch, etc. In an example, these processes occur one or more times in the background without requiring the user input while these are performed, and enable the server and or the client to further expand the possibilities of relevant content for the user much beyond any simple one-time keyword search, and based on analysis of fields of interest and inter-article similarities and relations. In some embodiments, such pre-fetch and analysis process occurs while obtaining information from network resources. In some examples, such pre-fetch and analysis process occurs while using information or characteristics or meta-data or statistical representation, or other properties of the content as they already present in the one or more servers and/or one or more clients.

### FIG. 2B—Client-Server-Network Resources Communication Components

In exemplary embodiments of the present invention, the professional, social, and virtual network and the user experience are built by a set of communications between the Clients 200, the Servers 210, and the Network Resources 220, which are providers of search services, publishers, aggregators of data like PubMed, IEEE, etc., and any other resource on the network with content relevant for the network. When the client sends Data to Server 270, such as intent, user data, collected data, partial data, and/or any other type of data, the server establish context and Analyze the Data 272, according to the analysis, the server start a series of push of Data to Client 274, such as advisory and/or relevant data. When the server encounter an event, such as other user updates, background process updates, etc., it will push Data Update to Client 276. When the client need data and/or assets, such as figures, media, etc., it sends Request to Network Resources 280. Such request can be triggered by the user and/or by background process to update client's existing data. The queried Network Resources are Compiling Results 282 and then Return Assets and Results 284. As shown in the figure, in some exemplary embodiments of the present invention the Network Resources communication with the Client is loosely coupled with the Server communication with the Client. In an example, the Client platform defines each communication as not dependent on another communication, to the point that data is only fetched from the Client's local database.

### FIG. 2C—Client-Server-Network Resources Communication Model

In exemplary embodiments of the present invention, the professional, social, virtual network and user experience are built by a set of communications between the Clients 200, the Servers 210, and the Network Resources 220, which are providers of search services, publishers, aggregators of data like PubMed, IEEE, etc., and any other resource on the network with content relevant for the network. When the client sends a Query to Server 212 the server establish context asynchronously push Signal to Client 214 if such query is known to the server and advises the client on Preferred Following Communication 216. In parallel or independently the client sends Query to Network Resources 218 to obtain IDs and/or links and/or content, which representing the query results. This procedure repeats for more detailed type of data, so similarly, the client sends the Query Results to Server 222 and asynchronously the server push Data Advisory 224 such as re-ordering of the results, additional results, results to hide, etc., and results which are unknown to the server, which is advise for Preferred Data Communication 226. In parallel or independently the client sends Data Request to Network Resources 228 to obtain more detailed data, such as citations, which representing the more detailed results for a tuned query. When client is advised to get data for new IDs, which the server add to the scope of the query results, the client sends Additional Data Request to Network Resources 238. The client sends an Unreachable Request to Server 232, means that Network Resources could not supply. The server push detailed Network Unreachable Data 234, such as citations and figures the client needs, but cannot obtain from Network Resources. The client, based on the server advisory for unknown results, sends Data of Unknown to Server 242. When user need to watch see full text of article, the client sends Full Data Request to Network Resources 248. The client, based on the server advisory, sends Full Data to Server 252, such as text, assets, figures, media, etc., and the server push Network Unreachable Full Data 234, such as full text and figures the client needs, but cannot obtain from Network Resources but is eligible to obtain.

### FIG. 2D

FIG. 2D represents another exemplary embodiment of the present invention demonstrating the client-server unique co-function and communication. In exemplary embodiments of the present invention, some or more of the communication steps listed in FIGS. 2D are implements, in the order shown in FIG. 2D or in other alternative orders.

### FIG. 3—Channels Display

In exemplary embodiments of the present invention, the user experience is built to utilize the professional, social, virtual network. A user is presented with the Channels Screen 300 when need to see multiple channels (see FIG. 1). In this screen there are toolbar controls 310 to manage the user's profile (user's entity), manage the visualization of the screen, manage aspects of the set of channels, etc., Also there is a Screen Title 320 to represent this set of channels. For example, a set of channels, for example, user's topics of interest, user's groups of people, user's recent searches, etc., presented, so each Channel 330 is a control with rotating assets, such as images, and/or multimedia, and/or tables, etc., Selecting the channel, by click or tap or other method, will present Entities Screen (see FIG. 4) for the selected channel For each channel, an Actions Control 340 is presented. Selecting the actions control for a channel, will present Action Menu 350 to allow performing additional actions on the channel, such as presenting Entities Screen (see FIG. 4) for related entities (for example, authors of articles, discussions related to articles, discussions initiated by group of people, articles mentioned in channel of discussions, etc.). Search Control 360 allows querying the server for channels using natural language. The Result of Search 370 is an ordered list of channels, with categories (category per entity type). Each item in the result list shows the Channel Title 380 and Channel Assets 390 rotating, such as images, and/or multimedia, and/or tables, etc.

### FIG. 4—Entities Screen

In exemplary embodiments of the present invention, the user experience described in this invention is built to utilize the professional, social, virtual network. For example, a user is presented with the Entities Screen 400 when need to see multiple entities (see FIG. 1). In this screen there are toolbar controls 410 to manage the manage the user's profile (user's entity), manage the visualization of the screen, manage aspects of the channel, etc., Also there is a Channel Title 420 to represent this set of entities. A channel, for example, articles of searched topic, most recently read articles, discussions related to an article, group of authors related to topic, etc., presented, so each Entity 430 is a glimpse to the full data. The layout of the entities is based on both the entities as well as Ads 490. Each entity includes data of the entity or related entities if needed, such as Entity Title 432, and/or Entity Authors 434, and/or Entity Source 436, and/or Entity Media 438 such as rotating images, and/or multimedia, and/or tables, etc., Selecting the entity, by click or tap or pinch-out or other method, will present Entity Screen (see FIG. 5) for the selected entity. For each entity, an Actions Control 440 is presented. Selecting the actions control for an entity, will present Actions Menu 450 to allow performing additional actions on the entity, such as presenting Entities Screen 400 for related entities (for example, authors of article and related articles, discussions related to article and related articles, discussions of related people, related articles to articles mentioned in discussion, etc.). Search Control 460 allows both narrow-down the number of entities in the displayed channel, as well as querying the server for new channels using natural language. The Result of the Search 462 is an ordered list of entities and channels, with categories (first are the entities of the narrowed-down channel, then channels categorized by entity type). Each item in the result list shows the Entity/Channel Title 470 and Entity/Channel Assets 480 rotating, such as images, and/or multimedia, and/or tables, etc., Ad 490 will include different set of actions in the Actions Menu 450 and will allow user to present articles related to the ad, discussions mentioning the ad, etc.

### FIGS. 5A-5L—Entity Display

### FIG. 5A—Entity Screen (Example for Article)

In exemplary embodiments of the present invention, the user experience is built to utilize the professional, social, virtual network. For example, a user is presented with this Entity Screen 500 when need to see single entity (see FIG. 1), which representing article. In this screen there are Toolbar Controls 510 to manage the user's profile (user's entity), manage the visualization of the screen, manage aspects of the entity, share the entity, perform other actions with the entity, etc., There is an Entity Screen Title 520 to represent the user name or the publisher of the entity or other attribute of the entity. Article Title 530 is displayed at the beginning of the scrollable/flip-able/page-able content, as in professional content such title is too long to occupy a fixed control on the screen. Following the title there is attribution for the Entity Authors 532 and Other Entity Attributions 534, such as departments of authors, journal's issue and pages, publishing date, etc., Each section of the article is starting with Section Title 536, for example, abstract, introduction, results, etc., Followed by the Text of Section 538, for example, the article's abstract. While the toolbar controls 510 allow some actions on the entity, more actions are visible in Secondary Toolbar and provide another area of more accessible actions. Following are some examples for such actions: In the case the user have no permission to view the full text of the article, a Buy Control 550 that allows the user to pay for access (in case his account is established with payment method, the process will only prompt for confirmation and a purchase record will be added for the user). To allow offline reading of an article Reading Control 552 is displayed. To start a discussion about this article a Discussion Control 554 is displayed. To allow the user to both read the text as well as look on the figures, media, tables, etc., the Entity Splitter 570 is allowing to switch between different reading experiences (see also FIG. 5d). In the Assets Column 580 there are figures or other assets, which are displayed in different sizes and ordered according to the visible text and/or relevant to the visible text. The client orders the assets so the Largest Asset 582 is one recommended based on the text position and/or other user interaction. The user can scroll or page through the assets. Between the assets, the client display Ads 590. The secondary toolbar includes more actions related to assets, such as displaying Related FIGS. 586 and Sharing FIGS. 584.

FIG. 5B—Entity Screen (Example for Article with Full Text)

In exemplary embodiments of the present invention, when full text is shown, the Buy Control is not displayed. When viewing Assets Column 580 the Full Text 540 is scrollable and/or flip-able and/or page-able. When a Text Precedes Section Title 542 is partially displayed, assets referenced in this text are displayed before the Largest Asset 582. The displayed Section Title 544 is the main focus point, while there is no user interaction and/or the user only scroll or flip or page through the content. The first Asset Reference 548 in the Text Following Section Title 546 is the recommended Largest Asset, when it is visible.

FIG. 5C—Entity Screen (Example for Article with Expanded Image)

In exemplary embodiments of the present invention, when user click or tap or select in other way an asset, such as figure, media, etc., in this example the Largest Asset 582, the client displays the asset in a large view with Asset Title 584 and the Asset Text 586. An Actions Control 588 is displayed to allow performing an action with the asset, such as start new discussion about the asset, share via email (when user have rights to do so), etc.

FIG. 5D—Entity Screen (Example for Article with Images Bar Closed and with Next Page Button)

In exemplary embodiments of the present invention, when the user is using the Entity Splitter 570 to hide the assets and switch into full textual mode, the scrolling and/or flipping and/or page turning behavior changes. Page Controls 572 are visible and providing the user guides to a recommended page turning mechanism for the current reading mode.

### FIG. 5E—Screen Shot Example

FIG. 5E shows exemplary screen arrangement and format that is used in exemplary embodiments of the present invention.

### FIG. 5F—General Flow Between Screens

FIG. 5F shows an exemplary representation of user interface screens flow that is used in some exemplary embodiments of the present invention.

### FIGS. 5G-5H—Topic Channel View and Variable Search Layout

FIGS. 5G-5H show exemplary representations of a variety of screen layouts for displaying channel and/or topic as used in some exemplary embodiments of the present invention.

### FIGS. 5I-5J—Abstract View and Article View

FIGS. 5I-5J show exemplary representations of screen layouts for displaying abstract and article, with previous page and next page controls, as used in some exemplary embodiments of the present invention. For example, when presented with long form textual content, with or without embedded objects, such as equations, graphs, tables, or any other object that is embedded in the text, the client offers appropriate scrolling of the content, and allows flipping and/or paging of the content, using clickable/tap-able controls and/or touch based swipe and/or other gestures. The separation of text and media, such as figures, charts, etc., allows fast scrolling through text, while the media displayed in accordance to references in the text. The user can configure the media to be sorted linear, as in the original published form, or sorted according to references in the text, or sorted by type of media, or other sort options. The user can configure the media bar to scroll automatically, so relevant media is displayed with context of the article.

FIG. 5K—Actions within Article View

FIG. 5K shows an exemplary representation of actions menu for a single article, which allows the user to navigate to related information, as used in some exemplary embodiments of the present invention.

### FIG. 5L—Person View/My Profile View

FIG. 5L shows an exemplary representation of screen layout for displaying person, with “previous” and “next” controls for publication and affiliation, as used in some exemplary embodiments of the present invention.

### Search for an Article

The following approaches describes in this section deal exemplary embodiments related to searching for content, such as an article.

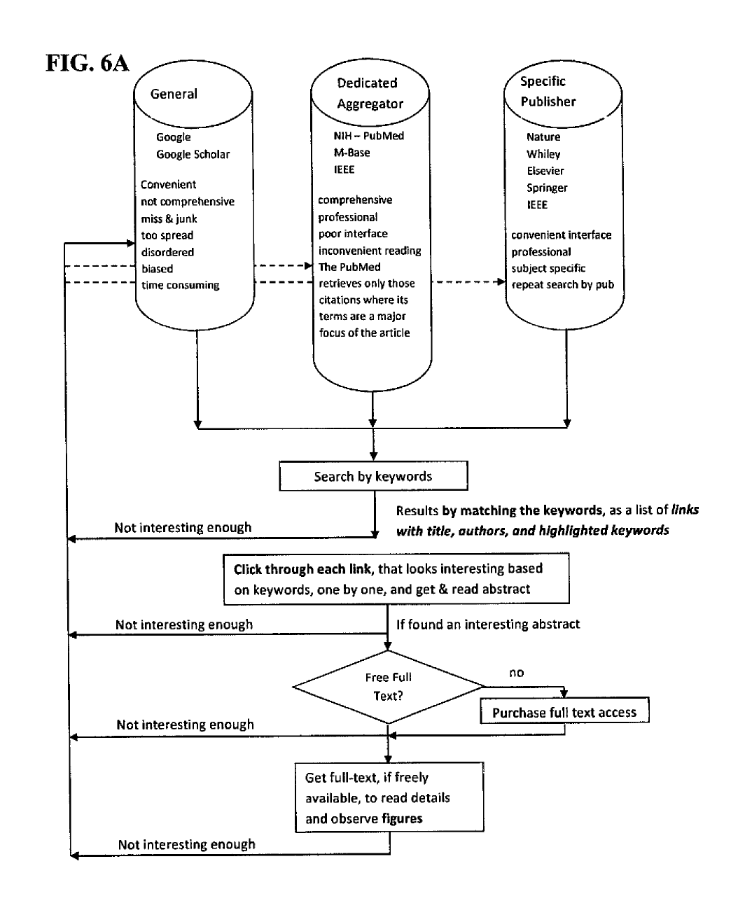

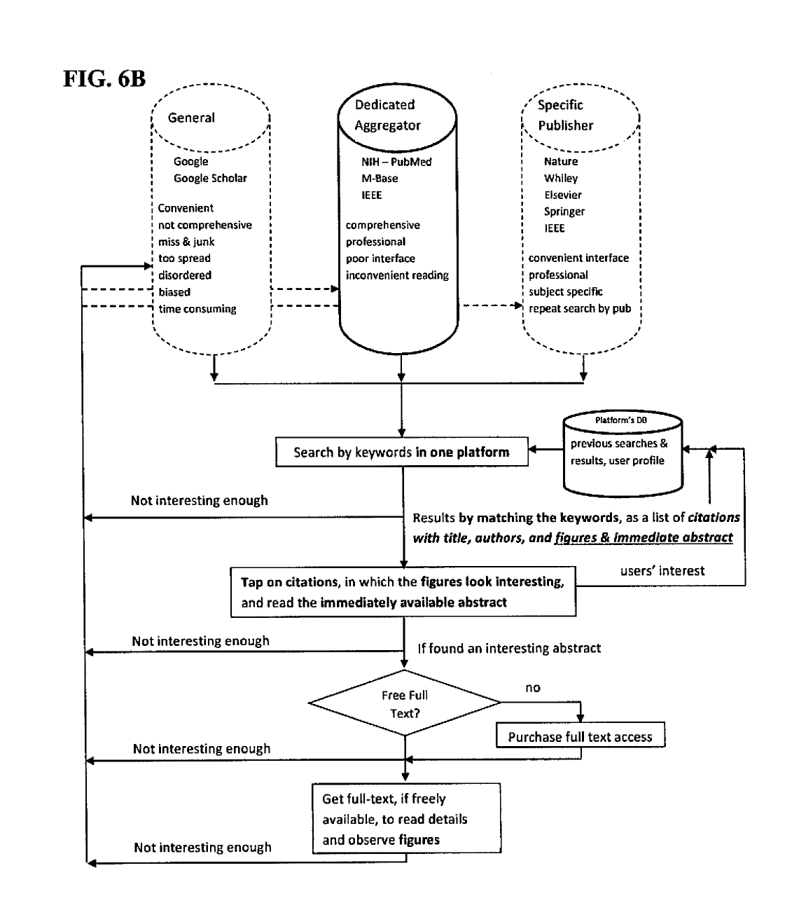

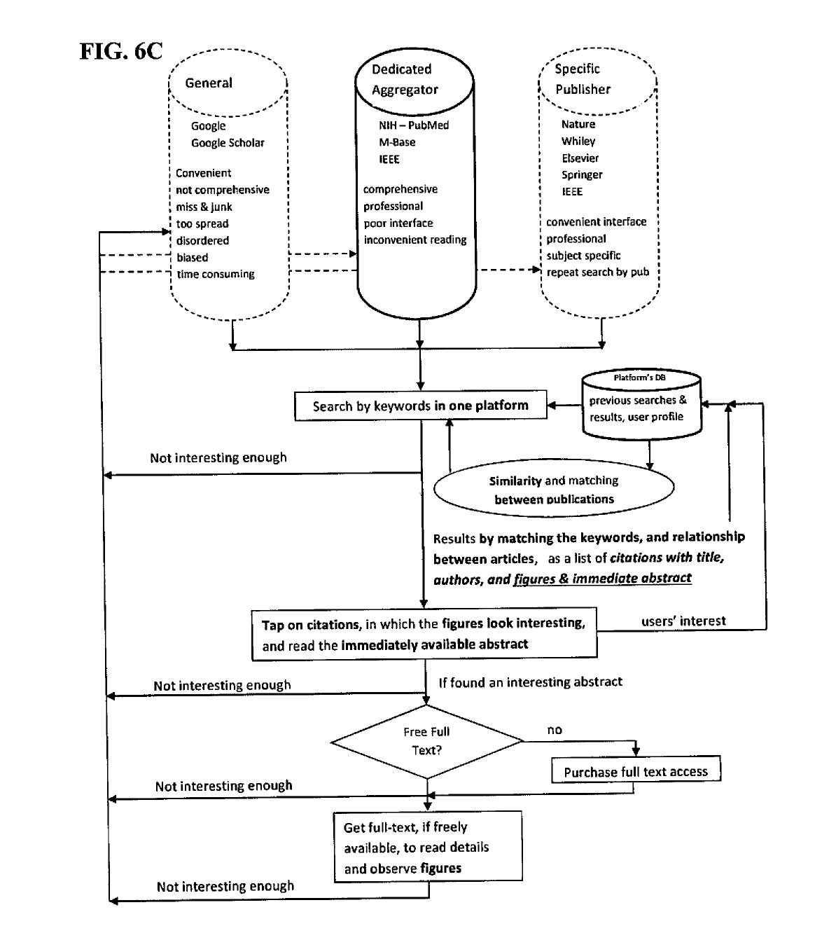

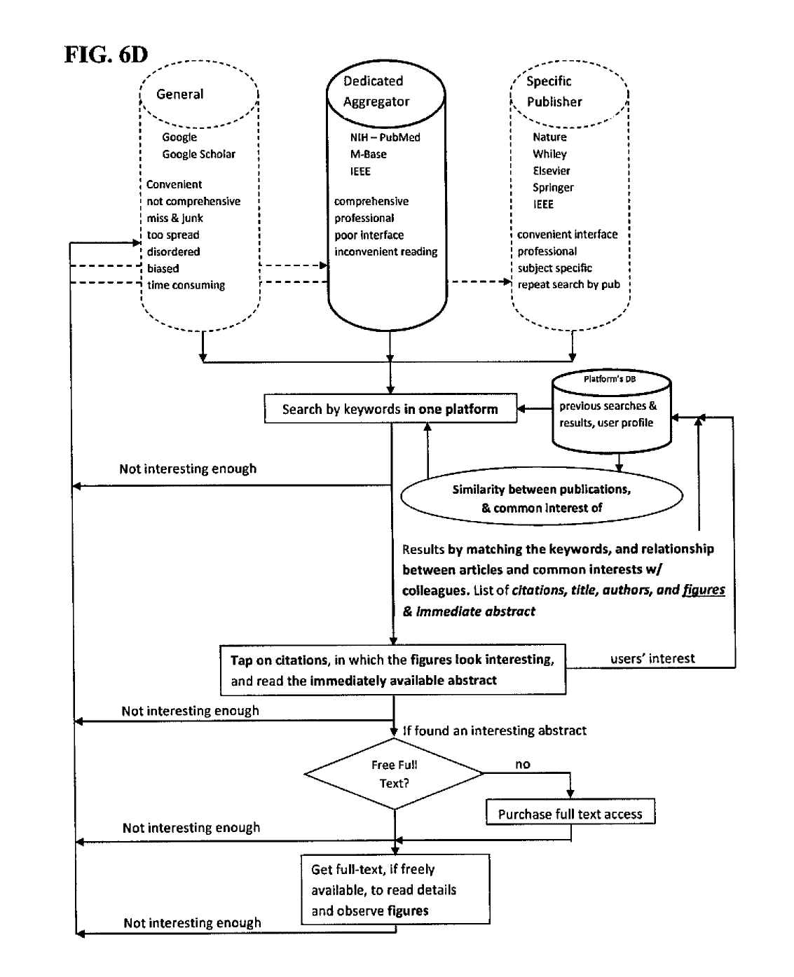

### FIG. 6A

In existing approach, a user is capable to provide keywords, and the Results are returned according to these keywords, as a list of links with title, authors, and highlighted keywords. Such results are based on either (i) general search tools (e.g. Google and similar), yet the results are not comprehensive, too spread, biased, disordered, not focused, with too many irrelevant items, and time consuming to the user; (ii) dedicated aggregators (e.g. PubMed), which are comprehensive, and professional, but might still miss similar relevant items or bee too broad, and very inconvenient to browse through and find the relevant items; or (iii) search tools of specific publishers, that may have convenient interface, but are not comprehensive, and thus require the user to repeat and search in other publisher's interfaces. In all those cases, the user needs to click through each link, that looks potentially interesting based on keywords, one by one, and get and read the abstract, and then obtain or purchase full text access, download it and read, while usually examining the main aspects, including for example, conclusion and figures representing the main results and finding. In each of these steps, the user often decides that the current article is not relevant, and thus needs to go back-and-forth in the steps repeatedly, with a lot of click-through steps and long wait time.

### FIG. 6B—New Approach #1

In exemplary embodiments of the present invention, query results are by matching the keywords, as a list of citations with title, authors, and figures & immediate abstract. For example, Keywords are highlighted, Figures are presented and potentially flipping (rotating among several figures when presented near the highlights of the article).

### FIG. 6C—New Approach #2

In exemplary embodiments of the present invention, query results are by matching the keywords, and relationship between articles, as a list of citations with title, authors, and figures & immediate abstract. For example, a virtual network of documents is used to provide related articles at a higher priority (earlier) in the search results, not only those articles that match the keywords.

### FIG. 6D—New Approach #3

In exemplary embodiments of the present invention, query results are by matching the keywords, and relationship between articles and common interests with colleagues. For example, list of citations, title, authors, and figures & immediate abstract.

In exemplary embodiments of the present invention, the professional social network is used to affect the order (priority) in which articles are presented on a search results: explicitly (recommendation/scoring/scoring per category/“like”), by communicating (blogs & reviews in the system, comments/minds), and implicitly—by observing the amount of time spent by others reading each article.

In exemplary embodiments of the present invention, an important part is the score, which is not only a general property of each article (got N positive recommendations) but rather associated with the social network: by the specific persons with whom the user has professional relationship (the article got K positive reviews by the colleagues, was read by my colleagues, etc). Privacy shall also be kept in order not to make an explicit reference to the colleagues that read the article (e.g. rough numbers only, and above a certain statistics of e.g. 10 other users, to avoid pointing to a certain colleague that read the article).

### Making New Contacts for Collaborations

In existing approach, professionals (e.g. Researchers, Physicians) can meet at conferences and other scientific committees where professionals present work, and can make contacts there. Alternatively, they can meet at their research & work facilities (labs, seminars, etc). Also, professionals read an article and search ways to communicate with certain author in order to share certain beliefs and attitudes about what they do or to solve a common problem and potentially establish collaboration about matters of interest which is critical for their professional progress. Normally the professionals contact each other by searching the details of the author (institution, telephone number, email address etc). For instance, they are approached by email. The professional may face some obstacles. There is a limited ability to know what is the current field of interest of a certain person, or what are the current contact details (The source for contact information could be an article from years ago which is not updated with the current contact information). Another obstacles is when the details of one author from a certain article are usually clear while other authors contact info are less easy to track; Additional obstacle is that there are no clear details of other professionals that are interested in the field and in specific article.

In exemplary embodiments of the present invention, the platform includes mechanism to overcome the above obstacles, Users forms an explicit social network, by one or more of (A) Adding list of contact, search for a name and profile and add to their lists; (B) Invite others through other means (emails, social networks, chat, phone, etc) by which they register to the system, add the details and form a connection; (C) Import existing contact and networking (relationship) details from other platforms, such as email & contacts system (e.g. Outlook, Google etc), social networks (e.g. Facebook, LinkedIn, Twitter, etc) and other data structures and applications; (D) The user arranges his contacts into “groups” and “subgroups”; (E) The user collects contacts and groups into other greater groups by any category user chooses. In particular, groups and subgroups are hierarchical; (F) a contact is part of multiple groups which the user has.

In another mechanism to overcome the above obstacles, A user creates group which are no longer local personal collection of contacts but rather become a published group: from that point it becomes a “forum” to which other users join and/leave. It could be open to all, or private=for a closed collection of users who are permitted to join. It could be managed by a certain user, and additional users later become managers and/or leave managing position.

In some exemplary embodiments of the present invention, additional mechanism the platform improves over the existing obstacles, Occasionally, randomly, systematically, or as a result of searches made by users, the system approaches authors of articles that the system has information about. In some examples, each article has at least one contact email address explicitly mentioned. In examples, the system then approaches by email that author, if not approached before, offering the other author to join the system and thus obtain one or more of: (A) Validated and up-to-date contact details of an author, in case users want to approach that author; (B) The author then become a registered user, thus being approached directly within the system and identified automatically as the author; (C) Obtain other contact approaches for that author (in case the user wants to be notified about events in the system—e.g. responses to his articles etc—through additional means); (D) Confirming with the author the list of other articles that this author has contributed to; (E) Confirming with the author details of the other co-authors, to be approached as well; (F) Obtaining up-to-date fields of interest and topics that the author wants to be approached about.

In exemplary embodiments of the present invention, better collaboration is also achieved by one or more of: (A) Offer a user that reads an article to directly contact the author(s) of that article; (B) Offer a user that reads an article to explicitly mention that the he is interested in this article, and is willing to be contacted about this article. This allow users to approach other users that showed interest and want to be contacted about a certain article; (C) Allow a user to create or join a discussion (“Mind”) on a specific article, or create or join discussions (“Minds”) that are controlled by groups in which the users is a member, or create or join any other discussion (“Mind”) on any subject (articles, fields of interest, a certain global field, a project) in a “blog” manner, which is open to the public, specific to a certain other user or users, or open to a certain group—per the preference of the user, provided that the user has the relevant permissions.

In some exemplary embodiments, as a result of the above mechanisms: (A) Users search for other people who were interested in an article; (B) Users communicate about articles; (C) Users create a discussion or post into a discussion on any subject that they have interest in and have permission to; (D) Users search for discussions (“minds”) that relate to a certain topic or a specific article, and by joining these discussions the user makes contact with the other participants in that discussion.

In exemplary embodiments of the present invention, a search for people that have interest in a certain topic is directed to a certain time period and the result is kept up-to-date to notify the user when additional people are added to the search results. For example, look for people that wrote/published/showed interest within the last day, week, month, year etc.

### Visualization

In existing approach, users are required to perform multi-click navigation, moving from search database, to citation list, to each link for abstract, to other full-text providers. Each click takes time to load, no uniform interface. This process is time consuming and tedious and laborious search process.

In exemplary embodiments of the present invention, one or some or all of the following are implemented: (A) a visual search, emphasize figures, flipping figures within the same citation; (B) Adaptation of dimension of text and figures to the screen dimension, especially in tablet; (C) Incorporation of ads in a manner that does not overlap searched matter and does not pop-up to cover searched matter, yet in predefined proportions to the presented search results; (D) Easy interface (iPad) foster interaction by swiping a finger across the screen/scrolling through multiple results with no wait time for obtaining next citations. In some example, pre-fetch of citations, abstracts, full text (citation may include links to full text content), and/or figures is implemented. In some examples, minimize wait time for next clicks for abstract view, full-text view and figures. In some examples, the pre-fetch goes all the way from citation to abstract to full text to figures (to the extent available) in advance and rearranging and placing information from all these (especially figures) already at the stage of the preliminary presentation of the search results; (E) Add additional external information to affect the search results, including information based on other users, popularity, subcategories of topics from the database, marking new-updates (search results which have just published), marking those that were especially popular ranked/read/wrote-about by colleagues; (F) Ability to resort the information based on the above; (G) Ability to easy mark for save/favorites/save search results as a separate channel of information/request auto-update of such channel to continuously update (e.g. once a day etc)/modify such list of search result as a private copy which is saved/publish such saved private list of articles.

### User Experience

In exemplary embodiments of the present invention, the user experience is based on touch and gestures. In some exemplary embodiments, by manipulating the text and the media (images, videos, etc.), the user navigates in feeds of content. In some example, the content of the feeds is adapted to the user's relations in the social network. The user can tap, double tap, perform gestures, and other perform other selections of media to navigate from feeds of content to media, to more feeds or back previous displayed feeds.

The following describes the mechanisms and services that are implemented from the viewpoint of the user experience, as available in existing platforms and as provided by some exemplary embodiments of the present invention.

In existing systems, searching for citation related to a specific area or group of authors can be labor-intensive. the user searches per keywords, then get an endless collection of answers, potentially thousands of results thrown up then clicks one (wait to get the content) then clicks back and then the next one (wait to get the content) etc, and typically gets lost in the too-much information and too slow/cumbersome methodology. The user is usually confused and quickly gives up the search or continues in it with reduced focus. It forms a very tedious process of going through a lot of information in multiple clicks and wait-time until hopefully finding relevant information. Only some of which are relevant to the paper that is being searched: due to non friendly Human Interface (UI), painfully time consuming and lack of infrastructure of suggesting the right information, and fetch it for the user in advance.

In exemplary embodiments of the present invention, a user searches per keywords, then search results pop up visually as channels, the system already starts bringing the important visual results in advance, and provides the user with a smooth and interactive experience, with no click and wait effect, and possibly with flipping figures that already provide preliminary insight. Thus the user gets quick insight on the figures, possibly with ability to zoom in/out on figure by single tap.

In further exemplary embodiment, reading an article is provided while figures and table are clearly presented next to the text and flipped automatically as the text progresses. Therefore, the text is scrolled while the figure is fixed in its screen location and the figure is flipped between (replaced with) other figures as most suitable for the content textual being displayed. Therefore, screen area is used totally differently than that of printed format (in which figures are geometrically fixed to a certain location and dimension within the text), and differently than a typical web approach of standard html views, in which figures are also part of the text and scrolled with it, and actually often presented in a poor resolution that requires further clicks and download to actually view them.

In a different example, the user sets the channel of information (the search results) to provide auto-updates. Therefore, in next day (for example, could be other frequency) the user gets updates on new article on same search which lead the user to see what's new in the existing channels. The auto-update feature may be performed in the client side and/or in the server side and/or on both, with synchronization between them.

In another example related to articles, the system finds relationships between articles and forms the “virtual network” by pre-determined categories, by common authors, by common important terms. The user then rearranges the channel that has search results or otherwise selected article, and select subgroup in it, etc. The articles are found and displayed in accordance with the categories, with a further refined search, by those people that related to the articles, and/or by those articles that have similar context to a given article.

In another exemplary aspect of the present invention, privacy is carefully considered, such that search results, and interest of a certain user is selectively presented or used when applying services for other users and for communicating with other users. An additional example relates to recommendation and interest meter. The person is explicitly vote on importance and/or quality and/or interest of the article. The user also provides information implicitly, for example, the longer time the person reads the article the more a “virtual counter” determines that this article is important and interesting to the user. Sharing such implicit information, or basing recommendations to other users based on implicit information obtained from a certain user is performed, for example, by limiting such use only to those users that allowed it, and only to the extent the information is used as part of a minimum group of users, and not individuals. For example, determining and using the information that a certain article became of interest to the user's colleagues is done only once the number of such interested colleagues crossed a threshold (e.g. 10, 20, 50, 100, 1000 etc) in order to prevent one-to-one identification of the colleagues.

In another example, the platforms provides the user the abilities of commenting and/or form or join discussions (also called “Minds” in the present invention). For example, a user shares his thoughts with others on any subject, such as to generate a general collection of posts, follow posts of others, open a subject (discussion), control users access to it, and initiate or join discussions on the subject. In another example, the user reads an article, then decides to open a discussion on it, or to post a comment on an existing discussion related to it. Posting is being set by the user to be available to the entire world, to his colleagues, to a closed collection of collaborators, to the author, and/or to (a) specific person(s).

In another exemplary embodiment of the present invention, the social network facilitates finding the best articles. The user searches for information, and rearranges the information according to the user's professional social network, other people such as the “entire world”, or any specific subgroup among the user's colleagues. The information is based on what is recommended by other people, what most discussed by other people, what most read recently by multiple other people.

In another example, the system provides new approaches for forwarding information and inviting new users to the system. For example, a user discusses and point to an interesting article with users within the application platform, but also forward it to people outside the application platform while automatically mentioning the article and inviting them to view it and communicate on it within the application platform. In another example, the user to which the system approaches is offered to claim authorship on the article. The Application platform identifies author's email as mentioned in the article and sends a message to the author suggesting him to join the application platform, confirm authorship of the article, and suggest to that user to forward to the other authors by requesting their emails from the users.

In an additional example, a user searches and connect with people who express and/or publish their interest explicitly by categories or in the text they write about themselves in the field that the user is looking for if they agree to be contacted accordingly. Thus form an explicit social network. While reading an article, the user contacts the author, finds and connects with people that wrote about the article in minds and/or discussions if they agree to be contacted accordingly. Thus the articles facilitate the social network. Articles pointing to other articles based on similar category or similar categories expands the potential user base of people to connect with. Thus the virtual network expands the social network. In an example of social and virtual and/or knowledge networks interplay. A user looks for a subject, find articles on the subject, find people dealing with the subject, and find discussions related to the subject. A user reads an article, post a comment on the article, find information on the author, connect to that author, mention the field of interest, in reply being pointed to another article, through the article find related articles, through the related articles find more people interested in that field, join a group that successes that field, follow people in that group, communicate with some of them, read and join the discussions people within the group created on the topic of interest, and find article which are most recommended or most read within the community etc.

### Content Similarity

In some exemplary embodiments of the present invention, the system provides several approaches for identifying potential similarity among articles. In some exemplary embodiments, this similarity measure is used to identify articles that relate to other articles. For example, this is used by a user to request additional similar articles which are likely to deal with similar topic. In another example, this similarity is used for sorting search results in a manner that articles that the user already marked as interesting, or practically spent longer time reading, is serve to bring higher in priority (“upper in the search results list”, “first in the channel”) other articles that are identified to be dealing with similar topics.

In other exemplary embodiments, a certain user's interest in an article is used to characterize the user's general interest, for example by the system maintaining a list of key words that are more likely to be within the scope of interest of the user. These keywords do not necessarily stem from the keywords search that the user has used, but rather from words and phrases identified as good representatives of topics that the user actually read (e.g. in the articles that he read, in the articles that he identified as interesting, in articles that he wrote and communicated about, in blogs, etc).

In other exemplary embodiments, the system enable a user to reach out for other users with similar interest, for example based on explicit similar fields of interest that users provide in their profile, and/or for example by matching the various keywords and phrases that appear to characterize the user's interest.

In other exemplary embodiments, the system allows a user that reads article, and thus the system identifies keywords of interest, to seek other similar articles, and also seek contact with other users showing interest in other similar articles. In an example, such similarities in users interest is time limited, such that the potential other users are selected to those that showed interest in the last hour, day, week, month, year, or so, or even in real time (meaning in the last few minutes).

In exemplary embodiments of the present invention, similarity measure between documents are defined as a score that takes into account factors such as: common first author, common last author, common other authors, common category by external categorization schemes (e.g. MESH system or similar, that provide for each article a general field definition). For example, the measure is a sum of points, with various metrics, for example there could be 5 points given for common last author, 4 points for common first author, 3 points for any common other author, and 1 point for any common category between two or more articles and/or other types of published content.

In another example, similarity is further calculated between any two text sentences by likelihood of occurrence of common words. For example any common word in the title (which is not a general term such as “of”, “a”, “new”, “in”, “method” etc) could add points to the similarity measure. In a further example, similarity is further evaluated in the abstract, in the full text, in discussion made on the article and the like. In an example, same word that appears in two documents are receive higher similarity score if it appears in both titles than if it appears in both abstracts, and higher that if is appears in both full-text article. In some examples, this is useful because the authors are likely to already emphasize the key topics of the article in the title, and if not there then in the abstract.

In further exemplary embodiment, a dictionary is formed for a wide range of professional terms, and similarity measure is thus more focused or occurrence of words from the professional dictionary. In some examples, each word or phrase includes a separate score, such that its occurrence and the number of occurrences affects the overall score of similarity.

For example, it is clear that if an article includes the word “cell”, although important in biology, it is very broadly used and thus does not immediately provide high similarity with another article that mentions the word “cell”. This would not be the case if a very specific rare protein is mentioned in two articles—which would likely mean that these are more likely to be of similar interest. In some examples, providing different score to different terms in the professional dictionary allows better classification and similarity measure among documents.

In a further example, such dictionary is automatically built in general or for a certain field. For example, a server that is exposed to many articles map all various words and phrases that appear in all those documents, and analyze the frequency of occurrence in an article and across articles. In an example, the higher the occurrence frequency a term has in the entire range of documents, the lower the score that this certain term would have when found in two documents that are being analyzed. In some further examples, words like “a”, “in”, “of”, etc are so frequently used, that the information that is being generated by their occurrence is typically meaningless compared with a certain name of a molecule, that appears in very few articles, but within these very few articles appears many times—that would likely to mean these are in similar field of interest.

As previously mentioned, such unique words, phrases and terms, may be used in some exemplary embodiments to be added into the user's profile, such that the system better identifies the actually and current fields of interest, and potentially better match articles to the needs of the user.

### Purchasing of Content

In existing systems, a user typically purchases paper copies of articles, either as individual printed copies or as part of a collection of one or more issues (e.g. by subscription). Alternatively, the user obtains an electronic form of the article, typically in a pdf, html or similar format. Individual printed or electronic copies are obtained after the user has already searched and identified the specific article of interest. Normally, these imply very high cost per article of interest, and do not provide to the publishers any practical means for controlling the many copies that are later made of the sold article due to unauthorized copying and/or email forwarding. In some cases the prices paid are relatively high, to “compensate” for the missed revenues to the publishers due to such unauthorized copies, and on the other hand, create a barrier for accessing the information for users who do not wish to pay such high prices. Some systems have been suggested for providing web-access (e.g. by html) to an article for limited time, thus limiting the phenomena a bit and reducing the price. However, these raises other concerns such as availability of the article to the user when not on-line, as well as very high cost of accessing to the article if the users wants to read it (or access it again) over a long time period (e.g. months and beyond).

In exemplary embodiments of the present invention, a method is provided that takes advantage of properties associated with mobile platforms such as tablets, which on one hand provide a convenient reading platform, and on the other hand offers a new closed system for data management. In an example, the suggested implementation includes for example an application platform, possibly with a client-server model. In an exemplary embodiment, there is coordination between the application platform and the publisher's content sell platform.

In exemplary embodiments of the present invention, the user provides to the application platform various content to which the user already has access rights (available on the web or organizational intranet, or purchased outside the system, for example as pdf or html files that are stored on the user's computer or cloud storage). In such exemplary cases, the application platform stores the content on the user's platform (e.g. mobile platform, tablet, computer) or the server side of application platform (e.g. associated with the user's account), and allows the user to access it within the application.

In exemplary embodiments of the present invention, when a user purchases an article or other content using the application, it is obtained by the application platform, either from the client side or from the server side. For example, the application approaches the publisher's platform to obtain an electronic copy, which is electronically encoded for that user's only. In some examples, the encoding is done either on the publisher's platform, on the application platform or on another 3^{rd} platform (e.g. 3^{rd} party), and permissions are assigned to the encoded content.

In exemplary embodiments of the present invention, the purchasing of the content is being made for read-only, non sharable and non-printable. For example, the user's application stores the encoded content, but practically reads it only if it has the credentials to do so. In some examples, the credentials serve as the key for reading the content on the user's platform.

In exemplary embodiments of the present invention, such read-only, non-printable right allows the publisher's to maintain copyright on one hand, and the user's ability to conveniently read on the other hand. In some examples, in this setting, the entire economic model associated with the content is changed and the prices is substantially reduced while both the publisher win: the price is reduced to a small fraction of the typical sales price, thus increase the availability to readers, and at the same time the publisher does not lose due to controlled copyrights.

In an exemplary embodiment, the system further provides forward and redistribution of content (e.g. an article, a document etc) while the user offers other users to access the content with one or more optional schemes of payment: (A) The user already pays for the content that is being forwarded to another user; (B) The user forward a reference to the content and the recipient purchases (and pays for) the right to read the content; (C) Group certificates are generated, to allow members of a certain group to access certain purchased content.

In exemplary embodiments of the present invention, permission system is further modulated: (A) Permission to print (paper print); (B) Permission to share (once, multiple, unlimited); (C) Permission to copy sections into other applications; (D) Permission includes time domain, which defines a certain period of time in which certain rights are available.

In exemplary embodiments of the present invention, the system includes credentials management (e.g. encrypted keys, certificates), which provide a content provider or content manager the ability to encode content, and enable access to it only with personalized credentials.

In exemplary embodiments of the present invention, encoding is with access keys which are, for example, specifically limited to a user's platform (specific to a certain tablet, laptop, computer, mobile device etc), or specifically associated with a user's billing system (e.g. credit card, bank account) or to a user identity (e.g. social security number, passport number, etc).

In exemplary embodiments of the present invention, the system further allows for a user to transfer rights from one user to another, or from one platform to another. In some examples, the system further assigns multiple platforms with the same user and thus enable access for that user one the multiple platforms. For example, payment stays the same or be modular to vary according to the number of platforms that the user has access to the certain content.

In exemplary embodiments of the present invention, in the case of permissions granted to organizations, the system further enables a floating license, for a group of up to a certain amount of users to access content within a certain number of platforms, out of a pre-specified larger group of users and/or platforms.

In exemplary embodiments of the present invention, the system further allows the encoding of a certain content to be used with a key that is being opened and accessed with multiple other keys that each has a separate individual access key. Thereby, a single copy of encoded content is being used and stored, instead of multiple copies-one differently encoded copy per user.

In exemplary embodiments of the present invention, this is being implemented, for example, using a two-way private-public key approach. For example, a document is being encrypted and associated with a unique document-permission-key that is transferred to a user in an encrypted form at the request of the user after the user's platform provides its public key. In some examples, the received information by the user's platform is then being opened by the user's application (based on the user's private key) and decrypted to obtain the document-permission-key that is now readable by the user's application. The document-permission-key is then being applied by the application to implement the permission policy to the content, for example, allow opening the document, reading it, sharing it, printing it, and other usages of the document.

In some exemplary embodiments, enabling offline reading of content the user's platform is being obtain the encoded content and keep it. In some examples, sharing and copying of the encoded content may be used to transfer the information, and for backup purposes and for online access, including using cloud computing approach, yet the content will only be readable on the systems and/or users that have permission to do so at given time.

In yet another exemplary embodiment, the content purchasing and certificate management approach further includes managing of multiple content items. For example, a subscription for obtaining a certain amount of articles out or a certain larger range of articles. For example, certificate for obtaining X articles in a certain Field over a certain publication time period from certain group of journal publications. The certificate further includes sub-categories, scoring function (e.g. X amount of articles of category 1, and up to Y amount of articles of category 2, or some mixture thereof, or a certain amount of points or credits or virtual currency that is used to spend over a certain type of content, possibly within a certain time period).

### Managing of Information and Storage

In commonly available approaches, available electronic content in the field of professional articles are either based on-line access (i.e. over the web, in html or similar format) or file download based, e.g. pdf format, that is stored on the user's computer and viewed off-line. While on-line approach for articles retrieval provides additional online features, including further searches and control on access and permissions to content, these miss the need of users to access to the information (including to the purchased information) also when off-line. On the other hand, most off-line approaches provide download of content, but then lose control on the use of that content, including with regard to copyrights and lack of integration of that content with other services that the user sometimes need (e.g. future search and communicate).

Some exemplary embodiments of the present invention define new mechanism to manage and store content, so the client-server model includes the ability of both the server and the client to reach out to databases and publishers servers, search and obtain content. In some examples, both the server and the client has the ability to synchronize downloaded content such that the server acts as a backup for the user's platform, allows user migration from one platform to another or sharing among multiple user's platforms.

In yet another exemplary embodiment of the present invention the client and/or the server obtain and/or maintain encoded copies of the content, in order to maintain permissions control with regard to the specific content both when online and when offline.

In yet another embodiment of the present invention the dual ability to access information enables handling access permissions which vary between users in respect of the facility network they are in at a certain time. For example, a user may have access to some articles while the user is located within the facility network (or VPN) of an organization, while not having access to these articles when outside the organization. In this example, a standard downloaded pdf copy approach might sometimes be problematic due to loss of copyright control. In an optional embodiment of the present invention, the copy is being be retained on the users platform (laptop, tablet, etc) in the encoded form and thus still be limited for use on that platform for that user even when outside the organization facilities and when offline, yet maintaining the copyright management and allowing the user continued efficient work. Similarly and/or additionally, the opposite optional case may useful too: when the user platform is outside the facility and the user securely connects to the server that has access to some information, the user is thus able to obtain services related to it. This is beyond a VPN approach as in fact the client platform does not just have access to the organizational network, but rather also the application server side that further continues and perform its advanced processes, including for example, the search, communicate, and integration between the knowledge network and the people network.

In exemplary embodiment of the present invention, a user U1 may have right to access a certain article A1 when the user U1 is present in network N1 at a certain time, and U1 is interested in the content of A1, and the article A2 is content-associated with another article A2 (e.g. both received similar comments, similarities in key terms, similarity in authors, etc), to which a different user U2 in organization N2 has access (and interest in) but to which the user U1 does not have access. If both users U1 and U2 are users of the application platform of the present invention and both wish to communicate with users with same interest, the server side of that application platform, being connected and synchronized with both users is thus able to make the connection from User1's interest in article A1, to article A2, to User2 who is interested in A2, thus enable U1 and U2 to form communication, if they wish, even though none of them originally had access to the other's network nor to the other's currently available articles.

In some embodiments, client synchronization with the server may be for actually maintain some sort of a miniaturized mirror the user's data between the server and the client. Additionally or alternatively, the client synchronization with the server could be informative and not mirror, for example, by notifying the server that the user has purchased a certain articles and provide to the server various properties related to the articles, without transferring the article itself. Similarly or alternatively it is in the opposite direction (server notifying the client).

In some embodiments, the user has a certain content (or obtained rights to read a certain content), and the user has several platforms for using the application, for example, a laptop, tablet, mobile phone etc. In these cases, for example, the server may provide part of the information, or reformatted information to fit the type of client platform being used. For example, differently structured figures from the article, different display layout and interaction, etc.

In yet another exemplary embodiment of the present invention content maintenance and storage mechanism by both the client and the server is applied also to messages and communications made by the users of the application platform, as part of their professional social communications. Similarly, it is applied to the management and storage of the user's profile, contacts list, social network information, and external connection to other tools that the users has for communicating and accessing and managing data.

In yet another exemplary embodiment of the present invention, the same approach applies to content generated by the user and by groups of users. In the case of scientists, for example, it is scientific data generated, drafts of reports and summaries and articles in preparation, etc. Such information is generated at the client side of the application platform, and sharing and synchronization between the various users handles by the application server's database. For example, users post information into a channel of messages that serves the group and accessible by it.

In yet another exemplary embodiment of the present invention, such group data management are moderated by users who are defined as editors. Therefore such a client-server based messaging system is useful in turning the posting of information into a peer-reviewed publication system, in which each post is first available to editors only, then they designate reviewers, and after iterations between them the editor then releases the agreed peer-reviewed to be accessible to all (to all the group, others, etc.).

### Access Rights and Permissions

One of the aspects of the present invention relates to rights management, for example, one or more of content access rights, and discussion permissions.

Content access rights: Common approach to purchasing of content from publishers usually provides either payment for full access to a copy (e.g. pdf of HTML access) of the article, or payment for limited time access to that article. These are done per user or group that wants to obtain access to the content. In addition, a campus may purchase subscription to that content. However, these do not usually provide group purchase for a single item (e.g. article).

In an exemplary embodiment of the present invention, the application manages content access per user, and/or per ad-hoc group (defined for that specific content item) and/or per group, and/or per society, such that the permission management and cost can be tailored per that item, regardless of location, subscription etc. For example, a certain collaboration group that includes a certain amount of collaborating researchers can obtain common access to a certain article per a pre-agreed cost, and the billing system and payment are defined for that “purchase group”.

Discussion permission management: In an exemplary embodiment of the present invention, permission management for discussions (e g “minds”) includes permission inheritance narrowing mechanism. In an example, a user can initiate a discussion (e.g. a “mind”) on a certain topic and include on the distribution list various entities, for example various other users that he has contact with, various groups to which he is a member, an ad-hoc group that the user creates for this specific discussion, email addresses, social networks users (twitter, facebook and the like). All those users can access to, or receive notification about, the message that was posted. However, any of the recipients that want to reply to the posted message can do that only within the permission that the recipient has.

In a further example, if a certain user can send a message to the entire world, a recipient will be able to reply only to the users contacts of that recipient, and not necessarily to the entire world. In some exemplary embodiments of the present invention, this approach maintains the logical separation among groups, such that information and user identities will not leak from one group to another. This approach is opposite to typical social networks in which the intention is to have a broad distribution of information. In some of the abovementioned examples, the intention is to narrow the distribution of information while progressing through users, such that users that receive information can only use it within the permissions that are limited to the original distribution list and those of the user. For example as the discussion progresses, the distribution lists tends to be narrowed or maintained, and not expanded.

In another exemplary embodiment of the present invention, an expansion of a certain group can take place. In some examples, such expansion is only permitted by a group manager or owner. In some examples, a group manager or owner may be added or replaced from time to time by the current group manager or owner. In some examples, a group manager or owner may be defined for a group of contacts, or may be defined ad-hoc for a certain discussion. In an example, a group manager or owner can add a new user to the discussion or to a certain group, and assign to that new user either access permission to new discussions only, or to bring that new user to have access to one or more of the historical discussions up to those that this manager or owner has access to.

In exemplary embodiments of the present invention, users are be defined as users of the system, being communicated and contacted by the system, or external users, which are communicating through external communication networks, such as email, social networks, etc.

### The Server Role as Advisor

One aspect of the present invention relates to the role of the server as an advisor to the client. This approach is unique, as it creates a flexible stiff-to-loose relation between the activity of the client application and the sever side. On one hand, in some examples of the present invention, some information of the server is mandatory for proper operation of the client application (e.g. user profile and credentials), and on the other hand, some of the information that the server has is used for augmenting the ability of the client to provide better service and experience for the user.

In an exemplary embodiment of the present invention, the client operates while either (i) completely off-line from network connection (thus using local stored data only), and/or (ii) operates while the server is unavailable but the client has access to network resources that allows it also to access information on the network and integrate its decisions and operations based on the client information and the network information, and/or (iii) operates while not having access to external resources other than connection with the server, thus integrating its local information and information that the server allows it to access, and/or (iv) operates with both network resources and server connections, while integrating local information, resources available to the client through its network and information that the server allows it to access. In some exemplary embodiments of the present invention, only part of these modes are implemented (e.g. online server only, offline and online server access, and the like).

In some exemplary embodiments, the client obtains information that exists on the client platform (e.g. tablet, mobile device, laptop, personal computer, or other end-user interface, or a network of such interfaces). In some examples, the client allows the user to generate such information, or to contribute such information (files, documents, figures, experimental results, communications, or other data) into the system. In an example, the server has access to the same information and/or to the same type of information, and/or to information with similar characteristics, and/or to other information, whether the client has access to and/or whether the client side does not have access to. In an example, the server can process information that it has, or it has access to, and/or the server can obtain from the client such information and process it.

In exemplary embodiment of the present invention, the advisory role of the server contributes to the client information related to information related to the text searches, such as keywords, categories, authors, statistically meaningful words and phrases. In additional exemplary embodiments of the present invention, the advisory role of the server comprises providing and/or linking to and/or superimposing and/or analyzing and/or comparing with and/or processing similar data, parameters, results, graphs, experimental subjects that are similar, molecules that are similar, DNA and/or protein and/or chemical entities sequences and compositions, formulations, and the like.

In exemplary embodiments of the present invention, data entities that are obtained by the client and/or contributed by the server advice are related to information about and/or processing data of a one or more items from of a variety of fields, including for example one or more of finance, legal, sport, food, books, engineering, art, and the like.

In exemplary embodiments of the present invention, the server receives information about the queries (the explicit field of interest) and/or about the results, and processes these in view of the user's actual interest, including, for example, topics that were collected from past searches, from the profile and/or from actually read articles and/or articles that are relevant to the user's communities. In some examples, in return, the server provides advice to the client. In some example, the advice is immediate, in real time, and in some examples it is delayed (after the client has already started to provide to the user information per the user's request). In some examples, the advice includes a variety of information types, including, suggested priorities and/or potential reordering options of the information, and/or suggested categories to enable the user to select search refinement, and/or information about popularity in general and/or popularity among specific users groups, and/or information about other related information, and the like. In some examples, other information types related to proposed ads, products or services are offered by the server as well. In some examples, a collection of relevant actions are offered by the server, for example: contacts to authors and/or key related people, posting messages to discussions (“minds”) that are related to the query, and/or other actions that the application offers in the context of the query, the results, the user's profile and/or the user's contacts.

### Asynchronous Communication and Data Distribution

In some examples of the present invention, the advice that the server provides to the client includes meta-data that the client did not obtain as part of its on-going search processes. For example, small or full size figures and/or other visual content that the server has access to, full text or text fragments that the server has access to, contact details or mechanism for approaching authors (e.g. second author, thirds author, etc) that are not otherwise obtained by the client's independent search results, alternative ways to purchase access to the article of interest, information (responses, links, opinions, communications and follow-on work, additional data, etc) that other users provided on the article, information about users that presented interest in that topic, statistics and analysis of the content such as categorization, keywords, links to other related content, data comparable to the data that is mentioned in the clients' information (similar results, contradicting results, comparative results, summaries and review articles, different presentation of same results, superimposing of results from multiple sources, etc), and the like.

In an exemplary generalization of the above mentioned concept, the client application and/or the one or more servers manage information related to the user's mental attitude, interest or assumptions (the user's mindset), including for example information about the user's profile, fields of interest, specific search queries and topics for which the user prefers to obtain repeated updates, contact details of related users in a variety of groups, specific articles and content that the user has, and/or has access too, and/or generates, and/or contributes to. In addition, the client application includes besides those data entities also lists of collection of such entities, also called herein “channels”. These can also be aggregated in multiple levels, such that there can be also channels of entities, channels of channels, channels of mixed composition, and so on (also called herein “super-channels”).

In exemplary embodiment of the present invention, one or more servers also maintains similar structures of entities, channels, super-channels. In some examples, the information that is maintained by the one or more clients and one or more servers is mirrored, such that they operate to maintain synchronization among them. In other exemplary embodiment of the present invention the client and the server do not maintain the same data, or maintain similar data only in part.

In exemplary embodiment of the present invention, client updates the server on the user's interest, including for example, the user's profile, explicit fields of interest mentioned by the user, user queries, client search results, content the client downloaded, information about content actually viewed and/or read by the user, information about the content itself, such as text, figures, statistics, data, or any processing, samples or analysis thereof, communications by the users, contacts and groups related to the user, and so on.

In exemplary embodiment of the present invention, in response to such information that is received and/or accumulates by the one or more servers, the server can provide to the client either synchronously or asynchronously or both, advice with additional information based on information gathered, accessed or processed by the server side.

### System Breakdown

In an exemplary embodiment of the present invention, a system that includes at least one server is implemented.

In an example, the application platform includes several main aspects: a server side (with its multiple components), a client infrastructure side and a client user interface.

In an example, the server side handles users' profiles, access to remote databases and information sources, data storage for users data, including acquired and user generated data, data management of communications among users, privacy and permission management, and connection to multiple clients.

In an exemplary implementation the server side will include server hardware that would be suitable for handling high volume of transactions, and probably will include the ability to maintain load balancing among multiple sub-servers, redundancy and fault tolerant architecture, and splitting of some tasks among dedicated server hardware for optimizing processing and communication load requirements. In a further optional embodiment of the present invention the server side is split among multiple sites for providing redundancy and reliability, maintaining multiple communication paths, and improving data access to information sources.

In an exemplary embodiment of the present invention the server include a database, for example relational database, for example SQL-based, such as MySQL, PostgreSQL, Oracle or the like.

In an exemplary embodiment, the server side also provides management of advertising streaming towards the clients. In an alternative embodiment, ads are managed by the clients, and in further example the client updates the server about ads activity for logging, monitoring and/or billing purposes.

In some exemplary embodiments the server include a lower level of interface that approach various databases for applying queries in a suitable for mat for each information provider, for example for searches, obtaining of citation or other content description, and for obtaining the full content.

In further examples, the server includes billing mechanisms for charging the user for transactions performed and requested by the user. For example, when a user wants to purchase content (e.g. an article). In some examples the billing and purchasing processes are done by the user outside the application and the application platform incorporates the acquired content into the system, and in some other examples the application platform performs this process for the user. In some cases this is done through a web-site managed by the application server, in which billing transactions take place, and payment mechanisms (e.g. credit card billing or others) are applied. In some other examples the purchase process is handled within the application on the client side.

In a further example, the server includes interface with content providers (such as publishers) in which content is encoded (e.g. encrypted) in an agreed manner that allows managing copyrights as mentioned above. Such interface with the server allows defining which users and clients would be able to perform which actions (e.g. read only, read & print, read & share, etc).

In some examples, the server is composed of multiple servers, in one or more sites that approach independently and/or in coordination and/or in synchrony to external data sources. For example, this may be useful when different location has different access and permission to data.

In a further exemplary embodiment, the servers may be distributed among different countries, and/or among different fields, such that they serve different needs of users, including different type of content, different languages, and/or overcome communication barriers. In a further example, communication and data access limitations are sometimes typical in enterprises and other organization, thus the server platform can applicable in enterprise.

In a further example, one or more servers are located within an enterprise (that have access to some information not available from outside, and/or has limitation on accessing information outside the enterprise. In further examples, those servers communicate between them, subject to the permitted information exchange, to enable the professional social networking even when the content itself is maintained with its intended access permission setting.

In an exemplary embodiment of the present invention the client infrastructure include implementation of a local data-base at the client side itself. In some cases the client also performs access to the external databases for performing searches and obtaining data and purchase content. In some cases this may be of very high importance, for example when the user wants to have off-line access to the user's content, for example when traveling or otherwise away from standard communication. In some other examples, such distributed approach to external data sources avoids bottlenecks that might otherwise occur if all communications and processing would have gone through the server.

In some examples of such distributed approach multiple clients and/or one or more servers approach external databases. In a further exemplary embodiment, the clients' database and the server database can work independently from each other, and/or in synchrony of each other, and/or work in parallel and synchronize the content frequently.

In an exemplary embodiment of the present invention, when a user uses the client to search for information, the UI provides the visual interface, and respective one or more search queries are sent to one or more external database (e.g. PubMed) and/or to the application server, and/or to both. The client can already obtain some results from external databases—if available, and in parallel obtain results from the application server—if available. In an example, results are then merged, and the client send to the application sever information about results so far. In a further example, the server then applies algorithm for optimize and customize the results to eh user. For example, among thousands of possible citations, it is possible that the server already know which ones are characterized by certain keywords (based on the similarity and textual analysis described above or based on other characteristics), thus in some examples the server provide an updated search results that takes into account customization to the users preferences (explicit and/or implied) thus provide the user the most suitable resulting articles, per the defined criteria. In some example, the communication provided between the client and the server enables the server to get updated information from the client about the content and about the user. This information can be provided from the client to the server in real time and/or at other time regardless of peaks in computation and/or communication.

In this example, the cooperation of the client and the server infrastructure allows both communication bandwidth sharing in a balanced way (client generates communications for that client needs, and server is not a bottleneck), the client can work offline and yet can benefit from the added value of services provided by the server when on-line. Both clients and servers extend their reach with regard to the ability to extend the professional social network based on understanding the up-to-date interest of the users.

In some examples, in addition to these, the client application provides also the human interface (UI) to enable the visualization and interaction with the user. In some exemplary embodiments these also benefit from pre-fetch processes initiated by the client and/or the server to allow the user to have immediate access to abstracts and figures as early as the search takes place.

### FIG. 7 Shows an Example of System Breakdown

In some exemplary implementations of the system, the system is comprised of one or more of the following components: (A) iPad Client—(or similar other user platform, e.g. other tablets, mobile, PC, web interfaces, and the like)—The client user interface including views such as Sign-In, Search and Channels; (B) Article/Mind/Person Viewer—Specific views in the iPad Client, which handles the viewing of Full Article, or Conversation, or Person's Profile; (C) Fetching Modules (client)—Code modules that fetch data from external databases, cache it in the client, and share it with the server; (D) Client API—Object model and communication code that separate the client code from the server and from the fetching modules; (E) Web Site—for example using HTML5 client code and PHP server side code to allow users access to the application server via browsers; (F) API Server—Publicly available API. The API can be XML or JSON and implemented using PHP. This part includes implementation of authentication based on OAuth; (G) The application Server—Internally API. The API will be XML and implemented using PHP; (H) Agents—Background processes performing data maintenance and integration with other external social networks; (I) Fetching Modules (server)—Internal API that fetch data from external sources, such as PubMed and PMC, and convert it to the application server's data structures; (J) Database—for example, PostgreSQL database.

### Details of Exemplary Implementation

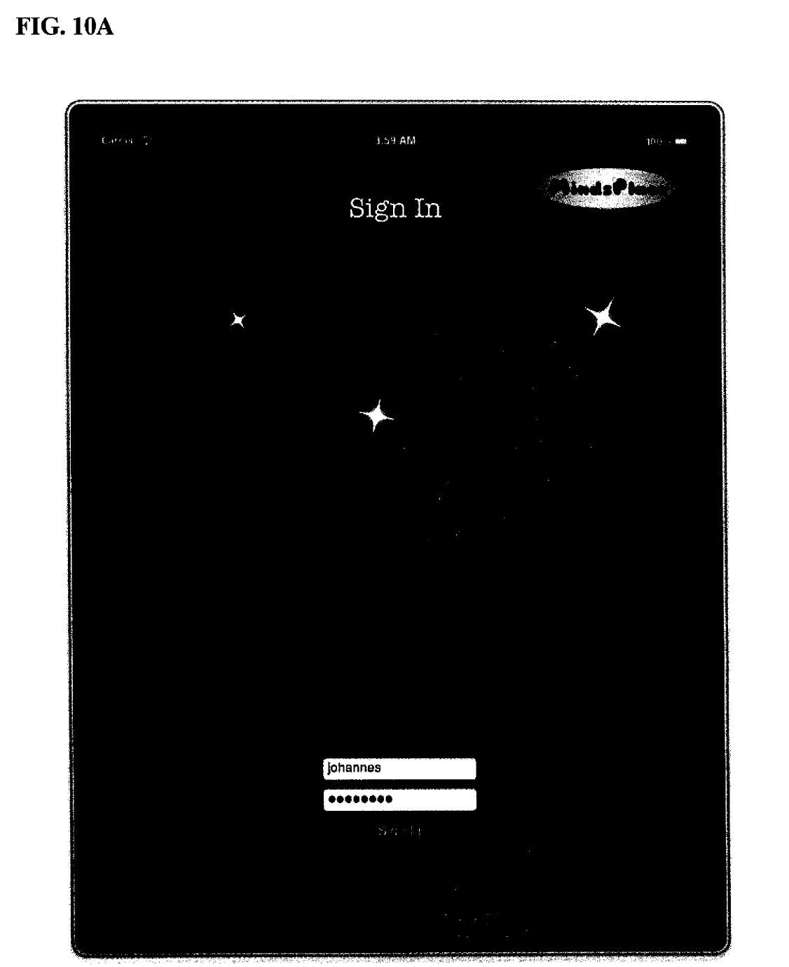

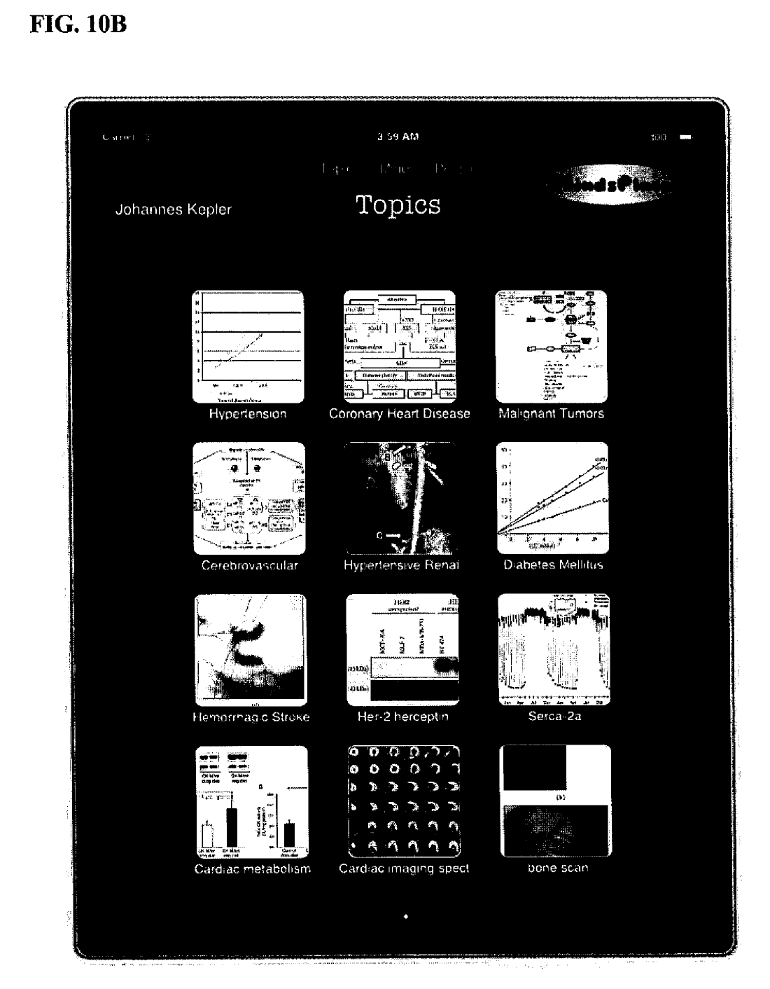

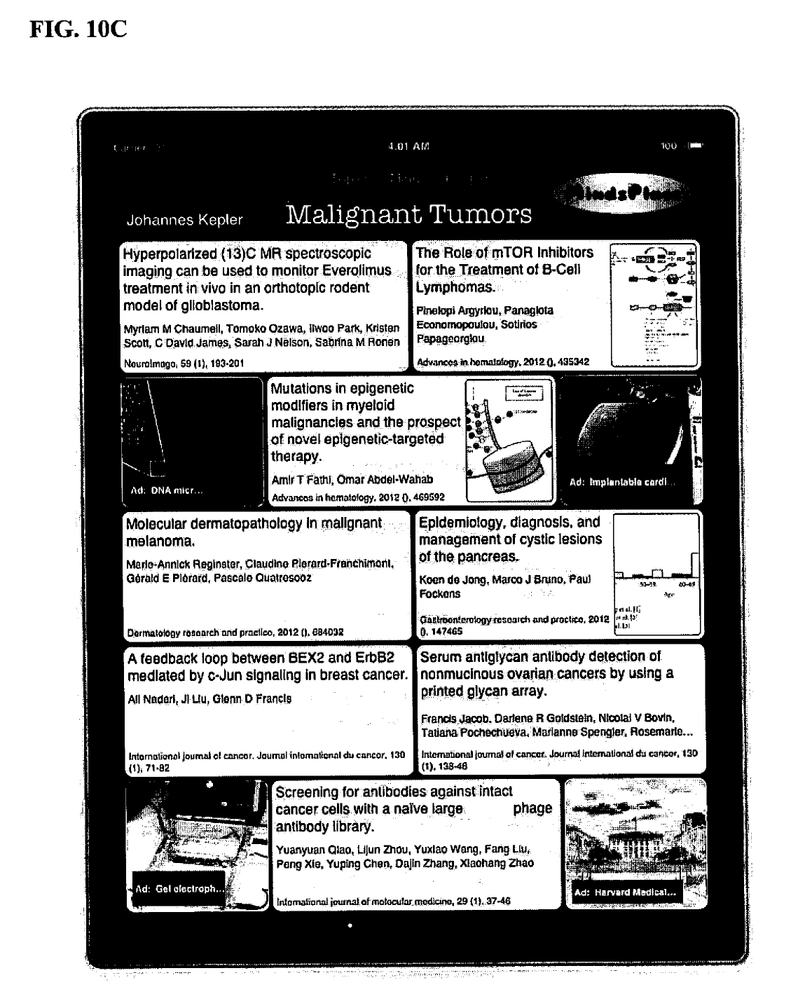

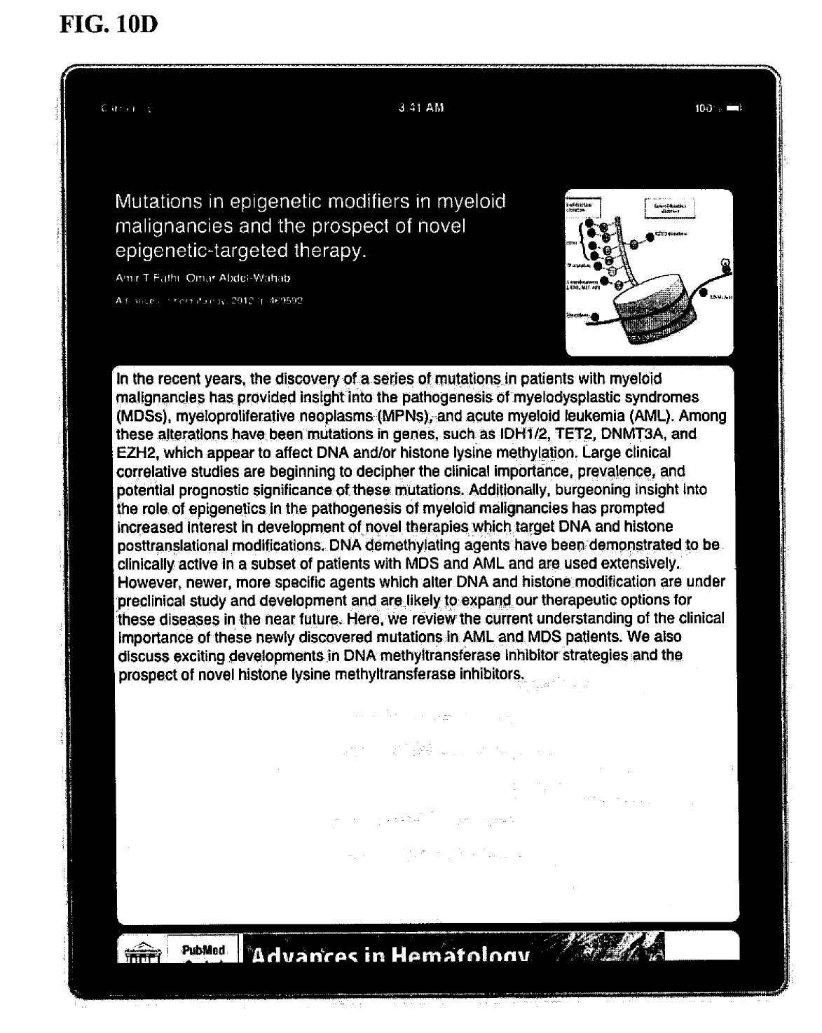

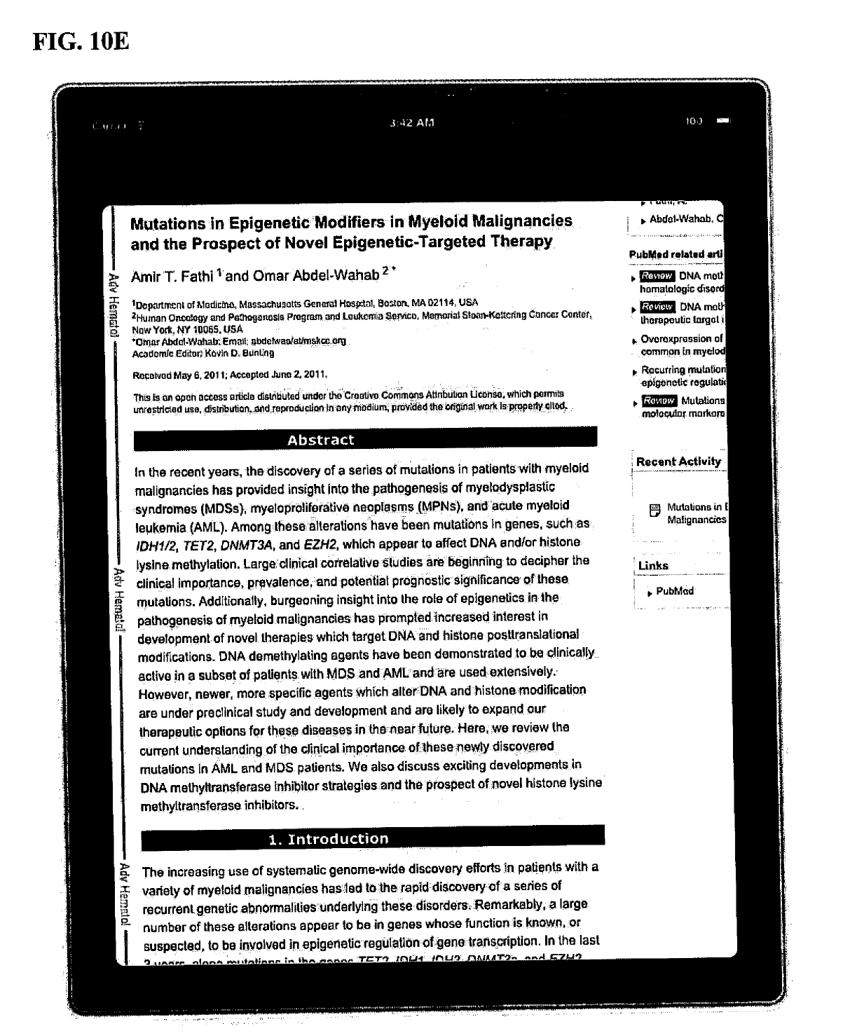

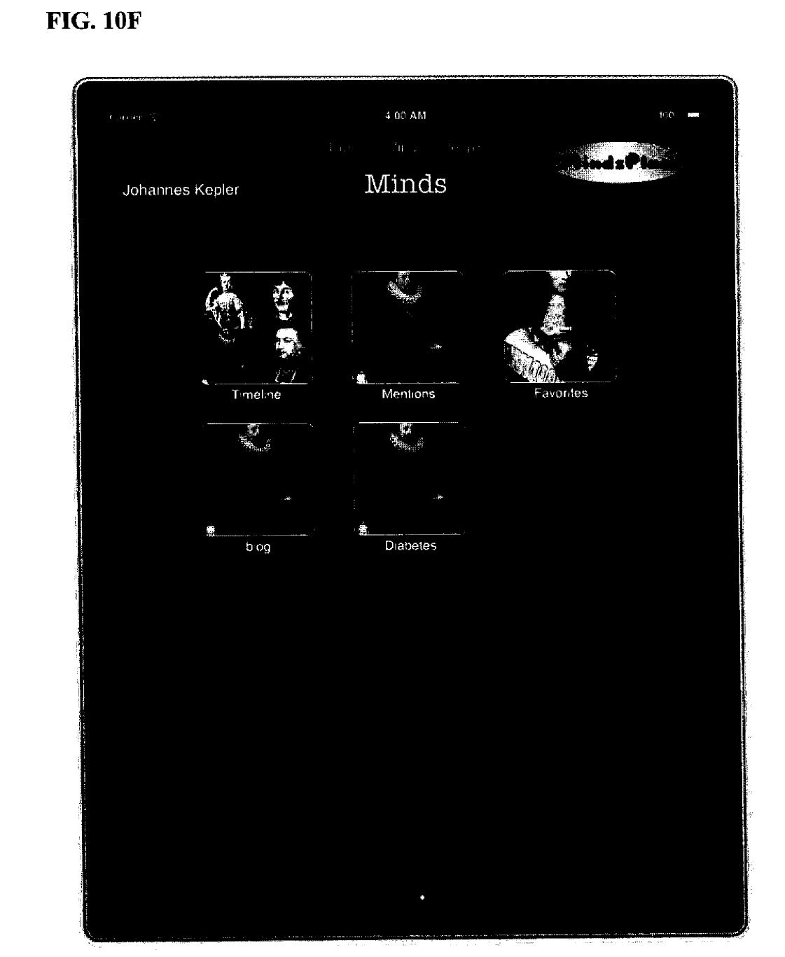

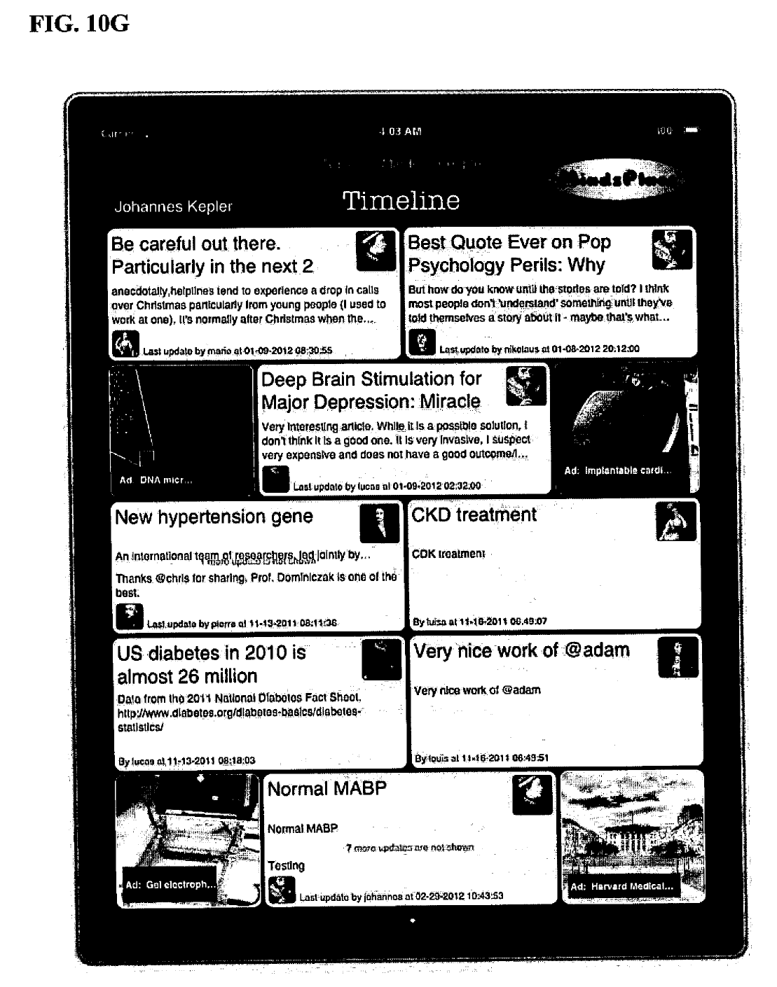

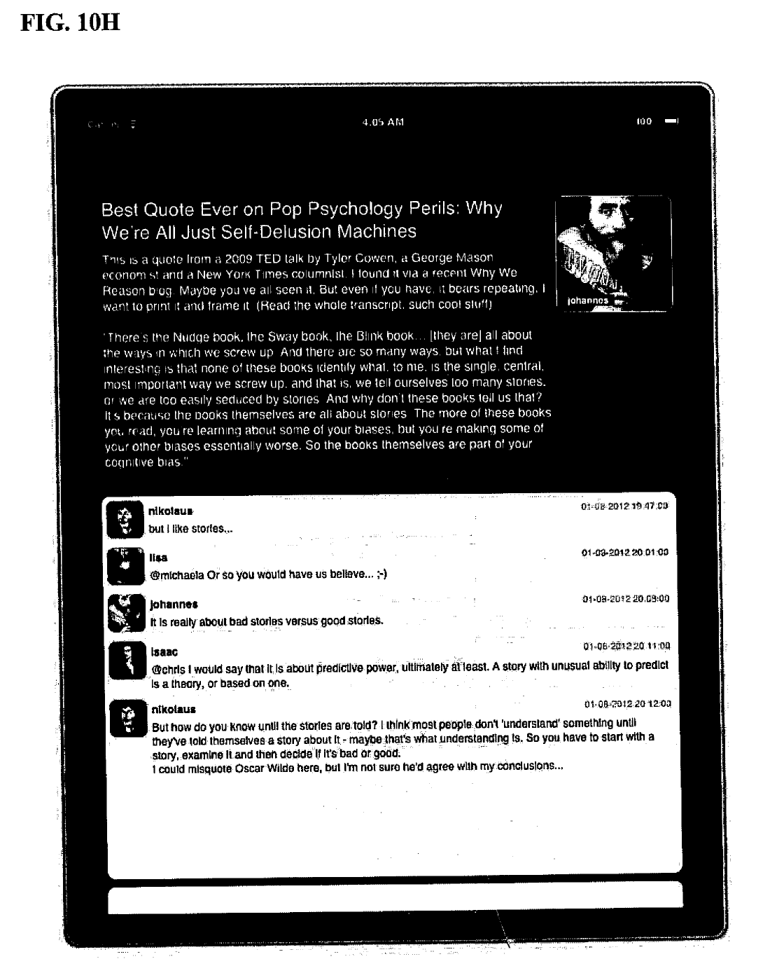

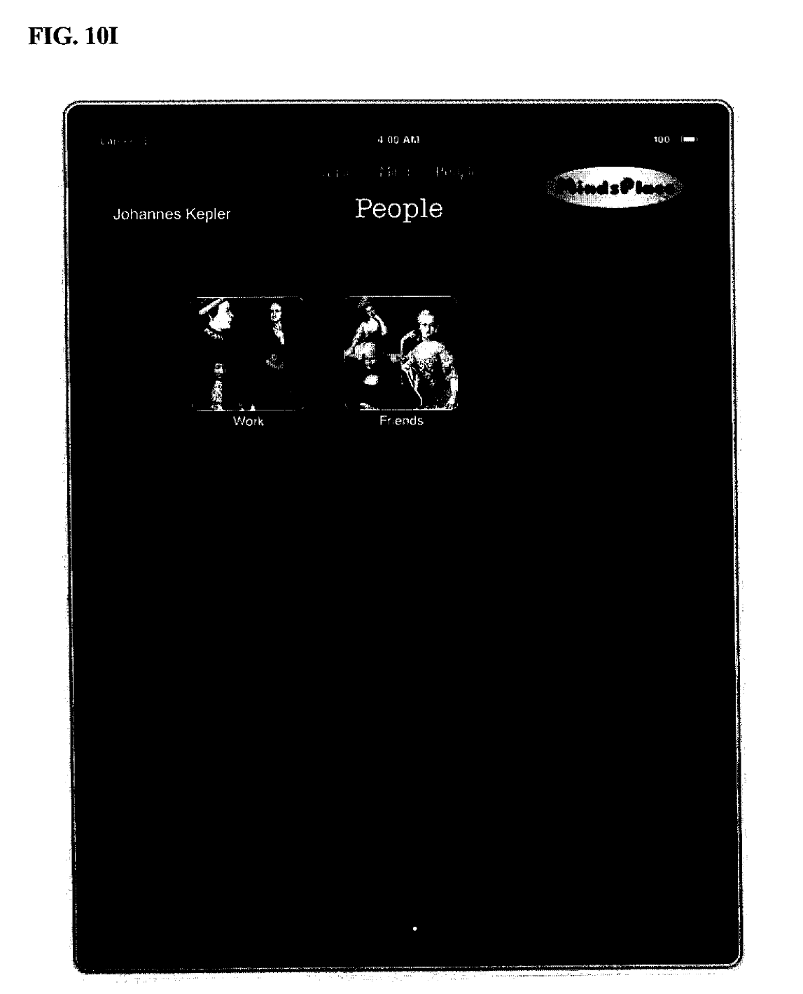

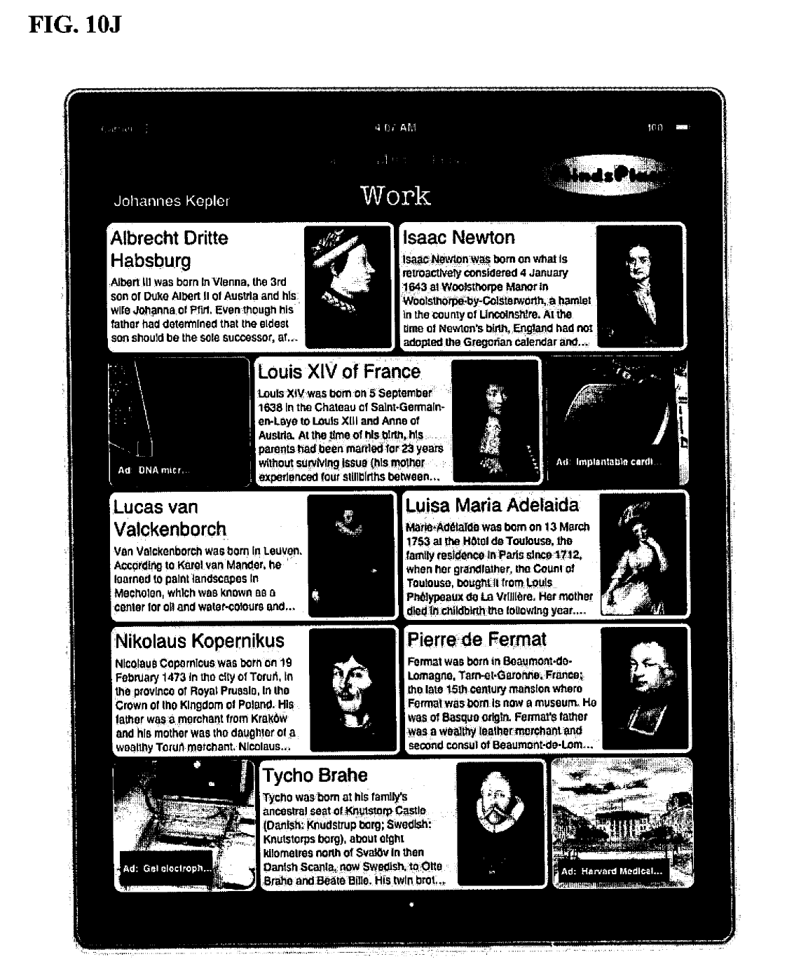

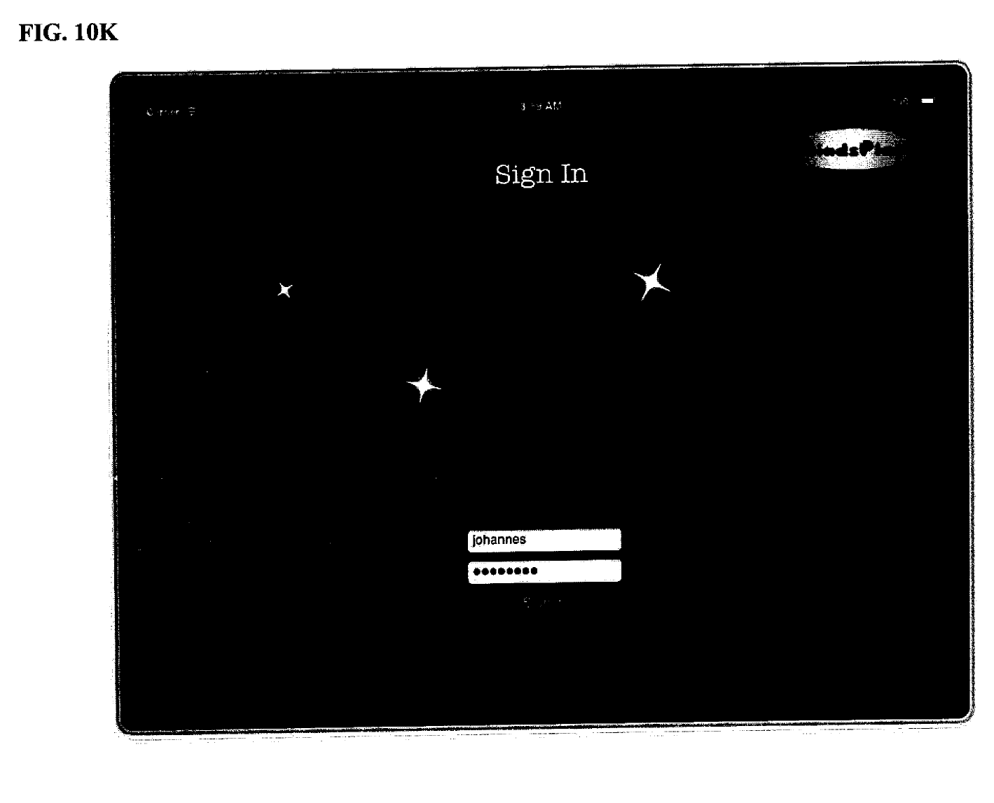

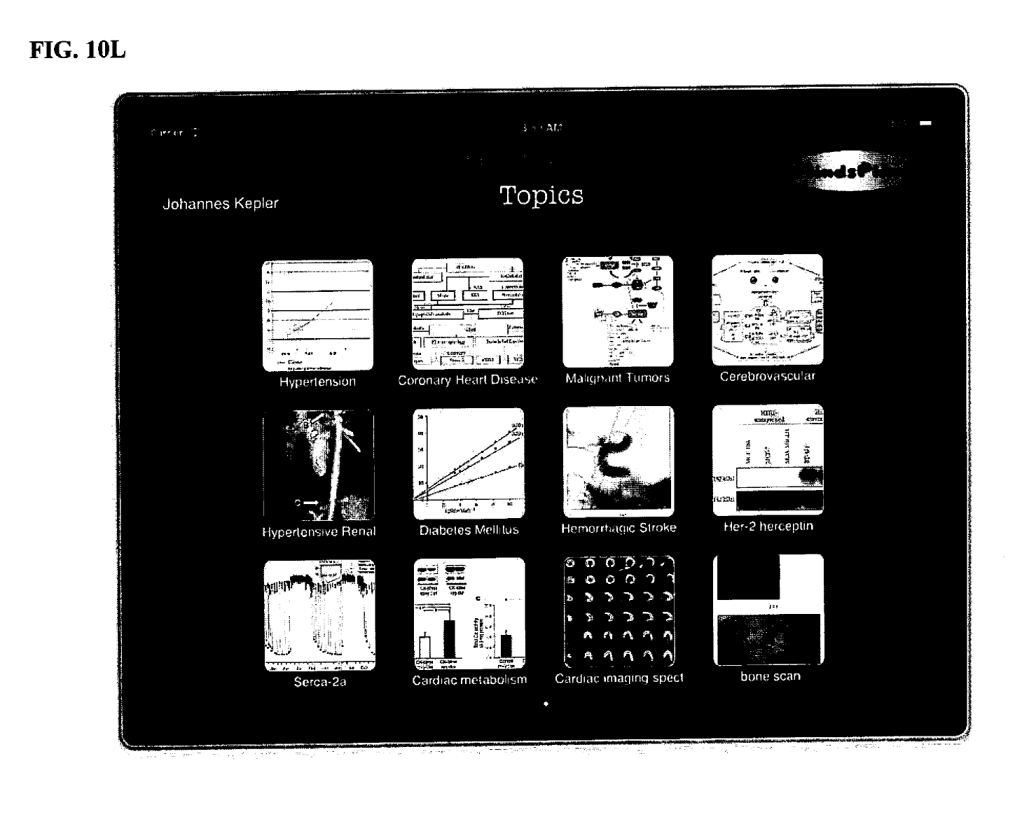

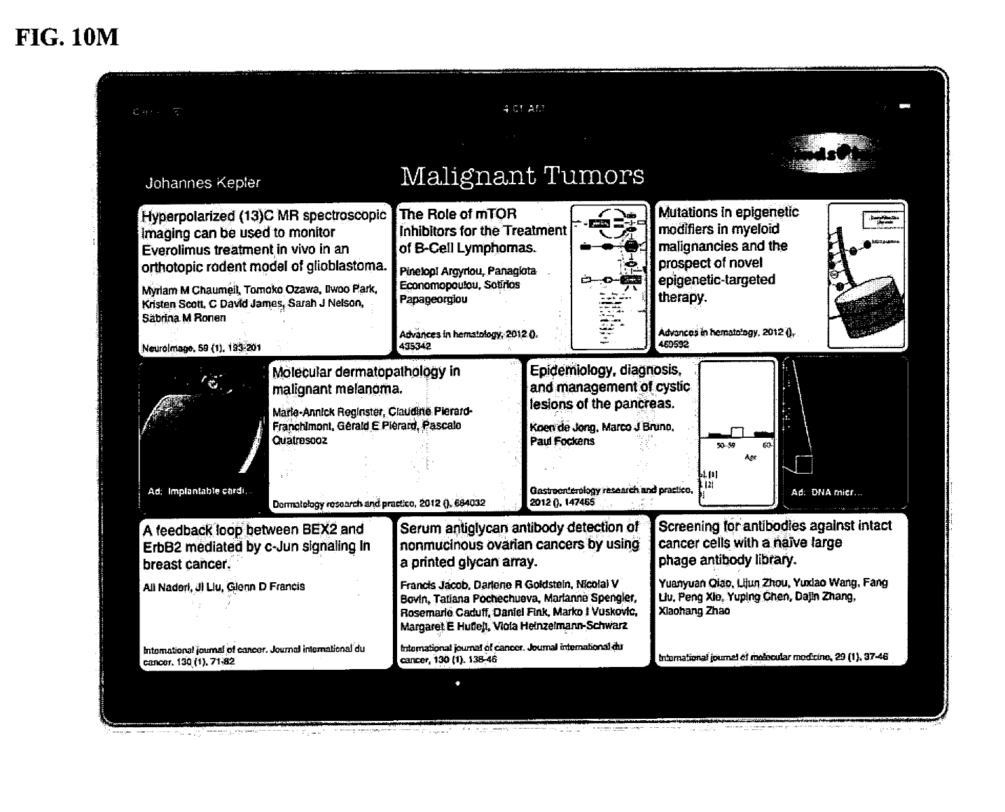

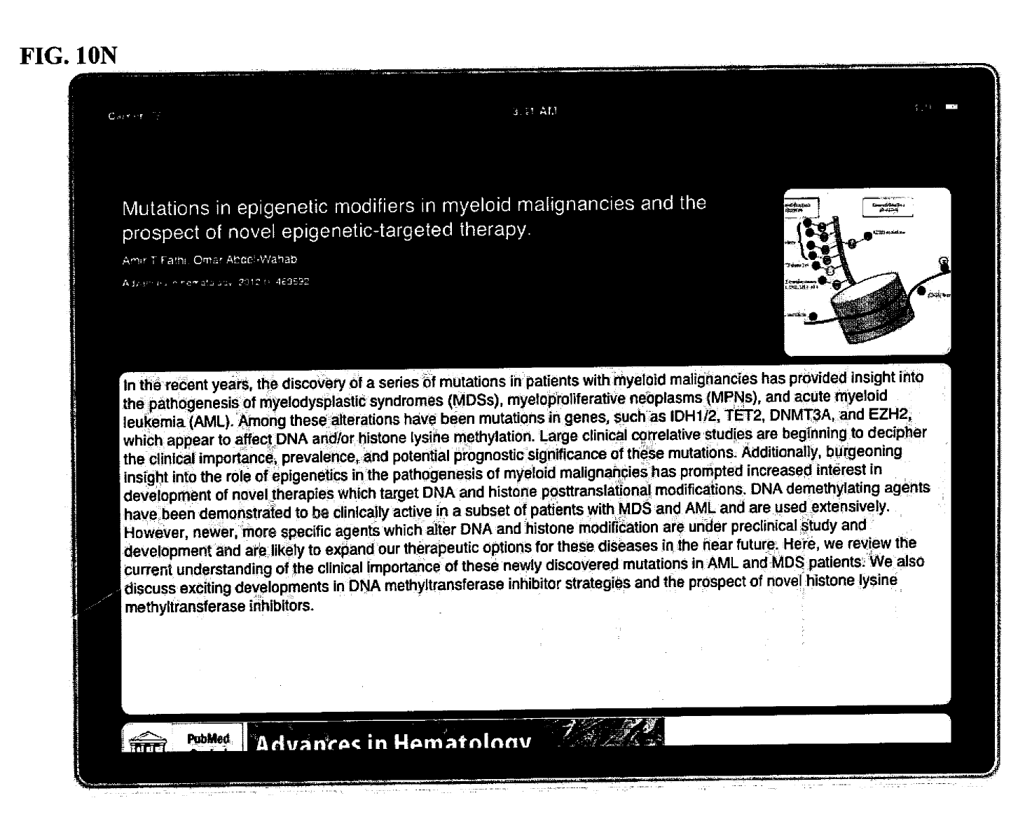

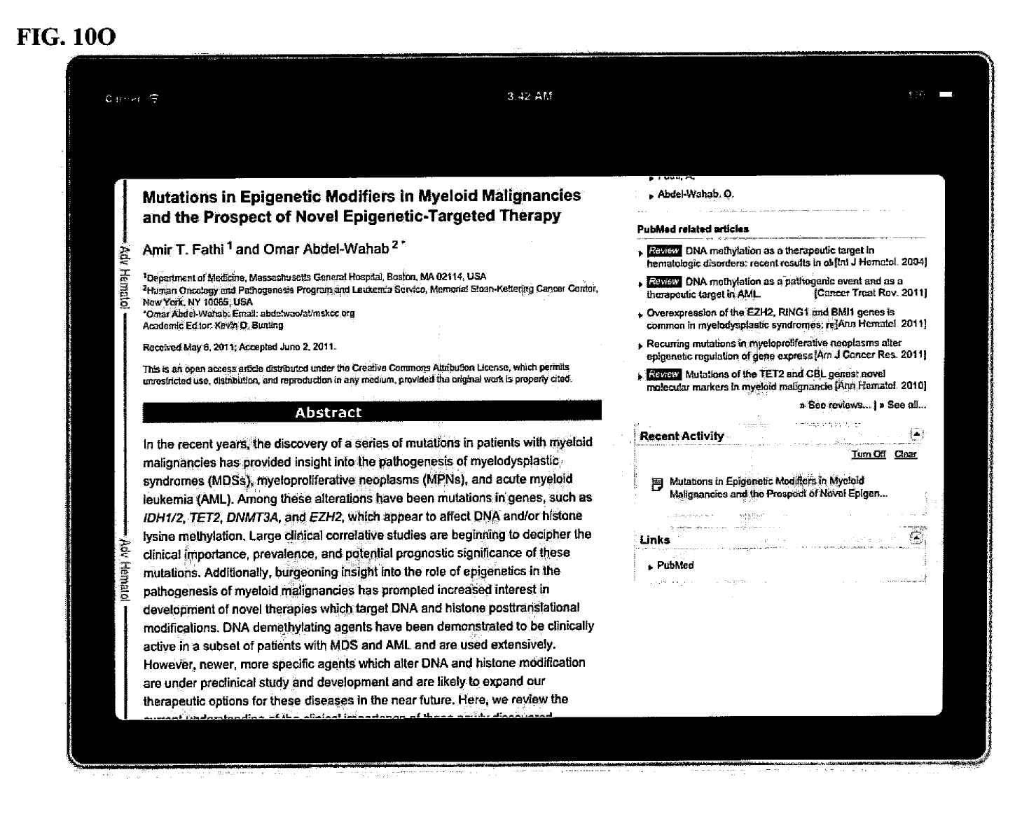

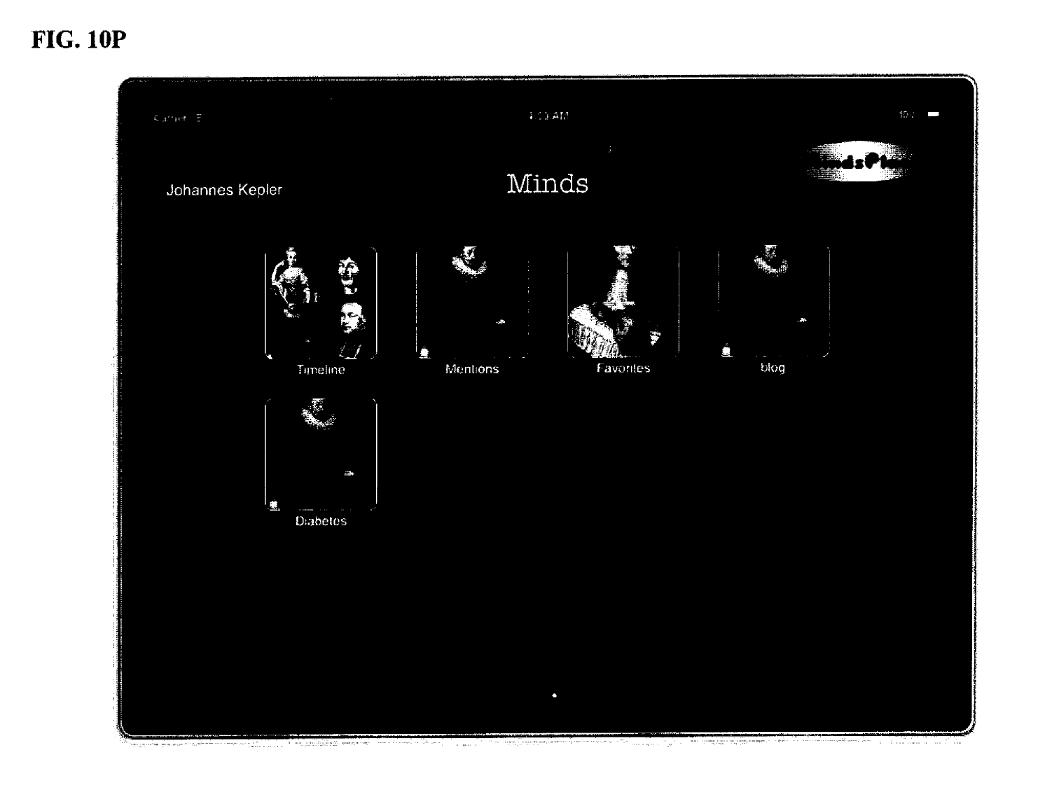

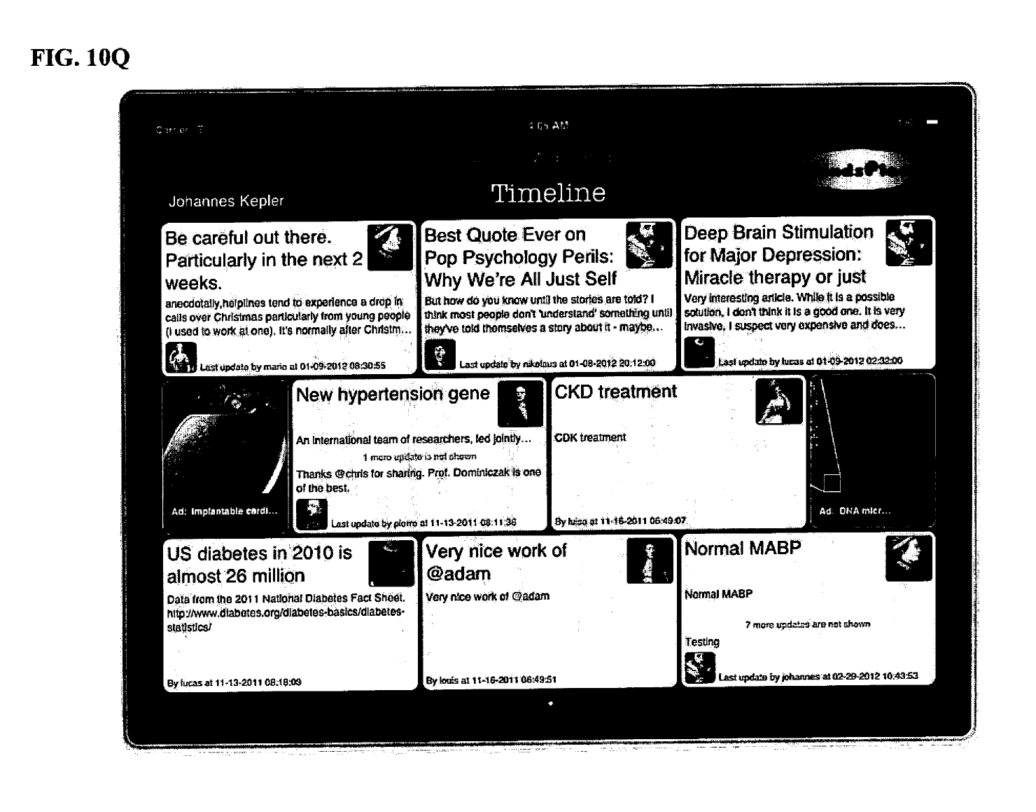

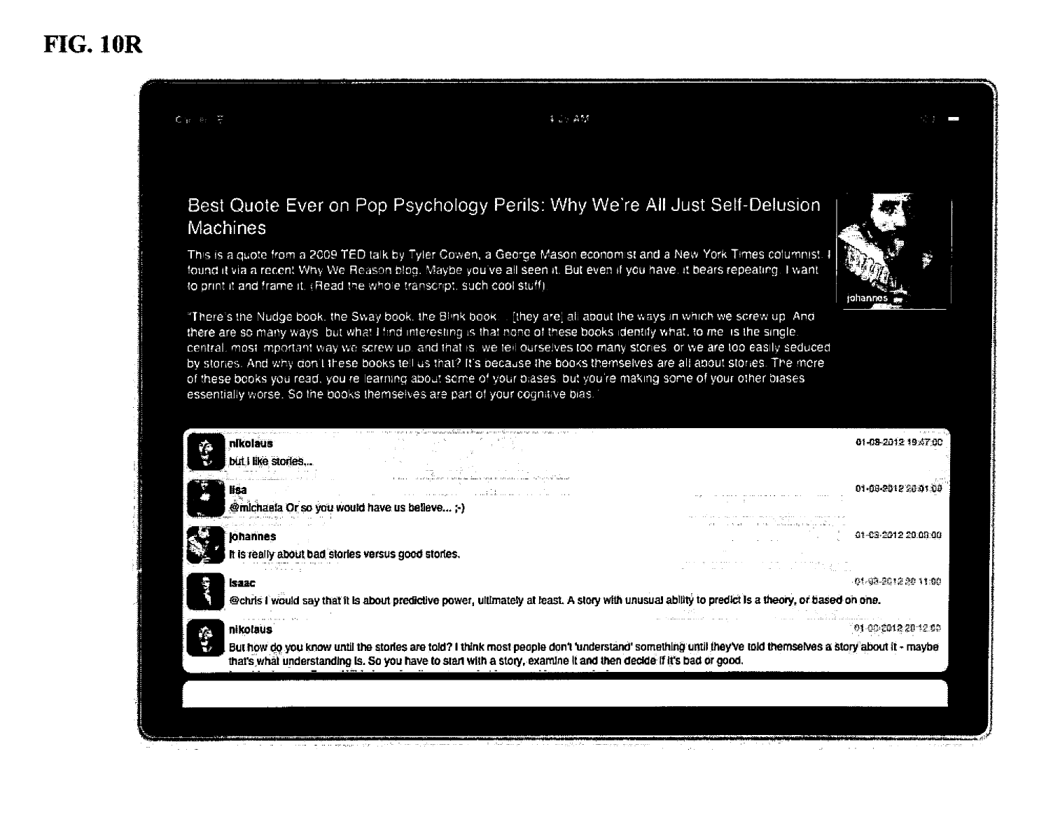

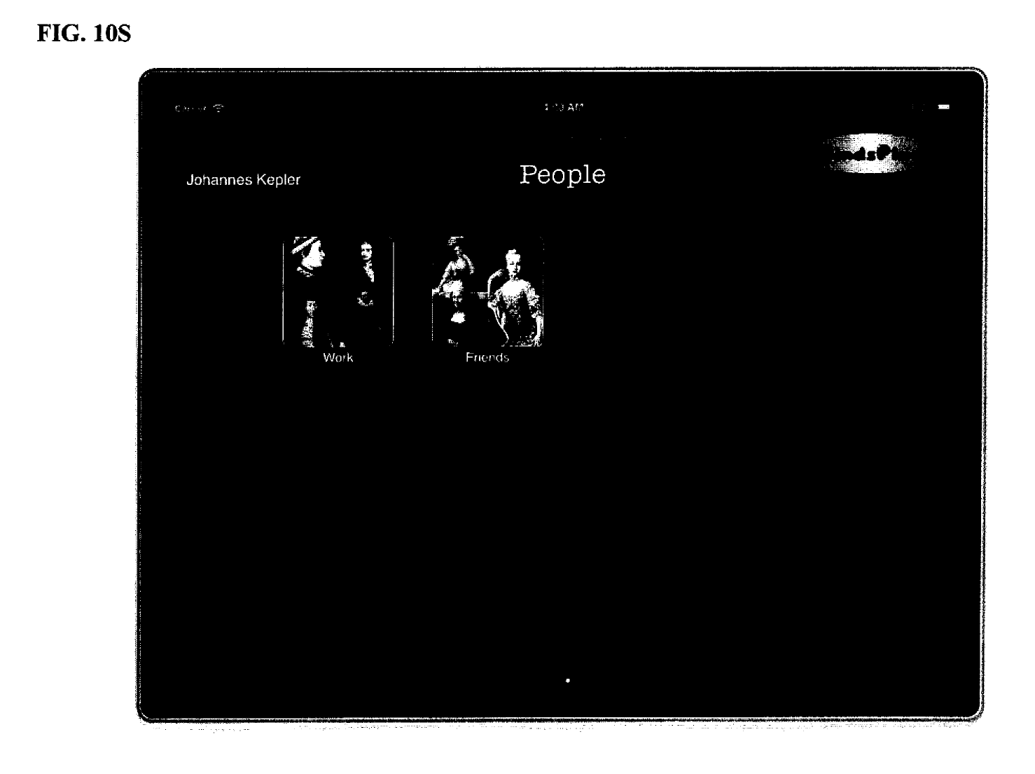

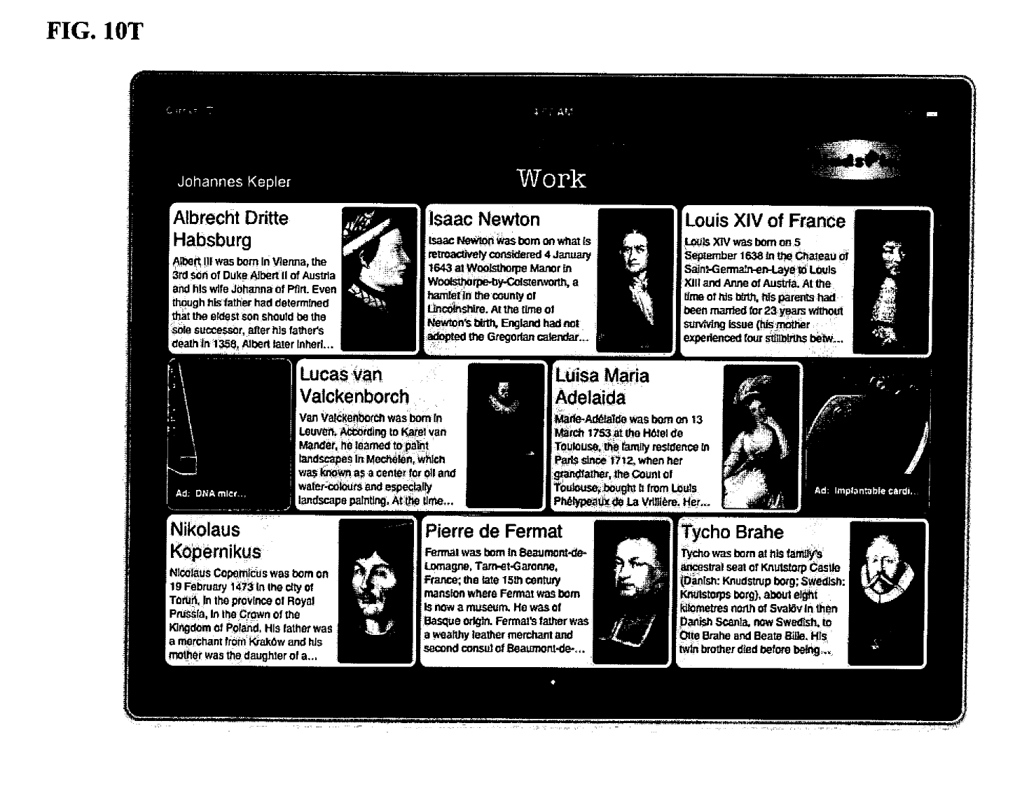

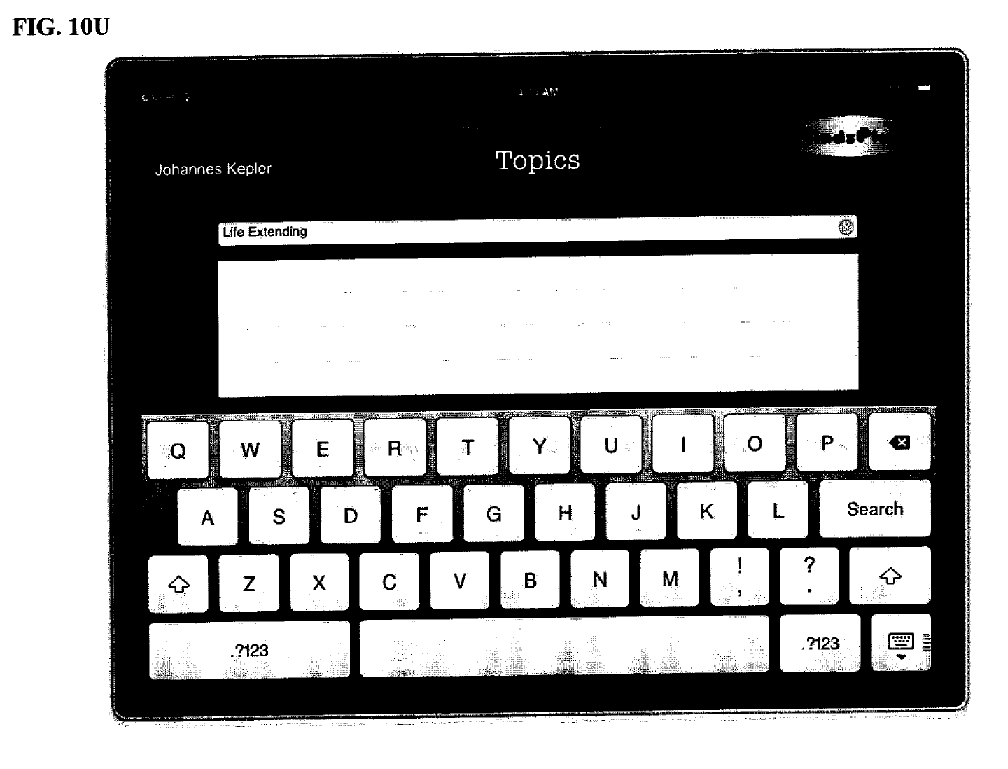

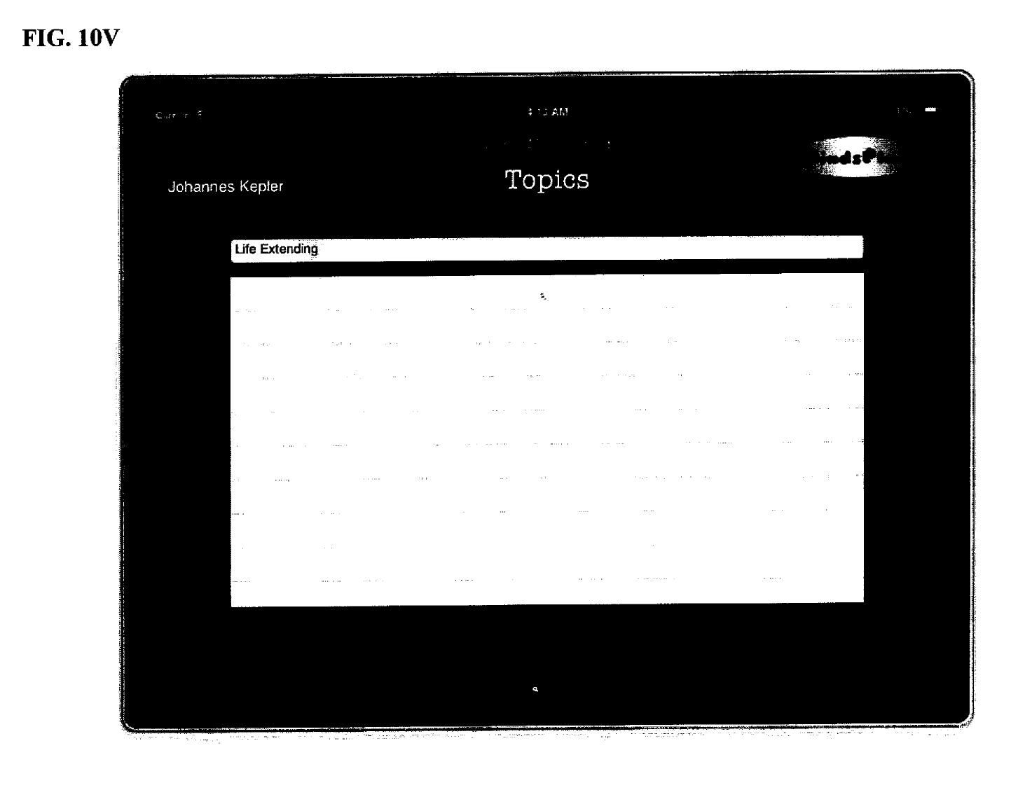

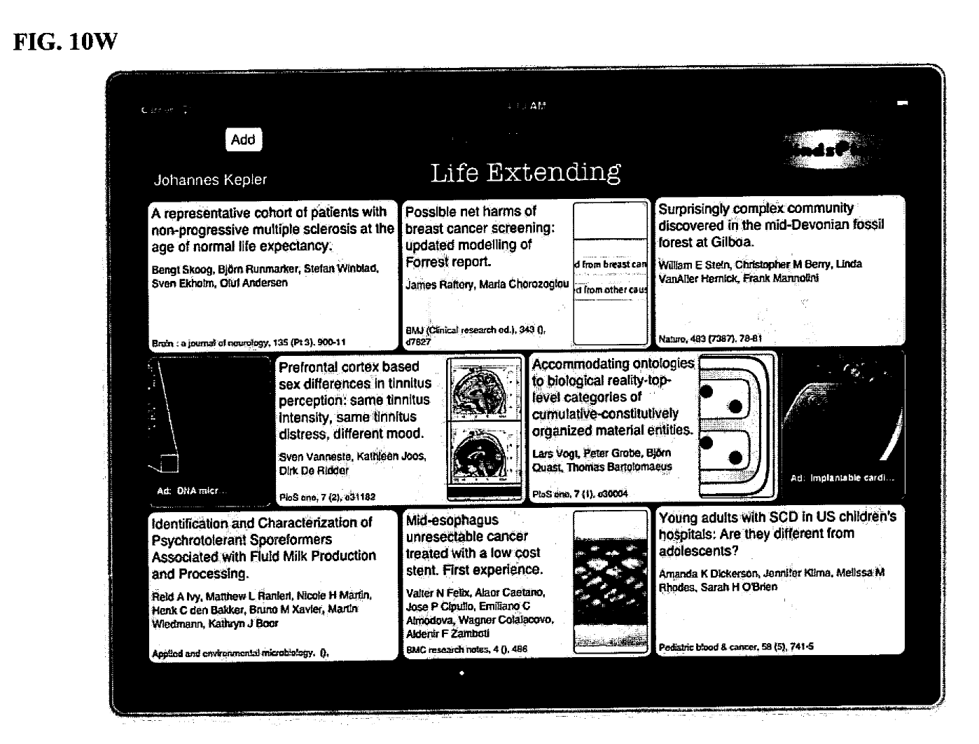

The following describes exemplary details of exemplary implantation of various feature of present invention. FIGS. 10A-10W show enabled implementation with an operational server and client application on an iPad system, with exemplary screenshot from the application that implements some of the visualization features described in the present invention.

In existing visualization approaches, the each commonly used approach is compromising several aspects: (A) Printed paper: the article is pre-shaped and edited. Figures and text are positioned relative to each other in a pre-fixed structure (fonts, location, integration into the journal, ads); (B) The user does not control it other than flipping pages. The user does not perform search queries to look for specific text; (C) PDF: similar to paper. Viewer allows to zoom in and out as a whole, keeping the proportion and location of text and figures. User still requires to fit the pdf into the screen size, with the limitation that if full page fits the screen the font becomes too small to read conveniently, and if zoomed in, then the user must shift the page back and forth for reading, and in particular to view images that are related to the text. Document keeps the original “print” structure and page breaks for the good (human edited) and for the bad (A4 print does not fit the screen size and resolution). Limited search and highlight (for example limitation in copying in multi-columns format); (D) HTML (web-interface): The software has the textual content and presents it in accordance to the HTML capabilities, including control over font size. It embeds the figures in fixed locations relative to the text, typically without smart formatting nor handling of size and resolution, thus the embedding of the figures never gets to a professional magazine look. Normally web pages are highly busy with additional indirectly relevant content and links from the page provider, sometime ads too. In some cases, the excessive presence of links cause unintentional click on them, which is annoying to the user. HTML document allows easy search and highlight. (E) Electronic Reader platforms: PDF viewers—same as above re PDF. Text viewers—at best will be as the HTML, usually less capable than a full HTML browser. Journal viewers—professional look by reformatting simple text content into automatically edited journal format. However, unsuitable and clearly not customized for handling scientific content (specific common formats such as Bold, Italic, Superscript, Subscript, etc.), and clearly not masses of scientific content.

In exemplary embodiments of the present invention, the visualization and platform comprise an integrated solution that provides 3 main modes to start with: Topics, People, Messages.

Topics—a mode that allows search for external information (for example, PubMed), observing search results, keeping history of searches and favorite results, and through that, reading content (scientific articles, databases). In an example, based on the content, further social activities are triggered (communicating and updating colleagues about the content, searching for people based on the content, conveying messages related to the content, etc). In an example, the search in itself may be influenced based on social aspects of the content and the user. In an example, this mode allows either view of auto-updating channels, fixed collection of content (articles) or an on-going updating list (smart collection), such that it continuously indicates and shows new content (articles) that become available from time to time under each topic; and new content that became relevant following social activity and social events in the system. In an example, the user shares topic with others, sends a link to an article to others, forms communications (messages) on a topic and form communications (messages) related to article.

People—a mode that allows search for people (potential colleagues), form groups of users, maintain information related to them—Permission management per user/group to allow certain individuals to access their posts Manage data sharing among colleagues. In an example, searching is done by a user, by a group or by subject. In addition, search among my existing user's database, search for new users based in profile, interests, implicit interest=searches. In an example, as part of a profile, a user shares info about himself (chooses either identifying the real user or not identifying), provide means to communicate with the user outside the application (for example, forward emails/social network/text messages etc.). In an example, a user collects contacts to users and categorize them into groups (his groups of contacts). A user joins “subject groups”. Each user posts (blog) messages on his user account, to be viewable by everyone, his direct friends, specific (or all) “subject groups” to which he belongs. A user also receives messages from them (based on permission he gives). In an example, from visualization perspective: the “People” screen shows both how many new posts are there by a certain person/group of contacts, and also mentions how many messages has been sent directly to the user (received directly by “me”).

Messages—Also referred as Minds or Discussions (subject groups/collection of discussions). In an example, the user performs one or more of the following: Adding a mind per article; Tapping a person's icon to get his profile and see his “mind” (blogs) or send him a message. In an example, it is a mode that allows searching and following messages on various topics (in a way, reminds forums, news or feeds, but mostly messaging systems). It allows posting messages (blog) and content on the user account, with permissions to certain individuals or groups (or public) to join, read and/or submit content. In an example, users broadcast messages in reply to a message, and form a conversation that would be viewed by those who have access to the original post. In an example, a user searches among his currently subscribed subjects, and among the “profile” of newly formed subject. Connectivity with “Topics”—once an article becomes something people want to express thoughts about, then they forms a “discussion” on it. If a message is aimed to closed forum, then secure sharing of content is achieved by the management of the group. In an example, a user adds a mind (discussion) per article.

In exemplary embodiments of the present invention, additional features of the client related to Topics are one or more of: (A) User opens the App and see list of topics/channels; (B) Some topics showing numbered badge (number of articles/entities); (C) The number represents new articles (time line based); (D) Articles recommended by the system (social graph based), according to: (D1) Users activity, such as (1) User read the article, (2) User viewed figures from the article, and (3) User mentioned the article in a message; and (D2) Social activity (involving other person that previously made User Activity), such as: (1) User added person to one of his groups, (2) User was mentioned by person, and (3) Other person added the user to his groups.

In exemplary embodiments of the present invention, additional features of the client related to Search of New Topic are one or more of: (A) User swipe the topics to the right and reveal Search Page; (B) User type text to search; (C) List of possible topics is shown, such as (1) Topics that include the text in their name, (2) Topics that include the text in their full name (descriptive name), and (3) The result of searching same text in external database (PubMed, etc.).

In exemplary embodiments of the present invention, additional features of the client related to View of Topic are one or more of: (A) User select topic from the topics view or from the search results; (B) The articles are laid as titles mixed with figures from the article, and with ads; (C) User swipes the first page left to reveal more pages of titles, figures and ads; (D) User taps on items, such as (1) Title box (with authors and journal name) to View Article, (2) Figure box to view it full screen (allow zoom and pan), and (3) Ad box to view sponsored content and/or commercial.

In exemplary embodiments of the present invention, the system manages advertisements on either one of the client or server or both. In exemplary embodiments of the present invention, ads are provided to the client either by the one or more servers, or from ads providers, and the client stores the ads and uses them as the client side determines. In exemplary embodiments of the present invention, the client displays ads also when the client is not connected to the network at all, or when not connected to the server, or when not connected to the ads provider. In exemplary embodiments of the present invention, the client stores a collection of ads, with tags and/or properties and/or description of conditions, which are used by the client to determine if, when, and/or how to display the ads to the user, and/or how to manage responses of the user to eh displayed ad (for example, response to click, response to tap, response to full watching a video/animated ad, interaction with the ad, and the like). In exemplary embodiments of the present invention, the client reports to the one or more servers and/or to the ads provider about the actual display and/or user response to the ads. In an example, such report is used for billing for the ads.

Database Schema and Services that the Application Platform Offers

In an exemplary embodiment of the present invention, the simplicity of having 3 objects made with simple attributes and complex attributes, and for each have its own collection, makes the application platform suitable for broad range of uses and expandable. In an exemplary initial implementation of the platform the objects are referred as following:

ActualEntity—User, a person which uses a client application, which accesses the Application platform.

MindEntity—Conversation, a set of updates (messages) made by multiple users on a timeline.

VirtualEntity—Article, a knowledge piece or content. For example, these are fetched from available information sources, for example from PubMed and/or PubMed Central (PMC).

In an exemplary embodiment of the present invention, additional minor objects and collections are supporting the above main objects:

FileEntity—A reference to physical file and/or file hosted in local network or remote network or other Web hosting.

AdEntity—Ad, list of targets with visual representation, tailored to the user and displayed with the above objects.

### Technical Layout of the Platform

In an exemplary embodiment of the present invention, each object or collection is represented by a key. For example, the object ActualEntity is described by the database table ActualEntity and the first column of this table is Key. In an example, this key is never a null value and it is unique in this table. In an example, all collections are the similar, but the entity attribute is referring to the corresponding object. In an example, a FileEntity is lacking a collection, and it is only referenced by other objects.

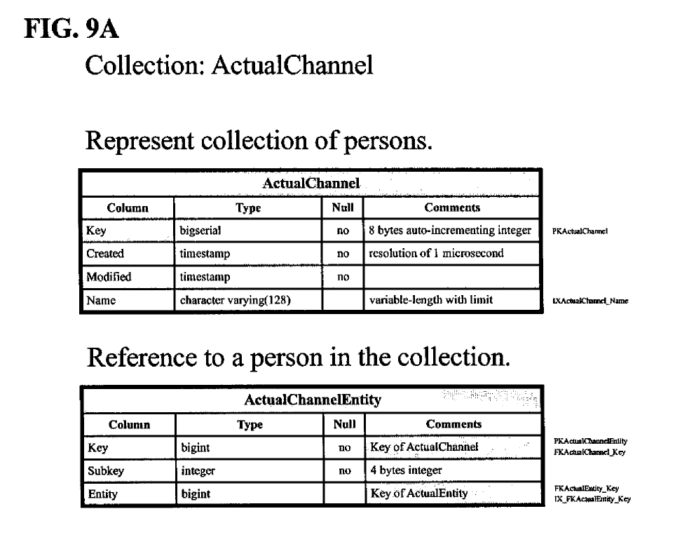

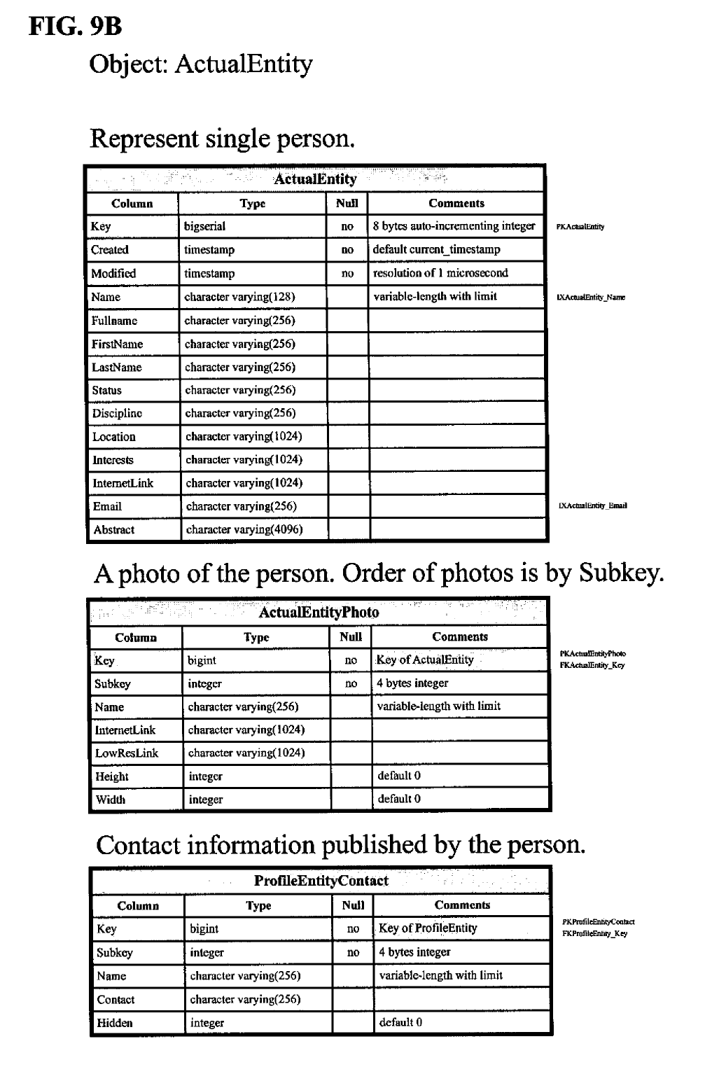

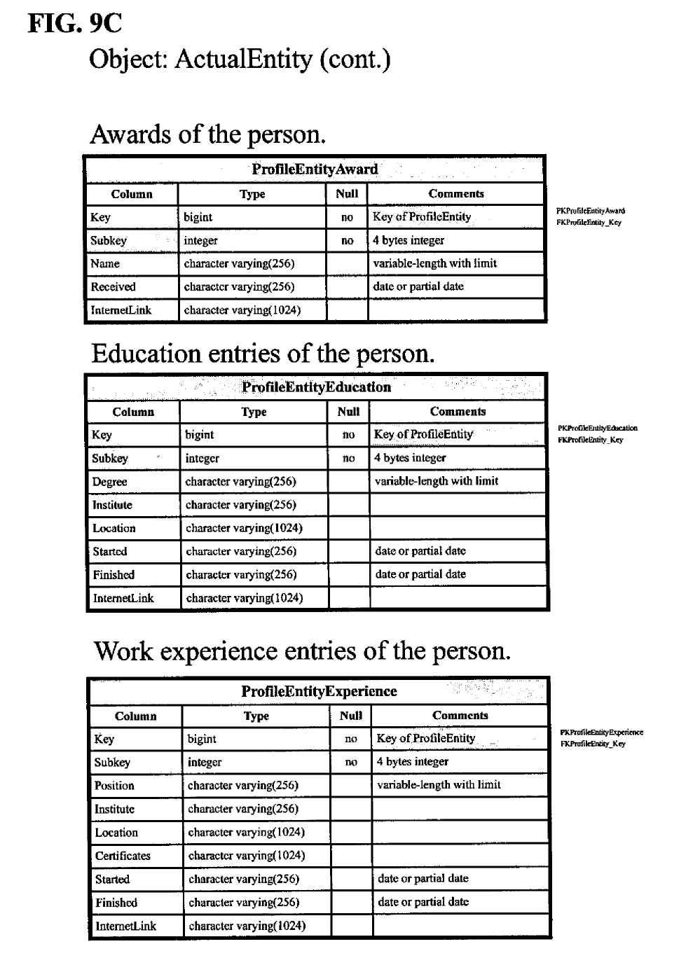

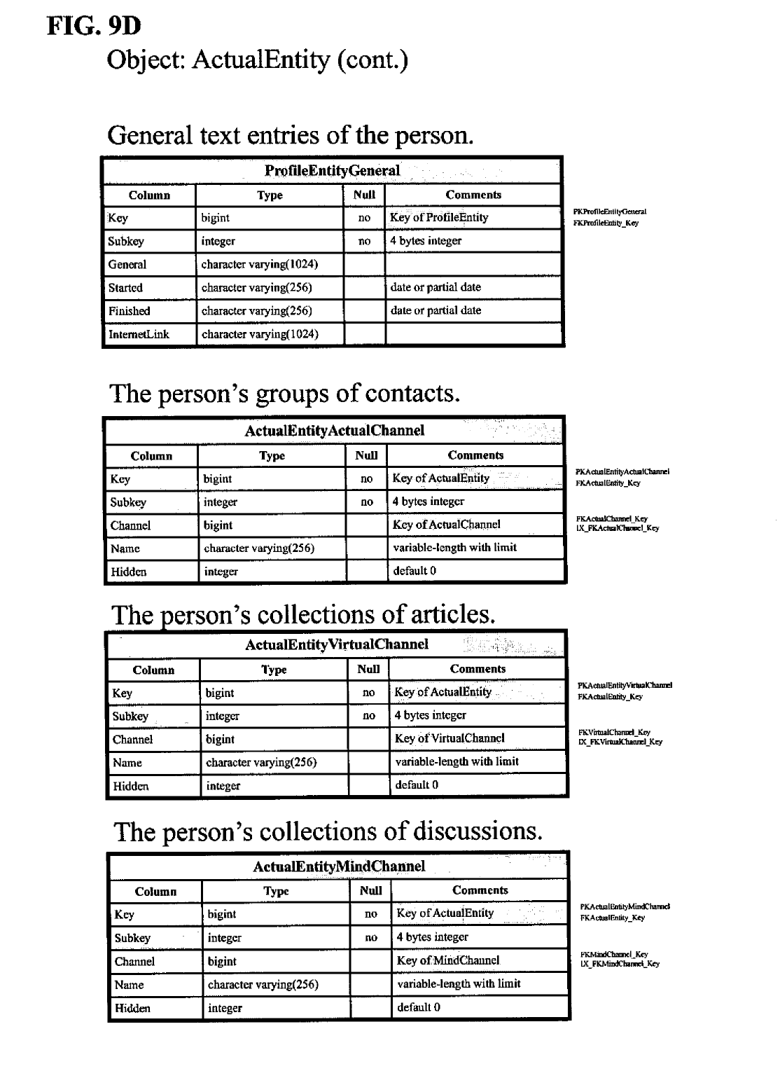

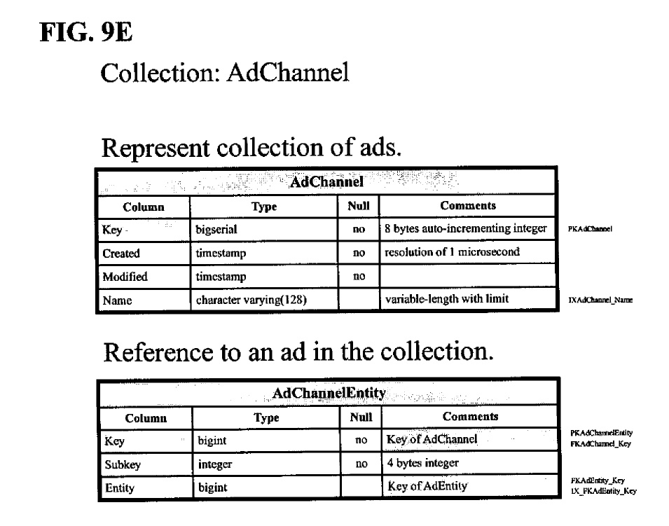

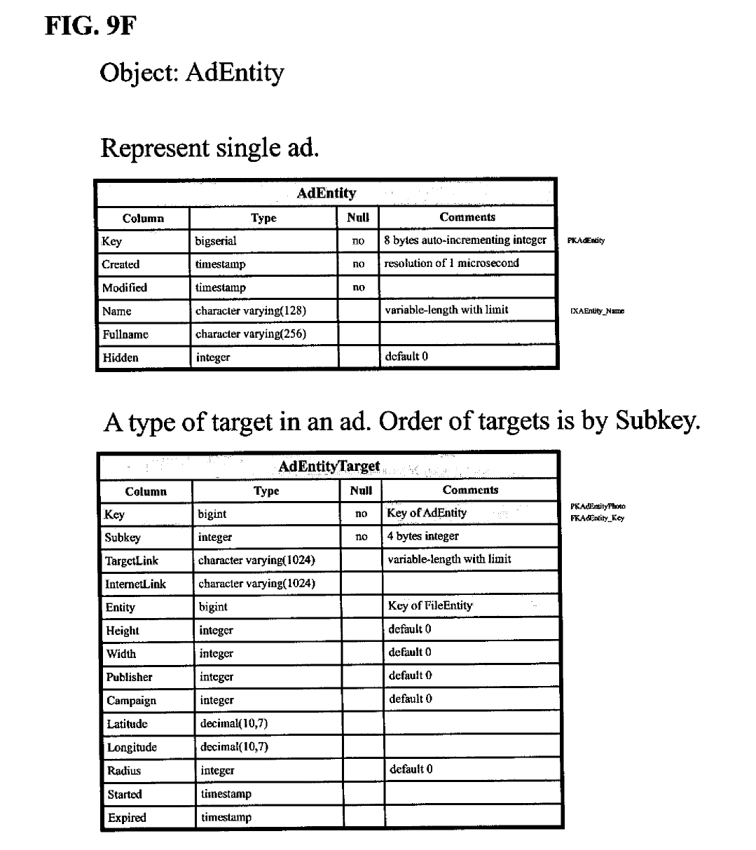

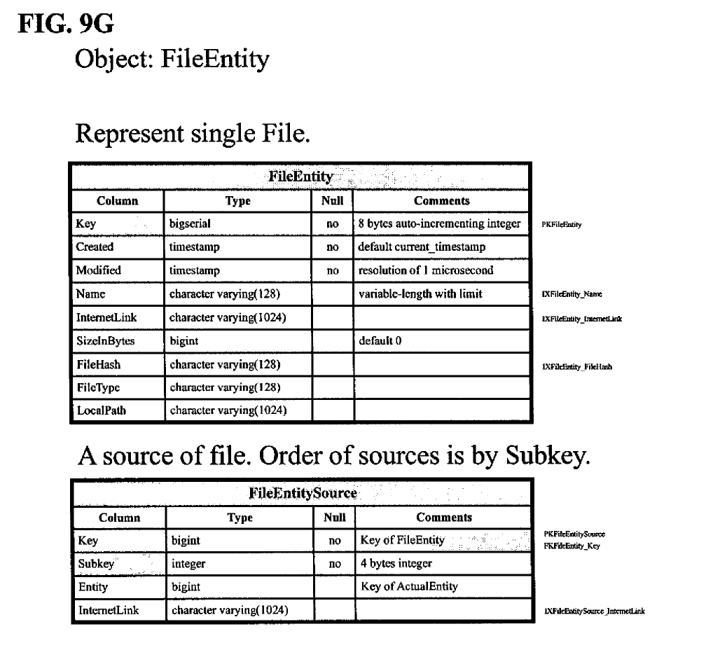

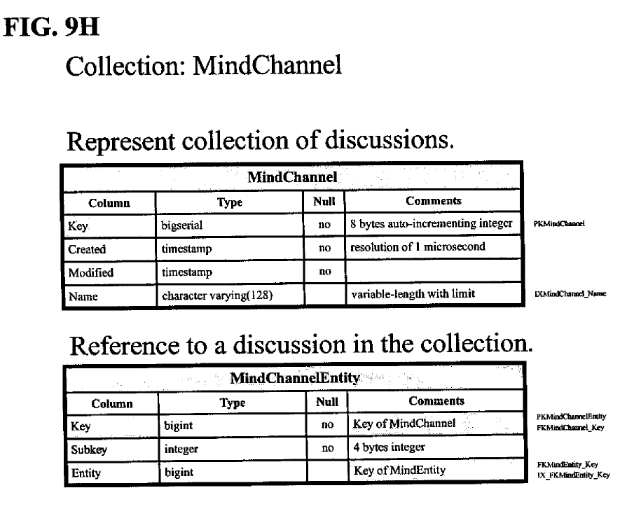

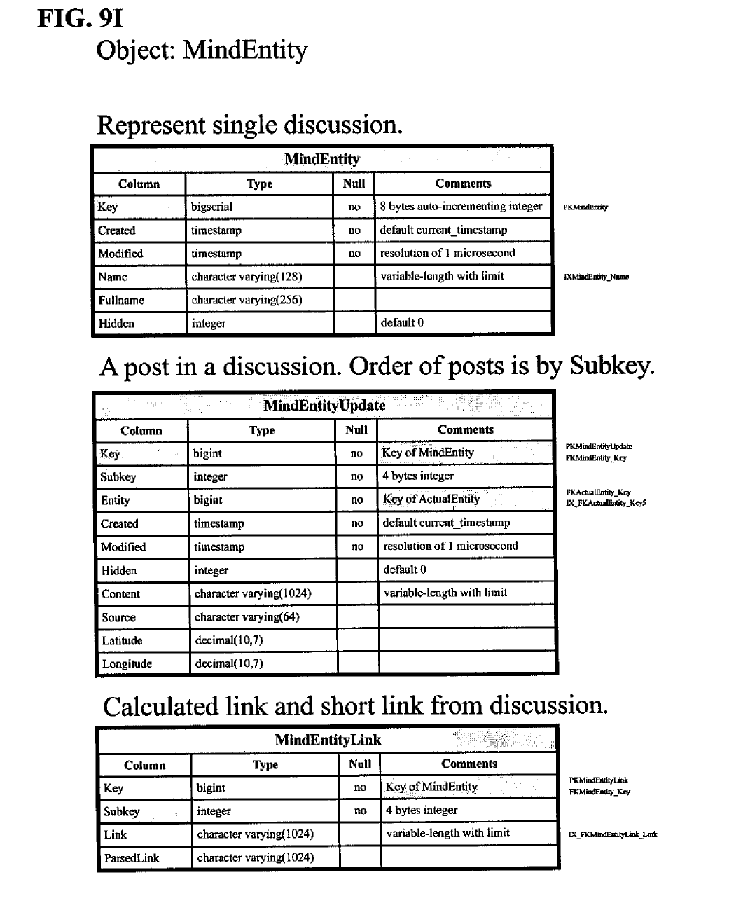

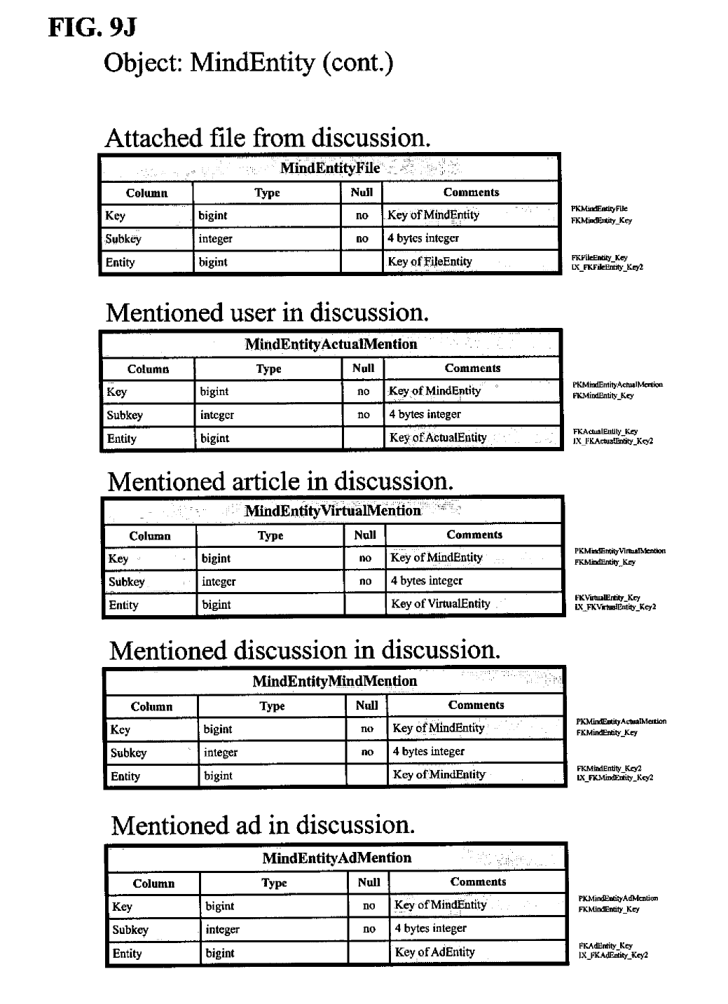

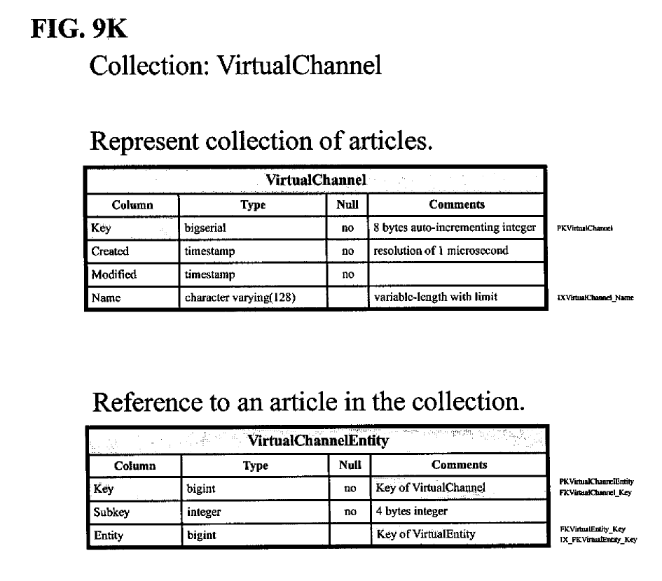

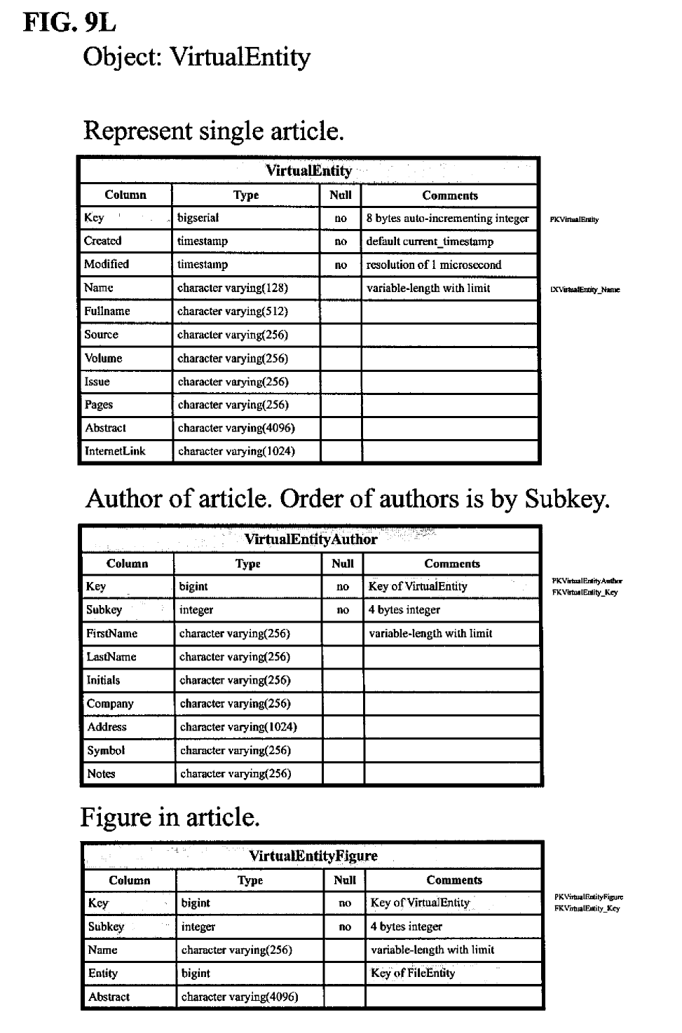

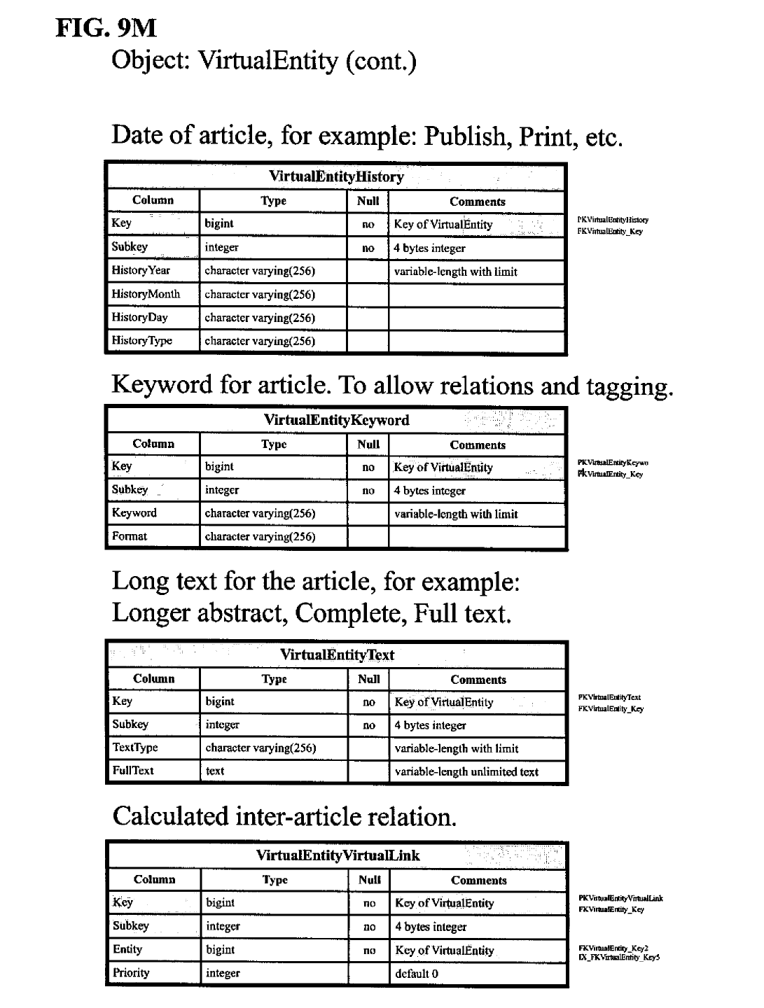

### FIGS. 9A-9M

FIGS. 9A-9M show example of database structure and relationships among data items and tables as being used by some exemplary embodiments of the present invention, for examples, tables describing ActualChannel, ActualEntity, AdChannel, AdEntity, FileEntity, MindChannel, MindEntity, VirtualChannel and VirtualEntity.

The following table shows an exemplary set of Server API Services used in exemplary embodiments of the present invention.

| Query | Service Type | Main Object | Description |
|---|---|---|---|
| ActualChannel | Single object | ActualChannel | Get single ActualChannel object by |
| | query | | key or name. |
| ActualEntity | Single object | ActualEntity | Get single or multiple ActualEntity |
| | query | | objects by key, name, or keys. |
| MindChannel | Single object | MindChannel | Get single MindChannel object by key |
| | query | | or name. |
| MindEntity | Single object | MindEntity | Get single or multiple MindEntity |
| | query | | objects by key, name, or keys. |
| VirtualChannel | Single object | VirtualChannel | Get single VirtualChannel object by |
| | query | | key or name. |
| VirtualEntity | Single object | VirtualEntity | Get single or multiple VirtualEntity |
| | query | | objects by key, name, or keys. |
| ActualChannelsImages | Deep object | ActualEntity | Get the first photo of up-to 4 |
| | query | | ActualEntity objects in each |
| | | | ActualChannel object referenced by |
| | | | ActualEntity. |
| VirtualChannelsImages | Deep object | VirtualEntity | Get the first figure of first |
| | query | | VirtualEntity object with figure in |
| | | | each VirtualChannel object |
| | | | referenced by ActualEntity. |
| | | | This query allows to populate the |
| | | | topics view of the logged-in user. |
| ChannelGet | External | VirtualChannel | Create new VirtualChannel or update |
| | fetch | | existing one, by searching PubMed, |
| | | | create new VirtualEntity objects when |
| | | | needed, reference the VirtualEntity |
| | | | objects from the VirtualChannel |
| | | | Returns how many of the |
| | | | VirtualEntity objects already existed |
| | | | in the Application platform. |
| | | | This query is used when searching for |
| | | | new topics. |
| ChannelFull | External | VirtualChannel | Update the VirtualEntity objects |
| | fetch | | referenced by VirtualChannel, by |
| | | | getting Full Text and links to Figures |
| | | | from PMC. |
| ChannelAdd | Add/Delete | ActualEntity | Add or remove reference from |
| | reference | | ActualEntity to VirtualChannel. |
| | | | This query is used to add new topic or |
| | | | remove topic from the user's list of |
| | | | topics. |

The following table is showing a set of Client Features used in exemplary embodiments of the present invention.

| Feature | Description |
|---|---|
| Sign-up for new | The user will provide initial information to open new Application |
| account. | platform account and will verify his email ownership to activate the |
| | account. The activation process implemented in such way that allows |
| | control of the ‘amount of activations per hour’ for smooth rollout. |
| Associate other social | The user will associate his other social accounts, such as Twitter, |
| networks' credentials | LinkedIn, Google+ and Facebook, so that the Application platform will |
| to allow the | be able to import the user's contacts list from other social networks. |
| application to import | |
| the users' contact | |
| lists. | |
| Associate other social | The user will associate his other social accounts, so that Application |
| networks' credentials | platform will be able to post the user's updates in parallel on other |
| to allow Application | social networks. |
| platform to post his | |
| public updates to | |
| other social networks. | |
| Search for articles. | User searches for articles to read. The iPad client allows the user to keep |
| | the search results as channel. |
| Search for minds | User searches in public minds. The iPad client allows the user to keep |
| (discussions). | the search results as channel. |
| Search for people | User searches for people, both the application users, as well as authors |
| (Application platform | of articles, which already been watched by any Application user. |
| users and authors). | |
| Notifications for new | User will get push notifications and/or emails (based on his preference) |
| content in channels. | whenever new content is available for one of his channels. |
| Ads while viewing | The user will be presented with ads from the point he is looking on |
| channel. | channel. This means that while user is viewing titles of articles, or |
| | recent updates from minds (discussions), he is already exposed to |
| | advertisement. |
| Search and manage | When viewing channel, the user searches in it, sort the items (articles, |
| within channel. | minds, people), hide items, favorite items (which added to the favorites |
| | channel), filter using sub-categories (only in the case of articles). |
| Manage channels. | The user sets channel to stop automatic fetching of new content, means |
| | set it as fixed channel. All people channels are fixed by default. |
| | In the case of people channels (groups), user creates empty channels and |
| | manage the people in each channel (group). This functionality is part of |
| | the profile administration. |
| Article figures while | The user will be presented with figures from articles while viewing |
| viewing channels. | channel. This means that the articles' figures are fetched while |
| | performing the search for the articles. |
| Start new mind | The user starts new mind from channel view, article view, person view, |
| (discussion). | and even other mind view. In any case, the new mind is created with |
| | link to the originating view. |
| Privacy of minds | The user, which creates the mind, posts it in public or limit the mind to a |
| | group (of people), and even limit to specific individuals. |
| Mind (discussion) | The user views a mind and post an update in reply to the discussion. The |
| viewing. | mind viewer will be based on HTML5. |
| Post an update to a | When user is viewing mind, he posts an update/reply/comment, which |
| mind (discussion). | then is added to the mind. |
| Social browsing. | When user is viewing channel, article, mind, or person, he taps a button |
| | to fetch “related channel”. From the related channel he fetches another |
| | related channel and so on. The user navigates back in the stack of views |
| | he fetched. |
| | Here is an example of social browsing and related channels: |
| | The User tap on articles channel, Diabetes, and get channel view |
| | with titles of articles. |
| | The user now tap a button for minds channel, which are discussing |
| | any of the articles in the Diabetes channel. |
| | The user now tap a button for people channel, which is a group |
| | made of all the users that participated in the minds. |
| | The user tap on a person and view his profile. |
| | The user tap on a button for articles channel, which this user |
| | discussed in the past. |
| | The user now goes back in the reverse order, as these views are |
| | stacked one after the other. |
| Related channels. | Application platform server will link between articles based on internal |
| | algorithm. User actions will link between articles, minds and people. |
| | The result of the links will support the fetching of related articles. |

### General

It is expected that during the life of a patent maturing from this application many relevant servers and client devices will be developed and the scope of the terms client, server, relationship and link are intended to include all such new technologies a priori.

As used herein the term “about” refers to ±10%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at” least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

What is claimed is:

1. A system for accessing electronic content and providing social network comprising:
(a) a computerized user interface;
(b) a computerized sub system for accessing one or more databases and for searching information in said one or more databases;
(c) a computerized sub-system for maintaining user data for a plurality of users and connectivity data among said users; and
(d) a sub-system that is suitable for generating information search results which takes into account the user's connectivity with other users.

2. A system according to claim 1 where said subsystem (d) uses information pertaining to the user's field of interest.

3. A system for accessing electronic content and providing social network comprising:
(a) a computerized user interface;
(b) a computerized sub system for accessing one or more databases and for at least one of searching, obtaining, reading and viewing of information in said one or more databases
(c) a computerized subsystem for analyzing said access to said information and/or at least one database and to characterize fields of interest of the user;
(d) a computerized sub-system for maintaining user data for a plurality of users and connectivity data among said users; and
(e) a sub-system that is suitable for identifying other users sharing similar field of interest based on said analyzing.

4. A system according to claim 3 wherein the system further makes connection between said users having similar fields of interest.

5. A system according to claim 3, comprising:
(f) a computerized sub system for accessing one or more remote databases and for searching information in said one or more remote databases; and
wherein said system include at least one client and at least one server, and wherein at least one client performs said access to said one or more remote databases.

6. A system according to claim 5 wherein at least one server also performs said access to said one or more remote databases.

7. A method of interactively display in a client application results of searches in databases, the method comprising:
(a) providing criteria of information to be searched;
(b) accessing a database to obtain characteristic information for multiple search results that meet the criteria;
(c) accessing a database to pre-fetch available initial textual information and figures for each of a certain amount of multiple results;
(d) display multiple search results in combination with figures for said multiple pre-fetched results; and
(e) enable one-click to access the figures and initial textual information.

8. A method according to claim 7 wherein information is articles and initial textual information includes at least abstract information.

9. A method according to claim 7 wherein multiple figures are displayed in a manner that they continuously replacing one another.
